(19) United States
(12) Patent Application Publication
(10) Pub. No.: US 2021/0312027 A1
(43) Pub. Date: Oct. 7, 2021

(54) METHODS AND SYSTEMS FOR IDENTITY CONFIRMATION

(71) Applicant: YUNDING NETWORK TECHNOLOGY (BEIJING) CO., LTD., Beijing (CN)

(72) Inventors: Yong ZOU, Beijing (CN); Xunlong ZHUO, Beijing (CN); Shuwen ZHOU, Beijing (CN); Wei CHANG, Beijing (CN)

(73) Assignee: YUNDING NETWORK TECHNOLOGY (BEIJING) CO., LTD., Beijing (CN)

(21) Appl. No.: 17/352,501

(22) Filed: Jun. 21, 2021

Related U.S. Application Data
(63) Continuation of application No. PCT/CN2019/127141, filed on Dec. 20, 2019.

(30) Foreign Application Priority Data
Dec. 20, 2018 (CN) 201811562066.4
Dec. 20, 2018 (CN) 201822144862.8
Jan. 31, 2019 (CN) 201910097375.7
Jan. 31, 2019 (CN) 201920179301.3

(51) Int. Cl. G06F 21/32; G06F 21/40; G06K 9/00

(52) U.S. Cl. CPC G06F 21/32; G06K 9/00906; G06K 9/00892; G06F 21/40

(57) ABSTRACT

The present disclosure may provide a method for confirming identity of a subject. The method may include: obtaining first recognition information of the subject; determining a first recognition result based on the first recognition information; obtaining second recognition information of the subject; determining a second recognition result based on the second recognition information; and determining a detection result of the subject based on the first recognition result and the second recognition result.

### CROSS-REFERENCE TO RELATED APPLICATIONS

This application is a continuation of International Patent Application No. PCT/CN2019/127141, filed on Dec. 20, 2019 which claims priority of Chinese Patent Application No. 201811562066.4, filed on Dec. 20, 2018, Chinese Patent Application No. 201822144862.8, filed on Dec. 20, 2018, Chinese Patent Application No. 201910097375.7, filed on Jan. 31, 2019, and Chinese Patent Application No. 201920179301.3, filed on Jan. 31, 2019, the contents of each of which are hereby incorporated by reference.

### TECHNICAL FIELD

The present disclosure relates to identity confirmation, and in particular, to methods, systems, and devices for identity confirmation.

### BACKGROUND

With the development of the Internet and communication technology, biometric feature information (such as fingerprint, face) has been widely used in user identity confirmation. However, the biometric feature information of a user may be copied and forged (for example, the user's fingerprint is easy to be stolen and made into a fingerprint sticker or a fingerprint film), causing a safety hazard. A current identity confirmation device may usually confirm identity of the user based on the biometric feature information, but fail to determine whether the user carrying the biometric feature information is a living body. An unauthorized person may steal the biometric feature information of the user to perform the identity confirmation, bringing a great threat to the privacy, the property, or the security of the user. Therefore, the present disclosure may provide identity confirmation devices with high security.

### SUMMARY

One aspect of embodiments of the present disclosure may provide a method for confirming identity of a subject. The method may include obtaining first recognition information of the subject, and determining a first recognition result based on the first recognition information. The method may further include obtaining second recognition information of the subject, and determining a second recognition result based on the second recognition information. The method may further include determining a detection result of the subject based on the first recognition result and the second recognition result.

In some embodiments, the first recognition information may include identity recognition information, or the second recognition information may include liveness recognition information.

In some embodiments, the first recognition information may include information relating to at least one of a fingerprint, a palm print, a palmar digital vein, voice, an iris, or the face of the subject; or the second recognition information may include at least one of a blood oxygen level, a heart rate, a palmar digital vein, or facial information of the subject.

In some embodiments, the first recognition result may include that the identity of the subject is confirmed or not; or the second recognition result may include that liveness of the subject is recognized or not.

In some embodiments, the determining a detection result of the subject based on the first recognition result and the second recognition result may include: in response to the first recognition result including that the identity of the subject is confirmed, and the second recognition result including that the liveness of the subject is recognized, determining the detection result of the subject to be positive; or in response to the first recognition result including that the identity of the subject fails to be confirmed or the second recognition result including that the liveness of the subject fails to be recognized, determining the detection result of the subject to be negative.

In some embodiments, the determining a second recognition result based on the second recognition information may include: generating a comparison result by comparing the second recognition information with a liveness detection threshold; and determining the second recognition result based on the comparison result.

In some embodiments, the liveness detection threshold may include a liveness recognition intensity threshold. The comparing the second recognition information with a liveness detection threshold may include comparing an average of the second recognition information with the liveness recognition intensity threshold; or comparing a maximum value of the second recognition information, a minimum value of the second recognition information, or a difference between the maximum value and the minimum value of the second recognition information with the liveness recognition intensity threshold.

In some embodiments, the liveness detection threshold may include a liveness detection curve slope threshold. The comparing the second recognition information with a liveness detection threshold may include comparing a maximum curve slope or a minimum curve slope of the second recognition information with the liveness detection curve slope threshold.

In some embodiments, the first recognition information may include identity recognition information. The determining a first recognition result based on the first recognition information may include: obtaining a retrieval result by retrieving the identity recognition information from a pre-stored identity recognition information set; and determining the first recognition result based on the retrieval result.

In some embodiments, the method may further include generating an instruction for updating a current status of an identity confirmation device based on the detection result of the subject.

In some embodiments, the generating an instruction for updating a current status of an identity confirmation device based on the detection result of the subject may include: in response to the detection result being positive, generating the instruction for updating the current status of the identity confirmation device such that the identity confirmation device is unlocked; or in response to the detection result being negative, generating the instruction for updating the current status of the identity confirmation device such that the identity confirmation device is locked.

In some embodiments, the method may further include transmitting, to an external device, notification information relating to the detection result of the subject.

In some embodiments, the method may further include: establishing a video call or an audio call between the subject and the external device.

In some embodiments, the method may further include: transmitting, to the subject, reminder information relating to the detection result of the subject.

In some embodiments, the reminder information may include at least one of: a voice reminder, a reminder by a flashing indicator, or a reminder by a beeping alarm.

In some embodiments, the method may further include: determining whether a wake-up signal of the subject is detected; and in response to determining that the wake-up signal of the subject is detected, obtaining the first recognition information of the subject and the second recognition information of the subject.

Another aspect of embodiments of the present disclosure may provide a system for confirming identity of a subject. The system may include: a storage device including a set of instructions; and one or more processors in communication with the storage device. When executing the set of instructions, the one or more processors may be configured to direct the system to: obtain first recognition information of the subject; determine a first recognition result based on the first recognition information; obtain second recognition information of the subject; determine a second recognition result based on the second recognition information; and determine a detection result of the subject based on the first recognition result and the second recognition result.

Another aspect of embodiments of the present disclosure may provide a system for confirming identity of a subject. The system may include: a first information obtainment sub-unit configured to obtain first recognition information of the subject; a first information processing sub-unit configured to determine a first recognition result based on the first recognition information; a second information obtainment sub-unit configured to obtain second recognition information of the subject; a second information processing sub-unit configured to determine a second recognition result based on the second recognition information; and a processing module configured to determine a detection result of the subject based on the first recognition result and the second recognition result.

In some embodiments, the system may further include: a control module configured to generate an instruction for updating a current status of an identity confirmation device based on the detection result of the subject.

In some embodiments, the system may further include: a communication module configured to transmit, to an external device, notification information relating to the detection result of the subject.

Embodiments of the present disclosure may provide a computer-readable storage medium storing computer instructions, when a computer reads the computer instructions in the computer-readable storage medium, the computer may perform the method described in any embodiments of the present disclosure.

In some embodiments, embodiments of the present disclosure may provide a device for confirming identity of a subject. The device may include a first recognition device configured to obtain first recognition information of the subject. The device may include a second recognition device configured to obtain second recognition information of the subject. The device may include a main control board configured to determine a first recognition result based on the first recognition information; determine a second recognition result based on the second recognition information; and determine a detection result of the subject based on the first recognition result and the second recognition result. The device may further include a mounting module configured to fix the first recognition device, the second recognition device, and the main control board in the device.

In some embodiments, the mounting module may include a retaining bracket. The first recognition device may include a first recognition information collector and a first recognition information identifier. The first recognition information collector and the first recognition information identifier may be detachably fixed on two sides of the retaining bracket, respectively.

In some embodiments, a communication line of the first recognition information collector may be connected to a terminal block of the first recognition information identifier.

In some embodiments, the mounting module may further include a buffer disposed between the first recognition information collector and the retaining bracket.

In some embodiments, the retaining bracket may include a mounting groove, and the buffer may be pressed inside the mounting groove by the first recognition information collector.

In some embodiments, the retaining bracket may be fixed on a first panel through a clamping connection.

In some embodiments, the first panel may include at least two clamping ribs, and the at least two clamping ribs may form a rib groove clamped with the retaining bracket.

In some embodiments, a portion of the first recognition device and the second recognition device may be exposed from a through hole of a second panel, and the first recognition device and the second recognition device may obtain the first recognition information and the second recognition information, respectively, through the portion exposed from the through hole.

In some embodiments, the second recognition device may include a light emitting element, a receiving element, and a light shielding element. The light emitting element and the receiving element may be disposed on two sides of the light shielding element. The light emitting element may be configured to transmit a recognition light towards the subject. The receiving element may be configured to receive the recognition light reflected by the subject.

In some embodiments, the main control board may be further configured to control the device based on the detected result of the subject.

In some embodiments, the device may further include a speaker configured to emit a voice reminder or a beeping alarm under a control of the main control board.

In some embodiments, the device may further include an optical indicator configured to emit an optical reminder under a control of the main control board.

In some embodiments, the device may further include a mechanical structure that is changeable under a control of the main control board such that the device is locked or unlocked.

Another aspect of embodiments of the present disclosure may provide a method for recognizing a fingerprint. The method may include: determining a liveness recognition result by performing a liveness recognition on a subject in response to the subject having a fingerprint; in response to the liveness recognition result including that the subject is a living body, obtaining a fingerprint image; and determining the liveness recognition result by searching for the fingerprint image in a pre-stored fingerprint image set.

In some embodiments, the determining a liveness recognition result by performing liveness recognition on a subject may include: emitting an infrared light towards the subject; receiving the infrared light reflected by the subject; obtaining an infrared light intensity of the infrared light reflected by the subject; determine whether the infrared light intensity is within a predetermined intensity range; in response to the infrared light intensity being within the predetermined intensity range, determining that the liveness recognition result includes that the subject is the living body.

In some embodiments, the determining a liveness recognition result by performing liveness recognition on a subject may include: emitting an infrared light towards the subject; receiving the infrared light reflected by the subject; obtaining an infrared light intensity of the infrared light reflected by the subject; determine whether a curve formed by changed infrared light intensities within a recognition time period conforms to a predetermined curve; in response to the curve formed by the changed infrared light intensities failing to conform to the predetermined curve, determining that the liveness recognition result includes that the subject is the living body. In some embodiments, the predetermined curve may include a substantially flat straight line or an irregular curve.

In some embodiments, the method may further include: transmitting an alarm instruction in response to the liveness recognition result including that the subject is not the living body; and calling the police based on the alarm instruction.

In some embodiments, the method may further include: transmitting a reminder instruction in response to failing to search for the fingerprint image in the pre-stored fingerprint image set. The reminder instruction may include a reminder instruction of a false fingerprint recognition or an alarm instruction. The method may also include: calling the police based on the alarm instruction or performing a reminder operation based on the reminder instruction of the false fingerprint recognition.

In some embodiments, the calling the police based on the alarm instruction may include: in response to an alarm device including a voice alarm device, controlling the voice alarm device to perform a voice alarm based on the alarm instruction; and/or in response to the alarm device including an optical alarm device, controlling the optical alarm device to perform an optical alarm based on the alarm instruction; and/or in response to the alarm device including a remote alarm device, controlling the remote alarm device to perform a remote alarm based on the alarm instruction.

In some embodiments, the controlling the remote alarm device to perform a remote alarm based on the alarm instruction may include: controlling the remote alarm device to call a relevant telephone terminal device based on the alarm instruction; and/or controlling the remote alarm device to push alarm information to a relevant network terminal device based on the alarm instruction.

Another aspect of embodiments of the present disclosure may provide a device for recognizing a fingerprint. The device may include: a liveness recognition module and a fingerprint recognition module. The liveness recognition module may be configured to determine a liveness recognition result by performing a liveness recognition on a subject in response to the subject having a fingerprint; in response to the liveness recognition result including that the subject is a living body, the finger recognition module may be executed. The fingerprint recognition module may be configured to obtain a fingerprint image; and determining the liveness recognition result by searching for the fingerprint image in a pre-stored fingerprint image set.

In some embodiments, the liveness recognition module may include: a light emitting diode configured to emit an infrared light towards a subject; a photoelectric receiver configured to receive the infrared light reflected by the subject and transmit an infrared light intensity of the infrared light reflected by the subject to a processor; the processor configured to determine whether the infrared light intensity of the infrared light reflected by the subject is within a predetermined intensity range and/or a curve formed by changed infrared light intensities within a detection time period conforms to a predetermined curve, and determining the liveness recognition result including that the subject is a living body in response to the infrared light intensity of the infrared light reflected by the subject being within the predetermined intensity range and/or the curve formed by the changed infrared light intensities within the detection time period failing to conform to the predetermined curve.

In some embodiments, the device may further include an alarm device. The liveness recognition module may be configured to transmit an alarm instruction to the alarm device in response to the liveness recognition result including that the subject is not the living body. The alarm device may be configured to call the police based on the alarm instruction.

In some embodiments, the alarm device may include: an audio alarm device configured to be controlled to perform a voice alarm based on the alarm instruction; and/or an optical alarm device configured to be controlled to perform an optical alarm based on the alarm instruction; and/or a remote alarm device configured to be controlled to perform a remote alarm based on the alarm instruction.

In some embodiments, the device may further include: a reminder device. The fingerprint recognition module may be configured to transmit an alarm instruction or a reminder instruction of a false fingerprint recognition to the reminder device in response to failing to search for the fingerprint image in the pre-stored fingerprint image set. The reminder device may be configured to call the police based on the alarm instruction or perform a reminder operation based on the reminder instruction of the false fingerprint recognition.

In some embodiments, the reminder device may include: an audio device configured to be controlled to perform a voice alarm based on the alarm instruction or perform a reminder operation based on the reminder instruction of the false fingerprint recognition; and/or a remote reminder device configured to be controlled to perform a remote alarm based on the alarm instruction or perform a reminder operation based on the reminder instruction of the false fingerprint recognition.

Another aspect of embodiments of the present disclosure may provide a fingerprint lock including a device for recognizing a fingerprint according to any embodiments of the present disclosure.

Another aspect of embodiments of the present disclosure may provide a device for recognizing a liveness fingerprint. The device may include: a light-transmitting plate, a photoelectric receiver, a fingerprint scanner, a chip, and an infrared light emitting device. The infrared light emitting device and the photoelectric receiver may be disposed oppositely. The infrared light emitting device may be disposed on one side end of the fingerprint scanner. The photoelectric receiver may be disposed on another side end of the fingerprint scanner. The light transmitting plate may be located above the fingerprint scanner, the infrared light emitting device, and the optical receiver. An infrared light emitted by the infrared light emitting device may travel through the light transmitting plate towards the subject. The photoelectric receiver may be configured to receive the infrared light reflected by the subject. The fingerprint scanner may be configured to scan a fingerprint image of the subject placed on the light transmitting plate and transmit the fingerprint image to the chip. The chip may be connected to the photoelectric receiver, the infrared light emitting device, and the fingerprint scanner. The chip may be configured to determine a liveness fingerprint recognition result of the subject based on the infrared light received by the photoelectric receiver and search for the fingerprint image of the subject in a pre-stored fingerprint image set to determine a fingerprint recognition result.

In some embodiments, the device may further include: a support plate under the fingerprint scanner and contact with the fingerprint scanner, the infrared light emitting device, and the photoelectric receiver. The support plate may be configured to support the fingerprint scanner, the infrared light emitting device, and the photoelectric receiver.

In some embodiments, the infrared light emitting device may include an infrared light emitting diode.

In some embodiments, the light transmitting plate may include a glass plate transmitting the infrared light.

Another aspect of embodiments of the present disclosure may provide a fingerprint lock including a liveness fingerprint recognition device, a controller, a motor drive module, and a mechanical lock body. The motor drive module may be located in the mechanical lock body. The liveness fingerprint recognition device may be connected to the controller. The motor drive module may be connected to the controller. The liveness fingerprint recognition device may transmit a fingerprint recognition result to the controller. In response to the fingerprint recognition result including that the fingerprint recognition is confirmed, the controller may transmit an unlocking instruction to the motor drive module. The motor drive module may be configured to perform the unlocking instruction transmitted by the controller.

In some embodiments, the fingerprint lock may further include a password input device connected to the controller. The password input device may include a button for inputting a password, and transmit the password to the controller. The controller may determine a password verification result by verifying whether the password is a predetermined password, and transmit an unlocking instruction to the motor drive module in response to the password verification result including that the password is the predetermined password.

In some embodiments, the fingerprint lock may further include a reminder device. The controller may be configured to transmit an alarm instruction to the reminder device in response to the fingerprint recognition result including that the fingerprint recognition fails to be confirmed. The reminder device may be connected to the controller for calling the police based on the alarm instruction. Additionally or alternatively, the controller may be configured to transmit an alarm instruction or a reminder instruction of an false fingerprint recognition to the reminder device in response to the fingerprint recognition result including that the fingerprint recognition fails to be confirmed. The reminder device may be connected to the controller for calling the police based on the alarm instruction or performing a reminder operation based on the reminder instruction of the false fingerprint recognition.

In some embodiments, the alert device may include: an audio device configured to be controlled to perform a voice alarm based on the alarm instruction or perform a reminder operation based on the reminder instruction of the false fingerprint recognition; and/or an optical reminder device configured to control an optical alarm device to perform an optical alarm based on the alarm instruction; and/or a remote reminder device configured to be controlled to perform a remote alarm based on the alarm instruction.

In some embodiments, the fingerprint lock may further include: a display device connected to the controller and configured to display control information of the controller.

Another aspect of embodiments of the present disclosure may provide a fingerprint module of a smart lock. The fingerprint module may include: a retaining bracket, and a fingerprint collector and a fingerprint identifier disposed on the retaining bracket, respectively.

In some embodiments, the fingerprint identifier may be fixed to the retaining bracket. The fingerprint collector may be fixed to the fingerprint identifier.

In some embodiments, the fingerprint collector and the fingerprint identifier may be respectively disposed on two sides of the retaining bracket.

In some embodiments, a communication line of the fingerprint collector may be connected to a terminal block of the fingerprint identifier to make the fingerprint collector fixedly connected to the fingerprint identifier.

In some embodiments, the fingerprint identifier may be detachably connected to the retaining bracket, and the fingerprint collector may be detachably connected to the fingerprint identifier.

In some embodiments, the fingerprint identifier may be detachably connected to the retaining bracket through a clamping connection, and the fingerprint collector may be detachably connected to the fingerprint identifier through an inserting connection.

In some embodiments, the fingerprint module may include a buffer disposed between the fingerprint collector and the retaining bracket.

In some embodiments, the retaining bracket may include a mounting groove. The buffer may be pressed inside the mounting groove by the fingerprint collector.

Another aspect of embodiments of the present disclosure may provide a smart lock. The smart lock may include a fingerprint module of any of the above-described fingerprint modules. The fingerprint module may be disposed at a handle of the smart lock.

In some embodiments, a retaining bracket may be fixed to an inner cavity of the handle through a clamping connection. A handle housing of the handle may include a through hole from which a fingerprint connector may be exposed.

In some embodiments, the inner cavity of the handle may include at least two clamping ribs. All of the at least two clamping ribs may form a rib groove clamped with the retaining bracket.

In some embodiments, the smart lock may be a push-pull lock.

In some embodiments, a fingerprint identifier may be communicated with a main control board of the smart lock via a data line. The inner cavity of the handle may include a wiring groove. The data line may be placed along the wiring groove.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals present similar structures, and wherein:

FIG. 1 is a schematic diagram illustrating an exemplary application scenario of an identity confirmation system according to some embodiments of the present disclosure;

FIG. 2 is a schematic diagram illustrating example hardware and/or software of an identity confirmation device according to some embodiments of the present disclosure;

FIG. 3 is a schematic diagram illustrating exemplary hardware and/or software of a computing device according to some embodiments of the present disclosure;

FIG. 4 is a block diagram illustrating an exemplary detection module according to some embodiments of the present disclosure;

FIG. 5A is a schematic diagram of an exemplary identity confirmation device according to some embodiments of the present disclosure;

FIG. 5B is a schematic diagram of an exemplary identity confirmation device according to some embodiments of the present disclosure

FIG. 6 is a flowchart illustrating an exemplary process for identity confirmation according to some embodiments of the present disclosure;

FIG. 7 is a flowchart illustrating an exemplary process for identity confirmation according to some embodiments of the present disclosure;

FIG. 8 is a schematic diagram illustrating exemplary curves of signals received by a human finger and a fake finger according to some embodiments of the present disclosure;

FIG. 9 is a block diagram illustrating an exemplary identity confirmation device according to some embodiments of the present disclosure;

FIG. 10 is a flowchart illustrating an exemplary process for recognizing a living body according to some embodiments of the present disclosure;

FIG. 11 is a schematic diagram illustrating exemplary signal curves of different blood oxygen levels of subjects according to some embodiments of the present disclosure;

FIG. 12A is a section view of an exemplary identity confirmation device according to some embodiments of the present disclosure;

FIG. 12B is a top view of an exemplary identity confirmation device according to some embodiments of the present disclosure;

FIG. 13A is a schematic diagram illustrating an exemplary distribution of a light emitting element and a photoelectric receiver according to some embodiments of the present disclosure;

FIG. 13B is a schematic diagram illustrating an exemplary light emitting element and an exemplary photoelectric receiver according to some embodiments of the present disclosure;

FIG. 13C is a schematic diagram illustrating exemplary light emitting elements and exemplary photoelectric receivers according to some embodiments of the present disclosure;

FIG. 13D is a schematic diagram illustrating an exemplary distribution of light emitting elements and photoelectric receivers according to some embodiments of the present disclosure;

FIG. 14A is a schematic diagram illustrating an exemplary structure of a door lock device according to some embodiments of the present disclosure;

FIG. 14B is a schematic diagram illustrating an exemplary structure of a door lock device according to some embodiments of the present disclosure;

FIG. 15 is an exploded view of an exemplary identity confirmation device according to some embodiments of the present disclosure;

FIG. 16 is a section view of an exemplary identity confirmation device according to some embodiments of the present disclosure;

FIG. 17 is an exploded view illustrating an exemplary door handle containing an identity confirmation device according to some embodiments of the present disclosure;

FIG. 18A is a top view illustrating an exemplary door handle containing an identity confirmation device according to some embodiments of the present disclosure;

FIG. 18B is a section view illustrating an exemplary door handle containing an identity confirmation device according to some embodiments of the present disclosure;

FIG. 19 is an exploded view illustrating an exemplary identity confirmation device according to some embodiments of the present disclosure;

FIG. 20 is an exploded view of an exemplary shell structure according to some embodiments of the present disclosure;

FIG. 21A is a schematic diagram illustrating an exemplary curve of a thickness of an optical lens and an optical signal intensity according to some embodiments of the present disclosure;

FIG. 21B is a schematic diagram illustrating an exemplary curve of a total transmittance of an optical lens and an optical signal intensity according to some embodiments of the present disclosure;

FIG. 21C is a schematic diagram illustrating an exemplary curve of a haze of an optical lens and an optical signal intensity according to some embodiments of the present disclosure;

FIG. 22 is a schematic diagram illustrating an exemplary communication module according to some embodiments of the present disclosure;

FIG. 23 is a schematic diagram illustrating an exemplary input/output module according to some embodiments of the present disclosure;

FIG. 24 is a flowchart illustrating an exemplary process for confirming identity of a subject according to some embodiments of the present disclosure;

FIG. 25 is a flowchart illustrating an exemplary process for confirming identity of a subject according to some embodiments of the present disclosure;

FIG. 26 is a block diagram illustrating an exemplary identity confirmation device according to some embodiments of the present disclosure;

FIG. 27 is a schematic diagram illustrating an exploded structure of an exemplary identity confirmation device according to some embodiments of the present disclosure;

FIG. 28 a schematic diagram illustrating an exemplary fingerprint collector according to some embodiments of the present disclosure;

FIG. 29 is a schematic diagram illustrating an exemplary retaining bracket according to some embodiments of the present disclosure;

FIG. 30 a schematic diagram illustrating an exemplary identity confirmation device according to some embodiments of the present disclosure;

FIG. 31 is a section view illustrating an exemplary identity confirmation device according to some embodiments of the present disclosure;

FIG. 32 a schematic diagram illustrating an exemplary handle of an identity confirmation device according to some embodiments of the present disclosure;

FIG. 33 is a section view illustrating an exemplary handle according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. It should be understood that the exemplary embodiments are provided merely for better comprehension and application of the present disclosure by those skilled in the art, and not intended to limit the scope of the present disclosure. Unless obviously obtained from the context or the context illustrates otherwise, the same numeral in the drawings refers to the same structure or operation.

It should be understood that “systems,” “devices,” “unit,” and/or “modules” used herein are a manner for distinguishing different components, elements, components, parts, or assemblies in different levels. However, if other words may achieve the same purpose, the words may be replaced by other expressions.

As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

While the present disclosure makes various references to certain modules or units in the system of embodiments of the present disclosure, any number of different modules or units may be used and run on a terminal and/or a server. The modules are merely illustrative, and different modules may be used in different aspects of the systems and methods.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Some embodiments of the present disclosure may provide a liveness fingerprint recognition device and a fingerprint lock. The liveness fingerprint recognition device may include a light transmitting plate, a photoelectric receiver, a fingerprint scanner, a chip, and an infrared light emitting device. An infrared light emitted by the infrared light emitting device may travel through the light transmitting plate towards a subject. The photoelectric receiver may be configured to receive the infrared light reflected by the subject. The fingerprint scanner may be configured to scan a fingerprint image of the subject placed on the light transmitting plate and transmit the fingerprint image to the chip. In one aspect, the chip may be configured to search for fingerprint information of the subject in a pre-stored fingerprint information set to determine identity of the subject. In another aspect, the chip may be configured to determine whether the subject is a living body based on an infrared light intensity of the infrared light received by the photoelectric receiver. The liveness fingerprint recognition device provided in the present disclosure may prevent an unauthorized person from stealing the subject's fingerprint and making a fingerprint film or a fingerprint sticker, thereby increasing the safety of the liveness fingerprint recognition device (e.g., the fingerprint lock) using the fingerprint recognition. In some embodiments, the fingerprint scanner may be omitted from the liveness fingerprint recognition device. The liveness fingerprint recognition device without the fingerprint scanner may be used at the inside of a door. When the subject needs to open the door from the inside, the liveness recognition of the subject may be performed, in order to prevent the door from being accidently unlocked by, for example, an unauthorized person or animal (e.g., a child, a pet (e.g., a dog)) from the inside, such that the security is improved. In some embodiments, the liveness fingerprint recognition device may include a sensor (e.g., a camera). Once the sensor senses a person near the door is within a certain distance, the sensor may capture an image or video of the person. If the person is unauthorized to unlock the door, the liveness fingerprint recognition device may transmit reminder information or alarm information to an owner or a manager of the property protected by the door, thereby avoiding the unauthorized person from using an unlocking device to unlock the door from the outside, e.g., through the peephole on the door.

In some embodiments, the liveness fingerprint recognition device may include a controller configured to control an operating status of the liveness fingerprint recognition device (e.g., a smart door lock) based on the recognition result.

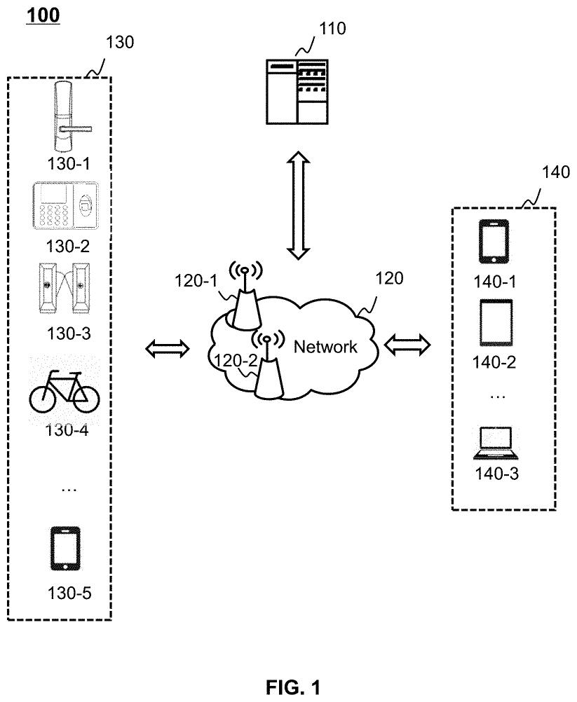

FIG. 1 is a schematic diagram illustrating an exemplary application scenario of an identity confirmation system according to some embodiments of the present disclosure. The identity confirmation system 100 may include a server 110, a network 120, an identity confirmation device 130, and a user terminal 140. The identity confirmation system 100 may be configured to obtain identity confirmation information (such as first recognition information, second recognition information, etc.) of a user (also referred to as a subject) and confirm identity of the user (also referred to as user identity) based on the identity confirmation information of the user. One or more operations may be performed after the identity of the user is confirmed. For example, the identity confirmation system 100 may be applied to an access control device (e.g., a door lock, a turnstile). Based on the identity confirmation information of the user, whether the user is permitted to pass the access control device may be determined. Further, in response to determining that the user is permitted to pass the access control device, the identity confirmation system 100 may cause the access control device to unlock. As another example, the identity confirmation system 100 may be applied to a time and attendance (TNA) device (e.g., a TNA machine). Whether the identity confirmation information of the user exists in a database corresponding to the TNA device may be determined based on the identity confirmation information of the user. Further, in response to determining that the identity confirmation information of the user exists in the database corresponding to the TNA device, the identity confirmation system 100 may update data of the user in the database, and record the identity confirmation information of the user and a current time point as TNA information of the user. As another example, the identity confirmation system 100 may be applied to a transportation device (e.g., a bicycle, an electrical vehicle, a car, etc.). The transportation device may be a private transportation device (such as a private car) or a shared transportation device (e.g., a shared vehicle, a shared bicycle). Whether the user is an owner or a current lessee of the transportation device may be determined based on the identity confirmation information of the user. Whether to unlock the transportation device may be further determined. As another example, the identity confirmation system 100 may be applied to an online service platform for an Internet service, such as an online payment platform (such as an online shopping platform), an online bank, an online vehicle hailing platform, an online food ordering platform, etc., which requires identity authentication (also referred to as identity confirmation). The identity confirmation system 100 may search for and associate a relevant account of the user in a platform and determine whether a service request of the user is permitted based on the identity confirmation information of the user. As another example, the identity confirmation system 100 may also be applied to an electronic device that requires the identity authentication (e.g., a mobile phone, a laptop, a tablet computer). The identity confirmation system 100 may determine whether an operation request (such as turning on or off of the electronic device, logging in a system of the electronic device, downloading software) of the user is permitted based on the identity confirmation information of the user, and determine a permission level of the user on an application of the electronic device. As another example, the identity confirmation system 100 may be applied to an electrical device or a smart electrical device (e.g., a washing machine, a refrigerator, an air conditioner, an air purifier, a television, a heating device). Whether the user is an owner or a legal user of the electrical device may be determined based on the identity confirmation information of the user. Whether to open a lock of the electrical device may be further determined. It should be noted that the identity confirmation system 100 may also be applied in other devices, scenes, and applications which require the identity confirmation, which is not limited herein. Any device, scene, and/or application that may use the identity confirmation method included in the present disclosure may be within the scope of the present disclosure.

In some embodiments, the server 110 may be configured to process and/or determine information and/or data associated with the identity of the user. For example, the server 110 may process the identity confirmation information of the user in the identity confirmation device 130, and complete confirming the identity of the user based on the identity confirmation information. In some embodiments, the identity confirmation information may include first recognition information and second recognition information. As another example, the server 110 may determine the identity of the user by comparing and/or matching the identity confirmation information of the user acquired by the identity confirmation device 130 with pre-stored user identity confirmation information. As a further example, the server 110 may generate an instruction for controlling the identity confirmation device 130 based on the identity confirmation result. The server 110 may be an independent server or a server group. The server group may be centralized or distributed (e.g., the server 110 may be a distribution system).

In some embodiments, the server 110 may be local or remote. For example, the server 110 may access information and/or data stored in the identity confirmation device 130 or the user terminal 140 via the network 120. In some embodiments, the server 110 may be directly connected to the identity confirmation device 130 or the user terminal 140 to access the information and/or the data stored therein. For example, the server 110 may be located in the identity confirmation device 130 or directly connected to the identity confirmation device 130. In some embodiments, the server 110 may be implemented on a cloud platform. For example, the cloud platform may include a private cloud, a public cloud, a hybrid cloud, a community cloud, a distributed cloud, an inter-cloud or the like, or any combination thereof.

In some embodiments, the server 110 may include a processing device. The processing device may process data and/or information related to the identity confirmation to perform one or more of the functions described in this disclosure. For example, the processing device may receive a signal of an identity confirmation request transmitted by the identity confirmation device 130 or the user terminal 140, and transmit a control instruction to the identity confirmation device 130. As another example, the processing device may acquire the identity confirmation information collected by the identity confirmation device 130, and transmit the identity confirmation result to the user terminal 140. In some embodiments, the processing device may include one or more processing sub-devices (e.g., single-core processing device(s) or multi-core processing device(s)). For example, the processing device may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate an exchange of data and/or information of the identity confirmation system 100. In some embodiments, one or more components (e.g., the server 110, the identity confirmation device 130, the user terminal 140) of the identity confirmation system 100 may transmit data and/or information to other components of the identity confirmation system 100 via the network 120. For example, the identity confirmation information collected by the identity confirmation device 130 may be transmitted to the server 110 via the network 120. As another example, the identity confirmation result of the user in the server 110 may be transmitted to the user terminal 140 via the network 120. In some embodiments, the network 120 may be any type of wired or wireless network. For example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the identity confirmation system may be connected to the network 120 to exchange data and/or information.

The identity confirmation device 130 may be configured to obtain the identity confirmation information of the user and confirm the identity of the user based on the identity confirmation information. After the identity of the user is confirmed, one or more operations may be performed based on the identity of the user. In some embodiments, the identity confirmation device 130 may include a door lock device 130-1, a TNA device 130-2, a turnstile device 130-3, a transportation device 130-4, and a communication device 130-5. For example, when the identity confirmation device 130 includes the door lock device 130-1, whether the user is permitted to open the door lock device 130-1 may be determined based on the identity confirmation information of the user. After the identity confirmation information of the user is determined to be positive, the door lock device 130-1 may be unlocked. The door lock device 130-1 may be applied to a door body, a parking lock, a safe deposit box, a security box (e.g., a portable safe, a smart safe), a gun safe, a lockbox, a package delivery box, a locker, a suitcase, etc. In some embodiments, based on categories, the door lock device 130-1 may include a push-button lock, a dial lock, an electronic key lock, a lock with a touchscreen keypad, a coded lock, a remote control lock, a key card (such as a magnetic key card, an integrated circuit (IC) key card) lock, a biometric lock (e.g., a fingerprint, a palmar digital vein, a palm print, the face, voice, an iris, a retina), or the like, or any combination thereof. As another example, when the identity confirmation device 130 includes the TNA device 130-2, whether the identity confirmation information of the user exists in a database corresponding to the TNA device 130-2 may be determined. Further, in response to the identity confirmation information of the user existing in the database corresponding to the TNA device 130-2, the TNA device 130-2 may update data of the user in the database and record the identity confirmation information of the user and a current time point as TNA information (for example, a name, an employee number, an attendance time, a geographic location) of the user. In some embodiments, the TNA device 130-2 may include a biological recognition TNA device, a mobile TNA device. In some embodiments, the biometric TNA device may include a fingerprint TNA device, a palmar digital vein TNA device, a palm print TNA device, a face TNA device, a voice TNA device, an iris TNA device, a retinal TNA device, or the like, or any combination thereof. In some embodiments, the mobile TNA device may refer to a mobile terminal (for example, a mobile phone, a computer, a smart watch, a wearable device) which is installed with a TNA client terminal (e.g., software, a mobile application) and configured to implement the TNA. As another example, when the identity confirmation device 130 includes the turnstile device 130-3, whether the user is permitted to pass the turnstile device 130-3 may be determined based on the identity confirmation information of the user. Further, in response to the determination result including that the user is permitted to pass the turnstile device 130-3, the turnstile device 130-3 may be unlocked to allow the user to enter; conversely, the turnstile device 130-3 may be not unlocked. The turnstile device 130-3 may be applied to an entrance or an exit of, e.g., an airport, a subway station, a light rail station, a bus station, a train station, an office building, a residential area, etc., that requires the identity confirmation. In some embodiments, the turnstile device 130-3 may include a swing turnstile device, a wing brake device, a tripod turnstile device, a rotatable turnstile device, a flat turnstile device, or the like, or any combination thereof. As another example, when the identity confirmation device 130 includes the transportation device 130-4 (e.g., a bicycle, an electrical vehicle, a car), the transportation device 130-4 may include a private transportation device (e.g., a private car) or a shared transportation device (such as a shared vehicle, a shared bicycle). Whether the user is an owner or a current lessee of the transportation device 130-4 may be determined based on the identity confirmation information of the user. Whether to unlock a lock of the transportation device 130-4 may be further determined. After the transportation device 130-4 confirms the identity confirmation information of the user to be positive, the transportation device 130-4 may be unlocked or initiated. When the identity confirmation device 130 includes the communication device 130-5, the communication device 130-5 may determine whether an operation request (such as turning on or off of the communication device 130-5, logging in a system of the communication device 130-5, downloading software) of the user is permitted, and a permission level of the user for an application (e.g., an online payment platform) on the communication device 130-5 may be determined based on the identity confirmation information of the user. Specific forms of the communication device 130-5 may be found in relevant descriptions of the user terminal 140 in the present disclosure.

It should be noted that the identity confirmation device 130 may be not limited to the door lock device 130-1, the TNA device 130-2, the turnstile device 130-3, the transportation device 130-4, or the communication device 130-5 shown in FIG. 1, and be applied to other devices that requires the identity confirmation, which is not limited herein. Any device that may use the identity confirmation method included in the present disclosure is within the scope of the present disclosure.

In some embodiments, the user terminal 140 may be configured to acquire information or data of the identity confirmation system 100. In some embodiments, the user terminal 140 may be configured to acquire push information of a status of the identity confirmation device 130. In some embodiments, the push information may include on/off status information of the identity confirmation device 130, passing information of the user, usage information of the user, alarm information, or the like. In some embodiments, the user may acquire the user confirmation information via the user terminal 140. For example, the user terminal 140 may be connected to the identity confirmation device 130 (e.g., via a wired connection, a wireless connection). The user may acquire the user confirmation information via the user terminal 140. The user confirmation information may be transmitted to the server 110 via the user terminal 140. In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a smart mobile device, a virtual reality device, an augmented reality device, or the like, or any combination thereof. In some embodiments, the smart home device may include a smart lighting device, a control device of an intelligent electrical device, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof.

In some embodiments, the user terminal 140 may directly acquire the identity confirmation information of the user (in this case, the identity confirmation device 130 is omitted, or the identity confirmation device 130 and the user terminal 140 are a same device). For example, the user terminal 140 may include a device (e.g., a fingerprint collector, a face recognition device, a voice recognition device, an iris recognition device) configured to acquire the identity confirmation information of the user. The identity confirmation information acquired by the user terminal 140 may be transmitted to the server 110 via the network 120.

In some embodiments, the identity confirmation system 100 may include a database. The database may store data (e.g., the pre-acquired user confirmation information) and/or instructions (e.g., an unlocking/locking instruction, an alarm instruction). In some embodiments, the database may store data acquired from the identity confirmation device 130 and/or the user terminal 140. In some embodiments, the database may store information and/or instructions to be executed or used by the server 110 to perform the exemplary methods described in the present disclosure. In some embodiments, the database may include a mass storage, a removable storage, a volatile read-and-write memory (e.g., a random access memory (RAM)), a read-only memory (ROM), or the like, or any combination thereof. In some embodiments, the database may be implemented on a cloud platform. For example, the cloud platform may include a private cloud, a public cloud, a hybrid cloud, a community cloud, a distributed cloud, an inter-cloud or the like, or any combination thereof.

In some embodiments, the database may be connected to the network 120 to communicate with one or more components of the identity confirmation system 100 (e.g., the server 110, the identity confirmation device 130, the user terminal 140). One or more components of the identity confirmation system 100 may access data or instructions stored in the database via the network 120. In some embodiments, the database may be directly connected to one or more components (e.g., the server 110, the identity confirmation device 130, the user terminal 140) of the identity confirmation system 100. In some embodiments, the database may be part of the server 110. In some embodiments, the server 110 may be independent from the identity confirmation device 130. In some embodiments, the server 110 may be located in the identity confirmation device 130.

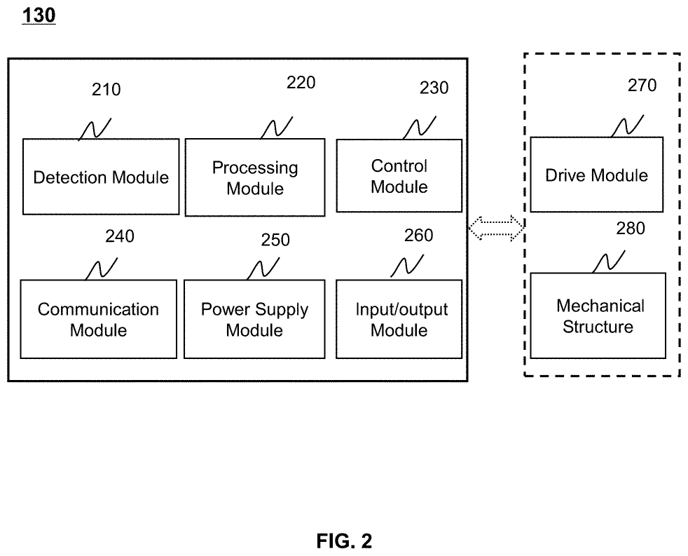

FIG. 2 is a schematic diagram illustrating example hardware and/or software of an identity confirmation device according to some embodiments of the present disclosure. As shown in FIG. 2, the identity confirmation device 130 may include a detection module 210, a processing module 220 (also referred to as a processor), a control module 230 (also referred to as a micro control unit (MCU) or a controller), a communication module 240 (also referred to as an alarm module), a power supply module 250, and an input/output module 260. It should be noted that the module, the unit, and the sub-unit mentioned in the present disclosure may be implemented by hardware, software, or a combination thereof. The hardware may be implemented by a circuit or a structure formed by entity components. The software may be implemented by storing operations of the module, the unit, or the sub-unit in the form of code in a storage, which may be executed by appropriate hardware (e.g., a microprocessor). As used herein, that a module, a unit, or a sub-unit performs an operation, unless stated otherwise, may refer to that a software program configured to effectuate the function is executed, or that the hardware configured to realize the function is used. In the meanwhile, the module, the unit, or the sub-unit mentioned in the present disclosure do not constitute a limitation on suitable hardware; any hardware that is capable of implementing such a function may be within the scope of the present disclosure. For example, different modules, units, or sub-unit mentioned in the present disclosure may correspond to same hardware. As another example, a same module, unit, or sub-unit mentioned in the present disclosure may be implemented on different hardware. In some embodiments, the server 110 may be located in the identity confirmation device 130. The identity confirmation device 130 and the server 110 may be connected via an internal wired network. In some embodiments, the server 110 may also be located at a cloud and connected to the identity confirmation device 130 via a wireless network. A portion of or all operations of a portion of the modules of the identity confirmation device 130 may be implemented by the server 110.

The detection module 210 may be configured to obtain identity confirmation information of a user. The identity confirmation information may include first recognition information and second recognition information. In some embodiments, the first recognition information (also referred to as identity recognition information) may be configured to indicate identity of the user. In some embodiments, the first recognition information may include biometric feature information, password information, identity (ID) information of the user, or the like, or any combination thereof. The biometric feature information may include physiological characteristics that may be measured, identified, or verified on a human individual, distinguishing from other human individuals. In some embodiments, the biometric feature information may include a fingerprint, a palm print, a palmar digital vein, the face, a heart rate, voice, an iris, an retina, or the like, or any combination thereof. In some embodiments, the password information may include digit, character, text, or the like, or any combination thereof. In some embodiments, the password information may include an authentication gesture, an answer to an authentication question, an image selection result, or the like, or any combination thereof. In some embodiments, the ID information of the user may include a name, a nickname, a series number, an employee number, contact information (e.g., a phone number, a mobile phone number, a mailbox) of the user, or the like, or any combination thereof. In some embodiments, the ID information of the user may be stored in a magnetic key card. For example, the first recognition information may only be the biometric feature information (e.g., the fingerprint, the palmar digital vein). As another example, the first recognition information may be a combination of one or more types of the biometric feature information and the password information or the ID information of the user. As a further example, the first recognition information may only include the password information and/or the ID information of the user.

The second recognition information (also referred to as liveness identification information) may be configured to indicate whether the user is a living body. In some embodiments, the second recognition information may include a blood oxygen level, a heart rate, a palmar digital vein, facial information, or the like, or any combination thereof. For example, the second recognition information may include blood oxygen level information (e.g., the blood oxygen level). As another example, the second recognition information may include blood oxygen information and heart rate information (e.g., the heart rate). As a further example, the second recognition information may include the blood oxygen information, the heart rate information, and palmar digital vein information (e.g., the palmar digital vein).

The processing module 220 may be configured to process data from the detection module 210, the control module 230, the communication module 240, the power supply module 250, and/or the input/output module 260. For example, the processing module 220 may process the identity confirmation information from the detection module 210. As another example, the processing module 220 may retrieve the identity confirmation information obtained by the detection module 210 in a pre-stored identity confirmation information set. The processing module 220 may compare or analyze the identity confirmation information obtained by the detection module 210 and the retrieved identity confirmation information to determine an identity detection result (also referred to as a detection result) of the subject. As a further example, the processing module 220 may process instructions or operations from the input/output module 260. In some embodiments, the processed data may be stored in a storage or a hard disk. In some embodiments, the processing module 220 may transmit the processed data to one or more components of the identity confirmation system 100 via the communication module 240 or the network 120. For example, the processing module 220 may transmit the identity detection result of the subject to the control module 230. The control module 230 may perform a subsequent operation or an instruction based on the identity detection result. As another example, the identity confirmation device 130 may include a door lock device. The control module 230 may transmit an instruction for controlling the door lock device to unlock to the drive module 270 after the identity confirmation information of the subject is determined to be positive. As a further example, the identity confirmation device 130 may be a communication device. The control module 230 may transmit an instruction for unlocking or controlling a login of a user account to the communication device after the identity confirmation information of the subject is determined to be positive.

The control module 230 may be associated with other modules of the identity confirmation device 200. In some embodiments, the control module 230 may control an operating mode of other modules of the identity confirmation device 200 (e.g., the communication module 240, the power supply module 250, the input/output module 260, the drive module 270). For example, the control module 230 may control an operating mode of the detection module 210 based on the detection result of the subject. The control module 230 may control the detection module 210 to enter a standby mode within a certain time period (e.g., 1 second, 2 seconds . . . ) after the detection result of the subject is generated, waiting for a next wake-up and/or a next detection. As another example, the identity confirmation device 130 may include the door lock device. The control module 230 may control an operating mode of the drive module 270. In response to the detection result of the subject being positive, the control module 230 may transmit an unlocking instruction to the drive module 270. The drive module 270 may drive a mechanical structure 280 to unlock. As a further example, the control module 230 may control an operating mode (e.g., a normal mode, a power saving mode) of the power supply module 250, a power supply time, etc. When a remaining power of the power supply module 250 reaches a specific threshold (e.g., 10%), the control module 230 may control the power supply module 250 into the power saving mode or to connect to an external power supply for charging. As a further example, the control module 230 may control an operating mode of the communication module 240. In response to the detection result of the subject being negative, the control module 230 may control the communication module 240 to emit reminder information or alarm information.

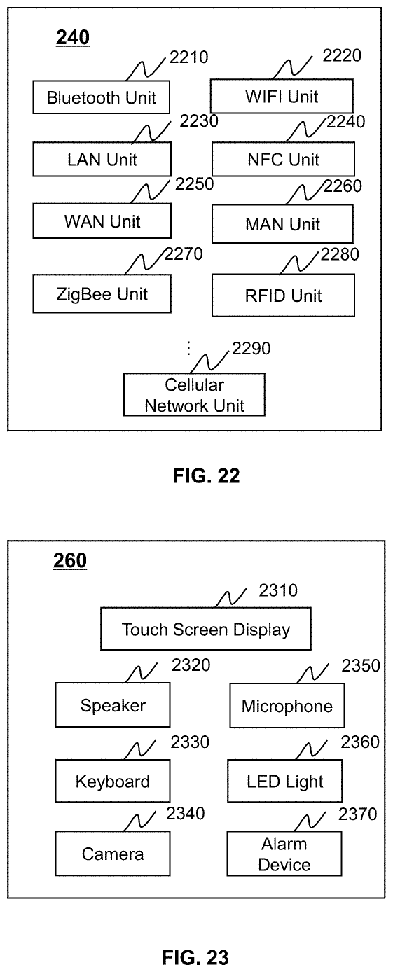

In some embodiments, the communication module 240 may be configured to exchange information or data. In some embodiments, the communication module 240 may be configured to facilitate a communication between internal components of the identity confirmation device 130 (e.g., the detection module 210, the processing module 220, the control module 230, the power supply module 250, the input/output module 260, and/or the drive module 270). For example, the detection module 210 may transmit the identity confirmation information (e.g., the first recognition information, and/or the second recognition information, etc.) to the communication module 240. The communication module 240 may transmit the identity confirmation information to the processing module 220. In some embodiments, the communication module 240 may also be configured to facilitate a communication between the identity confirmation device 130 and other components of the identity confirmation system 100 (e.g., the server 110, the user terminal 140). For example, the communication module 240 may transmit status information (e.g., an on or off status) of the identity confirmation device 130 to the server 110. The server 110 may monitor the identity confirmation device 130 based on the status information. The communication module 240 may utilize wired technology, wireless technology, or a hybrid thereof. The wired technology may be based on one or more optical cables such as a metal cable, a hybrid cable, a fiber optic cable, etc. The wireless technology may include Bluetooth, wireless network (Wi-Fi), Zigbee, Near Field Communication (NFC), Radio Frequency Identification (RFID), cellular network (e.g., a Global System for Mobile Communication (GSM), a Code-Division Multiple Access (CDMA), 3G, 4G, 5G, etc.), Narrow Band Internet of Things (NBIoT), etc. In some embodiments, the communication module 240 may encode the transmitted information by utilizing one or more encoding techniques, for example, phase encoding, non-return-to-zero line encoding, differential Manchester encoding, etc. In some embodiments, the communication module 240 may select different transmission and encoding modes based on types of data to be transmitted or types of the network. In some embodiments, the communication module 240 may include one or more communication interfaces for different communication techniques. In some embodiments, other modules of the identity confirmation system 100 may be dispersed on multiple devices, and each of the other modules may include one or more communication modules 240, respectively, to transmit information between the modules. In some embodiments, the communication module 240 may include a receiver and a transmitter. In other embodiments, the communication module 240 may be a transceiver. In some embodiments, the communication module 240 may also have a reminder and/or an alarm function. For example, in response to the detection result of the subject being negative, the communication module 240 may transmit the reminder information or the alarm information to the subject and/or the user. In some embodiments, types of the alarm information may include a voice alarm, an optical alarm, a remote alarm, or the like, or any combination thereof. For example, when the type of the alarm information includes the remote alarm, the communication module 240 may transmit the reminder information or the alarm information to a relevant terminal of the user. The communication module 240 may also establish a communication (e.g., an audio call, a video call) between the subject and the relevant terminal of the user. In some embodiments, in response to the detection result of the subject being positive, the communication module 240 may also transmit the reminder information to the subject or the user. For example, the communication module 240 may transmit the reminder information that the detection result of the subject is positive to the user. As another example, the communication module 240 may transmit the reminder information that the detection result of the subject is positive to the relevant terminal of the user. More descriptions of the communication module 240 may be found elsewhere in the present disclosure, for example, FIG. 22 or the description thereof.

In some embodiments, the power supply module 250 may provide power to other components (e.g., the detection module 210, the processing module 220, the control module 230, the communication module 240, the input/output module 260, the drive module 270) of the identity confirmation system 100. The power supply module 250 may receive a control signal from the processing module 220 to control a power output of the identity confirmation device 130. For example, when the identity confirmation device 130 does not receive any operation within a certain time period (e.g., 1 second, 2 seconds, 3 seconds, or 4 seconds), the power supply module 250 may only supply power to a storage, and switch the identity confirmation device 130 in the standby mode. As another example, when the identity confirmation device 130 does not receive any operation within a certain time period (e.g., 1 second, 2 seconds, 3 seconds, or 4 seconds), the power supply module 250 may not supply power to the components of the identity confirmation device 130. Data of the identity confirmation device 130 may be transferred to a hard disk. The identity confirmation device 130 may be in the standby mode or sleep mode. In some embodiments, the power supply module 250 may include at least one battery. The at least one battery may include a dry battery, a lead storage battery, a lithium battery, a solar battery, a wind power battery, a mechanical power battery, or the like, or any combination thereof. The solar battery may convert solar energy into electrical energy and store thereof in the power supply module 250. The wind energy battery may convert wind energy into electrical energy and store thereof in the power supply module 250. The mechanical energy battery may convert mechanical energy into electrical energy and store thereof in the power supply module 250. The solar battery may include a silicon solar battery, a thin-film solar battery, a nanocrystalline and chemical solar battery, a fuel-sensitized solar battery, a plastic solar battery, etc. The solar battery may be distributed on the identity confirmation device 130 in the form of multiple panels. In some embodiments, the processing module 220 may transmit a control signal to an audio device (e.g., a speaker) of the identity confirmation device 130 in response to the power of the power supply module 250 smaller than a power threshold (e.g., the power is 10%). The control signal may control the audio device to transmit an audio reminder. The audio reminder may include information of insufficient power of the power supply module 250. In some embodiments, the processing module 220 may transmit a control signal to the power supply module 250 in response to the power of the power supply module 250 smaller than the power threshold. The control signal may control the power supply module 250 to perform a charging operation. In some embodiments, the power supply module 250 may include a backup power supply. In some embodiments, the power supply module 250 may also include a charging interface. For example, the subject may use a portable electronic device (e.g., a mobile phone, a tablet computer) or a power bank to temporarily charge the power supply module 250 when the power supply module 250 is in an emergency status (e.g., the power of the power supply module 250 being 0, or an external power system failing to supply the power), and/or reboot the identity confirmation device 130, and/or restart the identity confirmation device 130. In some embodiments, when the identity confirmation device 130 is abnormal (for example, may not identify the first recognition information or the second recognition information of the subject) or insensitive, the identity confirmation device 130 may be restarted or rebooted by connecting the charging interface and the identity confirmation device 130. During the rebooting process, whether software in the identity confirmation device 130 is normal may be determined. In response to the software in the identity confirmation device 130 being normal, it may indicate that the identity confirmation device 130 can work normally; otherwise, the identity confirmation device 130 may be rebooted until it is detected that the software in the identity confirmation device 130 is normal, ensuring that the identity confirmation device 130 may work normally. During the restarting process, whether the software and hardware in the identity confirmation device 130 are normal may be determined. In response to that the software and the hardware in the identity confirmation device 130 are deemed normal, it may indicate that the identity confirmation device 130 can work normally; otherwise, the identity confirmation device 130 may be restarted again until it is detected that the software and the hardware in the identity confirmation device 130 are normal, ensuring that the identity confirmation device 130 may work normally. In some embodiments, upon the detection that the software or the hardware in the identity confirmation device 130 is abnormal, specific remainder information notifying the same may be transmitted to, e.g., the server 110, the user terminal 140.

The input/output module 260 may be configured to obtain, transfer, and/or transmit a signal. The input/output module 260 may connect or communicate with other components of the identity confirmation system 100. The other components of identity confirmation system 100 may establish connection or communication via the input/output module 260. More detailed descriptions of the input/output module 260 may be found elsewhere in the present disclosure, for example, FIG. 23 or the descriptions thereof. The input/output module 260 may include a wired universal serial bus (USB) interface, a serial communication interface, a parallel communication interface, a wireless Bluetooth, an infrared interface, a radio frequency identification (RFID), a WLAN Authentication and Privacy Infrastructure (WAPI), a General Packet Radio Service (GPRS), a Code Division Multiple Access (CDMA), or the like, or any combination thereof. In some embodiments, the input/output module 260 may be connected to the network 120 and obtain information via the network 120. For example, the input/output module 260 may obtain the user confirmation information from the detection module 210 via the network 120 or the communication module 240 and output the user confirmation information. As another example, the input/output module 260 may obtain a reminder instruction or an alarm instruction from the control module 230 via the network 120 or the communication module 240. In some embodiments, the input/output module 260 may include VCC, GND, RS-232, RS-485 (e.g., RS485-A, RS485-B), a general network interface, or the like, or any combination thereof. In some embodiments, the input/output module 260 (e.g., a camera, a microphone) may transmit the obtained user confirmation information to the detection module 210 via the network 120. In some embodiments, the input/output module 260 may encode the transmitted signal by utilizing one or more encoding techniques, for example, phase encoding, non-return-to-zero line encoding, differential Manchester encoding, etc.

In some embodiments, the identity confirmation device 130 may also include the drive module 270 (also referred to as a motor drive module) and the mechanical structure 280. In some embodiments, the drive module 270 may include one or more drive power sources. In some embodiments, the one or more drive power sources may include an electric drive motor. In some embodiments, the electric drive motor may include a direct current (DC) motor, an alternating current sensing motor, a permanent magnet motor, a switching magnetic resistance motor, or the like, or any combination thereof. In some embodiments, the drive module 270 may include one or more drive motors. For example, when the identity confirmation device 130 is applied to the door lock device 130-1, the turnstile device 130-3, or the transportation device 130-4, the detection module 210 may obtain the identity confirmation information of the user. The processing module 220 may complete confirming the identity of the user based on the identity confirmation information of the user. The processing module 220 may transmit a subsequent instruction to the control module 230 based on the user identity confirmation result. In response to the identity of the user being confirmed to be positive, the drive module 270 may make the mechanical structure 280 complete a subsequent operation. For example, the control module 230 may transmit an instruction including an electrical signal. The electrical signal may include a required active status and a required time duration. A drive power source of the drive module 270 may be configured according to the content of the electrical signal (e.g., the electric drive motor of the drive module 270 rotates at a specific speed per minute for a specific time period). The rotation of the drive motor may drive the change (an unlocking, locking, initiating) of the status of the mechanical structure 280 connected thereto. As another example, when the identity confirmation device 130 is applied to the door lock device 130-1, the drive module 270 may drive the mechanical structure 280 (e.g., the bolt) connected thereto to complete the unlocking after the identity confirmation information of the subject is determined to be positive. As a further example, when the identity confirmation device 130 is applied to the turnstile device 130-3, the drive module 270 may drive the mechanical structure 280 (e.g., a roller, a door) connected thereto to provide a passage for the user to pass through after the identity confirmation information of the subject is determined to be positive. As a further example, when the identity confirmation device 130 is applied to the transportation device 130-4, the drive module 270 may drive the mechanical structure 280 (e.g., a lock) connected thereto to complete unlocking after the identity confirmation information of the subject is determined to be positive. Additionally or alternatively, the drive module 270, the drive module 270 may drive the mechanical structure 280 (e.g., a motor) connected thereto to complete initiating.

It should be noted that the mechanical structure 280 may be not limited to the lock of the door lock device 130-1, the roller or the door body of the turnstile device 130-3, the lock or the motor of the transportation device 130-4, and also be other structures, the specific structure may be determined according to a type of the identity confirmation device 130, which may be not limited here. Any mechanical mechanism that may use the identity confirmation method included in the present disclosure may be within the scope of the present disclosure.

It should be understood that the system and the modules thereof shown in FIG. 2 may be implemented in various manners. For example, the system and the modules thereof may be implemented by hardware, software, or a combination thereof. The hardware may be implemented by dedicated logic. The software may be stored in a memory and executed by an appropriate instruction execution system, such as a microprocessor or dedicated design hardware. Those skilled in the art may be appreciated that the above-mentioned methods and systems may be implemented using computer-executable instructions and/or control codes included in processor, such as codes provided, for example, on a disk, a CD or DVD-ROM carrier medium, a programmable memory, a read-only memory (firmware), or a data carrier of an optical or electronic signal carrier. The systems and modules of one or more embodiments of the present disclosure may not only be implemented by hardware circuits of, for example, a large-scale integrated circuit, a gate array, a semiconductor such as a logic chip, a transistor, a programmable hardware device such as a field-programmable gate array, a programmable logic device etc., also be implemented by software executed by various types of processors, and also be implemented by a combination of the above-mentioned hardware circuits and software (e.g., the firmware).

It should be noted that the descriptions of the identity confirmation system and the modules thereof device are merely provided for the purposes of illustration, and not intended to limit the scope of the present disclosure. For persons having ordinary skills in the art, multiple variations and modifications on the modules (e.g., an arbitrary combination of the modules, constructing a sub-system including a portion of the modules and connected to other modules) may be made under the teachings of the present disclosure. However, those variations and modifications do not depart from the scope of the present disclosure. In some embodiments, the drive module 270 or/and the mechanical structure 280 in FIG. 2 may be omitted. For example, when the identity confirmation system 100 may be applied to an online service platform for Internet service, and the drive module 270 and the mechanical structure 280 are not required, the identity confirmation system 100 may search and associate a relevant account in the platform and determine whether to permit a service request of the subject. As another example, the identity confirmation system 100 may be applied to an electronic device that needs identity authorization (e.g., a mobile phone, a laptop computer, a tablet computer), and the drive module 270 and the mechanical structure 280 are not required, the identity confirmation system 100 may directly determine whether to allow the subject to turn on and off the electronic device, to log in a system, download software, etc., and determine a permission level of the subject on an application therein. As a further example, when a transportation device is an electrical vehicle and after identity confirmation of the subject is positive, the drive module 270 may directly activate the electrical vehicle and provide power thereto without the mechanical structure 280. In some embodiments, the detection module 210 and the processing module 220 may be a module that has the function of obtaining and processing the identity confirmation information. Such variations and modifications do not depart from the scope of the present disclosure.

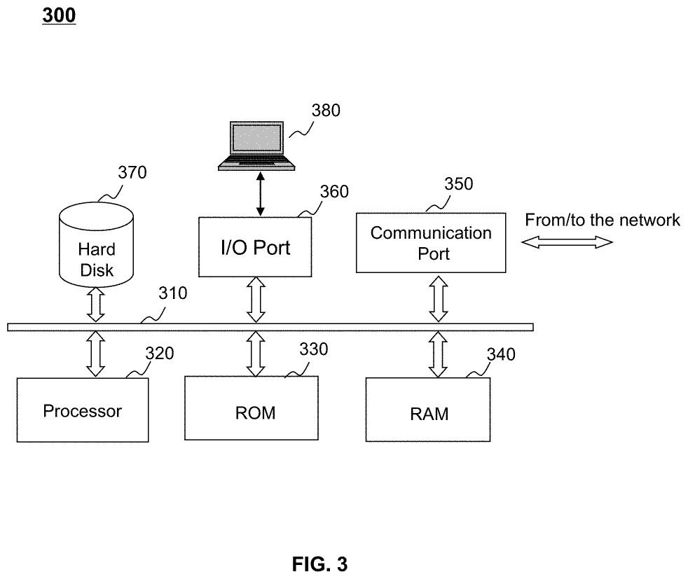

FIG. 3 is a schematic diagram illustrating exemplary hardware and/or software of a computing device according to some embodiments of the present disclosure. In some embodiments, the server 110 and/or the user terminal 140 may be implemented on the computing device 300. For example, the processing device may implement and/or perform the functions of the processing device disclosed in the present disclosure on the computing device 300. As shown in FIG. 3, the computing device 300 may include an internal communication bus 310, a processor 320, a read only memory (ROM) 330, a random access memory (RAM) 340, a communication port 350, an input/output (I/O) port 360, a hard disk 370, and a user interface 380.

The internal communication bus 310 may be configured to realize data communication between the components of the computing device 300. For example, the processor 320 may transmit data to other hardware such as the memory or the I/O port 360 via the internal communication bus 310. In some embodiments, the internal communication bus 310 may include an industrial standard architecture (ISA) bus, an enhanced industry standard architecture (EISA) bus, a video electronics standard association (VESA) bus, a peripheral component interconnect (PCI) bus, etc. In some embodiments, the internal communication bus 310 may be configured to connect each module (e.g., the detection module 210, the processing module 220, the control module 230, the communication module 240, the input/output module 260, the drive module 270) of the identity confirmation system 100 shown in FIG. 1.

The processor 320 may perform computing instructions (e.g., program codes) and the functions of the identity confirmation system 100 described in the present disclosure. The computing instructions may include a program, an object, a component, a data structure, a process, a module, or a function (e.g., a particular function described in the present disclosure). For example, the processor 320 may process user confirmation information (e.g., first recognition information, second recognition information) acquired from the identity confirmation device 130 and/or the user terminal 140 of the identity confirmation system 100, and determine identity of the user based on the confirmation information of the user. In some embodiments, the processor 320 may include a microcontroller, a microprocessor, a reduced instruction set computer (RISC), an application specific integrated circuit (ASIC), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof. Merely for illustration purposes, only one processor is described in the computing device 300 in FIG. 3. However, it should be noted that the computing device 300 in the present disclosure may also include multiple processors.

The memory of the computing device 300 (e.g., the ROM 330, the RAM 340, the hard disk 370) may be configured to store data/information acquired from any other component of the identity confirmation system 100. In some embodiments, the memory of the computing device 300 may be located in the identity confirmation device 130 or the server 110. Exemplary ROM 330 may include a mask ROM (MROM), a programmable ROM (PROM), an erasable programmable ROM (EPROM), an electrically erasable programmable ROM (EEPROM), a compact disk ROM (CD-ROM), a digital versatile disk ROM, etc. Exemplary RAM 340 may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc.

The I/O port 360 may be configured to input or output signals, data, or information. In some embodiments, the I/O port 360 may enable a user interaction with the identity confirmation system 100. For example, the I/O port 360 may include the communication module 240 to implement the communication function and the alarm function of the identity confirmation system 100. In some embodiments, the I/O port 360 may include an input device and an output device. Exemplary input devices may include a keyboard, a mouse, a touch screen, a microphone, or the like, or a combination thereof. Exemplary output devices may include a display device, a loudspeaker, a printer, a projector, or the like, or a combination thereof. Exemplary display devices may include a liquid crystal display (LCD), a light emitting diode (LED)-based display, a flat panel display, a curved screen, a television device, a cathode ray tube (CRT), or the like, or a combination thereof. The communication port 350 may be connected to a network (e.g., the network 150) to facilitate data communications. The connection may be a wired connection, a wireless connection, or a combination thereof. The wired connection may include an electrical cable, an optical cable, a telephone wire, or the like, or any combination thereof. The wireless connection may include Bluetooth, Wi-Fi, WiMax, WLAN, ZigBee, mobile network (e.g., 3G, 4G, 5G, etc.), or the like, or a combination thereof. In some embodiments, the communication port 350 may be a standardized communication port, such as RS232, RS485, etc. In some embodiments, the communication port 350 may be a specially designed communication port.

The hard disk 370 may be configured to store information and/or data generated by or received from the server 110. For example, the hard disk 370 may store the confirmation information of the user. In some embodiments, the hard disk 370 may include a mechanical hard disk (HDD), a solid-state hard disk (SSD), a hybrid hard disk (HHD), etc. In some embodiments, the hard disk 370 may be disposed in the server 110 or the identity confirmation device 130. The user interface 380 may be configured to implement interaction and information exchange between the computing device 300 and the user. In some embodiments, the user interface 380 may be configured to present information and/or data generated by the identity confirmation system 100 to the user. For example, the user interface 380 may present the user confirmation result (e.g., the identity of the user being determined to be positive, the identity of the user being determined to be negative) of the identity confirmation system 100 to the user. In some embodiments, the user interface 380 may include a physical display, such as a display with a speaker, an LCD, an LED display, an OLED display, an electronic ink display (E-INK), etc.

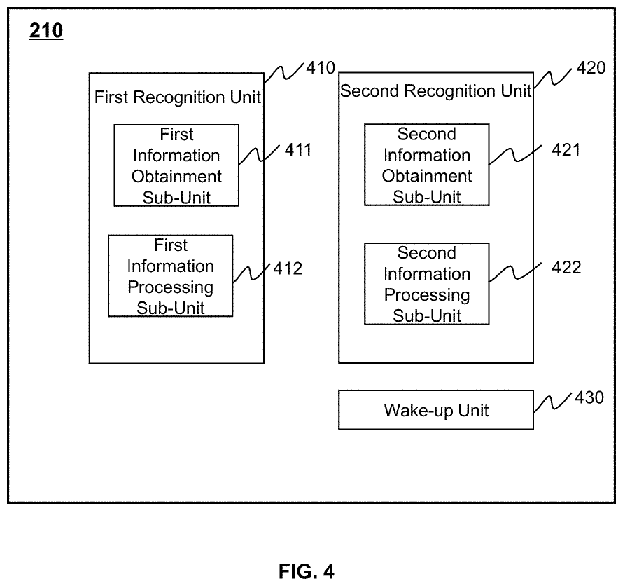

FIG. 4 is a block diagram illustrating an exemplary detection module according to some embodiments of the present disclosure. As shown in FIG. 4, the detection module 210 may include a first recognition unit 410 (also referred to as a first sensor, an identity recognition unit) and a second recognition unit 420 (also referred to as a liveness recognition unit). It should be noted that the module, the unit, and the sub-unit mentioned in the present disclosure may be implemented by hardware, software, or a combination thereof. The hardware may be implemented by a circuit or a structure formed by entity components. The software may be implemented by storing operations of the module, the unit, or the sub-unit in the form of code in a storage, which may be executed by appropriate hardware (e.g., a microprocessor). The software may be implemented by storing operations of the module, the unit, or the sub-unit in the form of code in a storage, which may be executed by appropriate hardware (e.g., a microprocessor). As used herein, that a module, a unit, or a sub-unit performs an operation, unless stated otherwise, may refer to that a software program configured to effectuate the function is executed, or that the hardware configured to realize the function is used. In the meanwhile, the module, the unit, or the sub-unit mentioned in the present disclosure do not limit the corresponding hardware structure as long as the hardware is capable of implementing its function, which may be within the scope of the present disclosure. For example, different modules, units, or sub-unit mentioned in the present disclosure may correspond to a same hardware structure. As another example, a same module, unit, or sub-unit mentioned in the present disclosure may correspond to multiple independent hardware structures.

The first recognition unit 410 may be configured to obtain first recognition information of a subject (also referred to as a user) and determine a first recognition result based on the first recognition information. The first recognition unit 410 may include a first information obtainment sub-unit 411 and a first information processing sub-unit 412. The first information obtainment sub-unit 411 may be configured to obtain the first recognition information of the subject. In some embodiments, the first recognition information may include biometric feature information (e.g., a fingerprint, a palm print, a palmar digital vein, voice, an iris, a retina, the face), password information, ID information of the subject, or the like, or any combination thereof. The ID information of the subject may refer to information indicating identity and/or permission level information of the subject. The ID information of the subject may be stored in a magnetic key card. In some embodiments, the first information obtainment sub-unit 411 may include a fingerprint collector, a palm print collector, a palmar digital vein collector, a voice collector (e.g., a microphone), an iris collector, a facial information collector (e.g., a camera), an electronic tagging reader, an information input device, or the like, or any combination thereof. In some embodiments, there may be multiple first recognition units 410 included in the detection module 210. Different first recognition units 410 may include different first information obtainment sub-units 411. Different first information obtainment sub-units 411 may obtain different types of first recognition information. For example, when the first information obtainment sub-unit 411 includes the fingerprint collector, the fingerprint collector may be configured to obtain the fingerprint information of the subject. When the first information obtainment sub-unit 411 includes the facial information collector (e.g., the camera), the facial information collector may be configured to obtain facial feature information (also referred to as facial information) of the subject. When the first information obtainment sub-unit 411 includes the iris collector, the iris collector may be configured to obtain iris feature information (also referred to as iris information) of the subject. When the first information obtainment sub-unit 411 includes the electronic tagging reader, the electronic tagging reader may be configured to obtain the ID information of the subject (e.g., information of the magnetic key card). When the first information obtainment sub-unit 411 includes the information input device (e.g., a keyboard, a touch display screen), the information input device may be configured to obtain the password information of the subject. As another example, when the first information obtainment sub-unit 411 includes the fingerprint collector and the facial information collector, the first information obtainment sub-unit 411 may be configured to obtain the fingerprint information and the facial information of the subject. As a further example, when the first information obtainment sub-unit 411 includes the fingerprint collector and the information input device, the first information obtainment sub-unit 411 may be configured to obtain the fingerprint information and the password information of the subject.

It should be noted that the first recognition information obtained by the first recognition unit 410 may include other information used to confirm the identity of the subject. Additionally or alternatively, the first information obtainment sub-unit 411 may also obtain the first recognition information from other devices capable of obtaining the first recognition information, which may be not limited here. Any device capable of confirming identity information of the subject and obtaining the first recognition information may be within the scope of the present disclosure.

The first information processing sub-unit 412 may be configured to determine the first recognition result based on the first recognition information. In some embodiments, the first recognition result may include that the identity of the subject is confirmed or not. For example, when the first information obtainment sub-unit 411 includes the fingerprint collector, the fingerprint collector may obtain the fingerprint information of the subject. The first information processing sub-unit 412 may generate a matching result by searching for the obtained fingerprint information in a fingerprint information set of the identity confirmation system 100 and determine the first recognition result based on the matching result. In response to the matching result being positive, the identity of the subject may be confirmed. In response to the matching result being negative, the identity of the subject may fail to be confirmed. As another example, when the first information obtainment sub-unit 411 includes the facial information collector (e.g., the camera), the facial information collector may obtain the facial information of the subject. The first information processing sub-unit 412 may generate a matching result by searching for the obtained facial information in a facial information set of the identity confirmation system 100 and determine the first recognition result based on the matching result. In response to the matching result being positive, the identity of the subject may be confirmed. In response to the matching result being negative, the identity of the subject may fail to be confirmed. As another example, when the first information obtainment sub-unit 411 includes the palmar digital vein collector, the palmar digital vein collector may obtain the palmar digital vein information of the subject. The first information processing sub-unit 412 may generate a matching result by searching for the obtained palmar digital vein information in a palmar digital vein information set of the identity confirmation system 100 and determine the first recognition result based on the matching result. In response to the matching result being positive, the identity of the subject may be confirmed. In response to the matching result being negative, the identity of the subject may fail to be confirmed. As another example, when the first information obtainment sub-unit 411 includes the information input device (e.g., the keyboard, the touch screen), the information input device may obtain authentication information (e.g., a password authentication, a gesture authentication) of the subject. The first information processing sub-unit 412 may generate a matching result by confirming the acquired authentication information, and determine the first recognition result based on the matching result. In response to the matching result being positive, the identity of the subject may be confirmed. In response to the matching result being negative, the identity of the subject may fail to be confirmed. As another example, when the first recognition information includes the fingerprint information and the palmar digital vein information, the first information processing sub-unit 412 may include the fingerprint connector and the palmar digital vein connector. In response to that the fingerprint information and the palmar digital vein information both are confirmed, the identity of the subject may be confirmed. In response to that either one of the fingerprint information or the palmar digital vein information fails to be confirmed, the identity of the subject may fail to be confirmed.

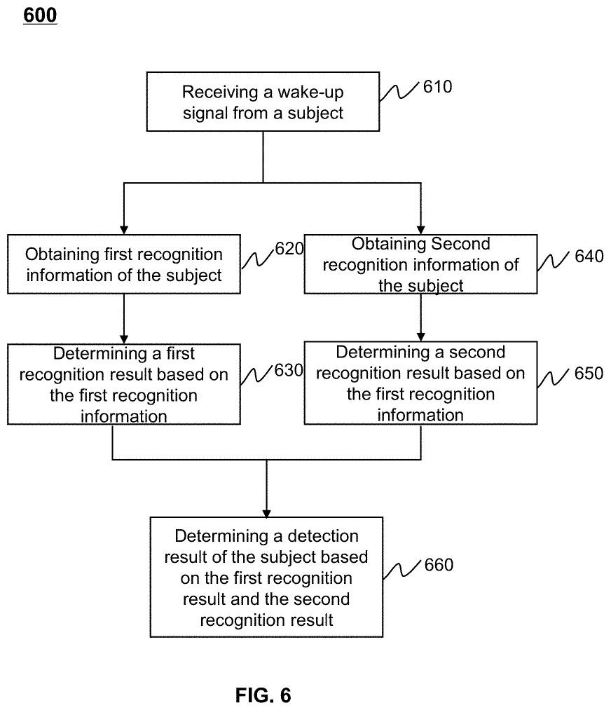

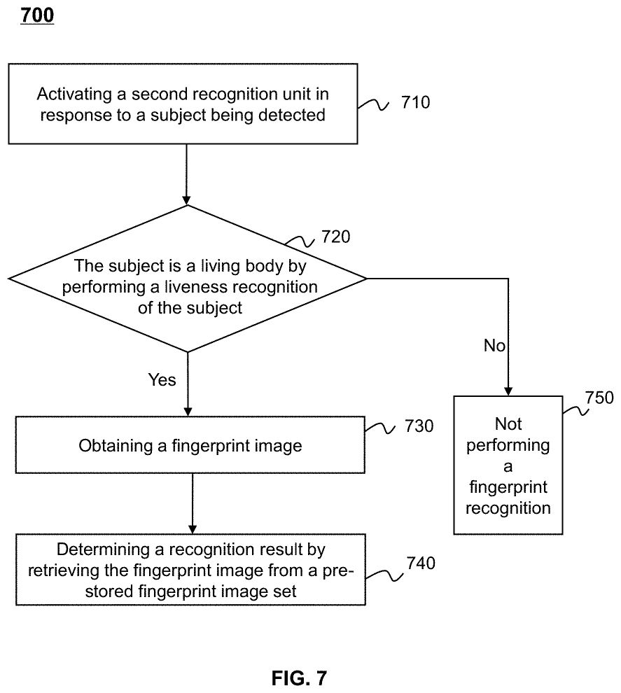

The second recognition unit 420 may be configured to obtain second recognition information of the subject and determine a second recognition result based on the second recognition information. In some embodiments, the second recognition information may include blood oxygen level information, heart rate information, palmar digital vein information, facial information of the subject, or the like, or any combination thereof. The second recognition unit 420 may include a second information obtainment sub-unit 421 and a second information processing sub-unit 422. The second information obtainment sub-unit 421 may be configured to obtain the second recognition information of the subject. The second information processing sub-unit 422 may determine the second recognition result based on the second recognition information. The second information obtainment sub-unit 421 may include a collection device of the blood oxygen level information, a collection device of the heart rate information, a connection device of the palmar digital vein information, a connection device of the facial information, or the like, or any combination thereof. In some embodiments, a count of the second recognition unit 420 included in the detection module 210 may be one or more. Different second recognition units 420 may include different second information obtainment sub-units 421 and different second information processing sub-units 422, thereby obtaining and processing different second recognition information. For example, when the second recognition information includes the blood oxygen level information, the second recognition unit 420 may obtain the blood oxygen level information and determine the second recognition result of the subject based on the blood oxygen level information. As another example, when the second recognition information includes the blood oxygen level information and the palmar digital vein information, the second recognition unit 420 may obtain the blood oxygen level information and the palmar digital vein information and determine the second recognition result of the subject based on the blood oxygen level information and the palmar digital vein information. The second recognition result may include that liveness of the subject is recognized or not. More descriptions of the second recognition unit 420 determining whether the liveness of the subject is recognized or not may be found elsewhere in the present disclosure, for example, FIG. 6, FIG. 7, or the descriptions thereof.

In some embodiments, the detection module 210 may also include a wake-up unit 430 (also referred to as a first sensor). The wake-up unit 430 may be configured to activate a component of the identity confirmation system 100 or the detection module 210 (e.g., the first recognition unit 410, the second recognition unit 420) from a sleep mode or a standby mode. In some embodiments, a wake-up mode of the wake-up unit 430 may include a contact wake-up and a non-contact wake-up. The contact wake-up may include wake-up via a mechanical switch (e.g., wake-up via a push-button switch, wake-up via a spring pressure switch), and wake-up via a touch device (e.g., wake-up via a pressure sensor, wake-up via a capacitive sensor). The non-contact wake-up may include a voice wake-up (e.g., wake-up via a voice sensor), an infrared proximity wake-up (e.g., wake-up via an infrared proximity sensor, an infrared proximity switch), or the like, or any combination thereof. Merely by way of example, the wake-up unit 430 may include a push-button switch. A mechanical position or a trajectory of the push-button switch may change under an external pressure to connect to a control circuit of the identity confirmation system 100 or the detection module 210, thereby achieving the wake-up purpose or the activation purpose. As another example, the wake-up unit 430 may include a pressure sensor configured to sense a pressure signal and convert the pressure signal into an electrical signal, and then transmit the electrical signal to the control module 230. In response to the electrical signal greater than a specific threshold, the control module 230 may control the first recognition unit 410 and/or the second recognition unit 420 in an operating mode. As another example, the wake-up unit 430 may include a capacitive sensor. A capacitance of the capacitive sensor may change under an action (e.g., touching, pressing, sliding) of the subject. The wake-up unit 430 may convert a signal of the changed capacitance into an electrical signal and transmit the electrical signal to the control module 230. In response to the electrical signal greater than a specific threshold, the control module 230 may control the first recognition unit 410 and/or the second recognition unit 420 in the working mode.

In some embodiments, the wake-up unit 430 may be located at the identity confirmation device 130, or independent from the identity confirmation device 130. In some embodiments, the wake-up unit 430 may be located in the detection module 210, or independent from the detection module 210. In some embodiments, the wake-up unit 430 may be located in the first recognition unit 410 or the second recognition unit 420, or independent from the first recognition unit 410 or the second recognition unit 420.

In some embodiments, the detection module 210 may also include an obtainment assistance unit (not shown). The obtainment assistance unit may include a device configured to assist the detection module 210 in obtaining the first recognition information and/or second recognition information. For example, when the detection module 210 obtains the fingerprint information, the obtainment assistance unit may include a finger placement plate. As another example, when the detection module 210 obtains the facial information, the obtainment assistance unit may include an adjustment rod configured to adjust an angle or a height of a camera.

It should be noted that the above description of the detection module is provided for the purposes of illustration, and one or more embodiments of the specification are not intended to limit the scope of the present disclosure. It will be appreciated that for those skilled in the art, after understanding the principle of the detection module, multiple variations and modifications may be made without departing from this principle, e.g., one or more units may be combined or omitted. In some embodiments, the wake-up unit 430 may be omitted. For example, the first recognition unit 410 and the second recognition unit 420 may be always in the working mode and the wake-up unit 430 may be omitted. In some embodiments, the wake-up unit 430 may be combined with the first recognition unit 410 or the second recognition unit 420. For example, the wake-up unit 430 may be combined with the first recognition unit 410. The wake-up unit 430 may obtain the wake-up signal and activate the first recognition unit 410. As another example, the wake-up unit 430 may be combined with the second recognition unit 420. The wake-up unit 430 may obtain the wake-up signal and activate the second recognition unit 420. In some embodiments, the first recognition unit 410 and the second recognition unit 420 may be combined into one unit having the identity recognition function and the liveness recognition function. In some embodiments, the first recognition unit 410 or the second recognition unit 420 may be omitted. Taking a door lock with a peephole as an example, a detection module only including the second recognition unit 420 may be disposed at the inside of the door. When the subject needs to open the door from the inside, the liveness recognition of the subject may be performed, in order to prevent the door from being accidently unlocked by, for example, an unauthorized person or animal (e.g., a child, a pet (e.g., a dog)) from the inside, such that the security is improved. As another example, when the identity confirmation information includes the palmar digital vein information or the facial information (e.g., a dynamic video), whether the subject is the living body and the identity of the subject may both be determined by the first recognition unit 410 or the second recognition unit 420. As another example, each module described above may share a same storage module, or each module may include a respective storage module. Such variations and modifications may be within the scope of the present disclosure.

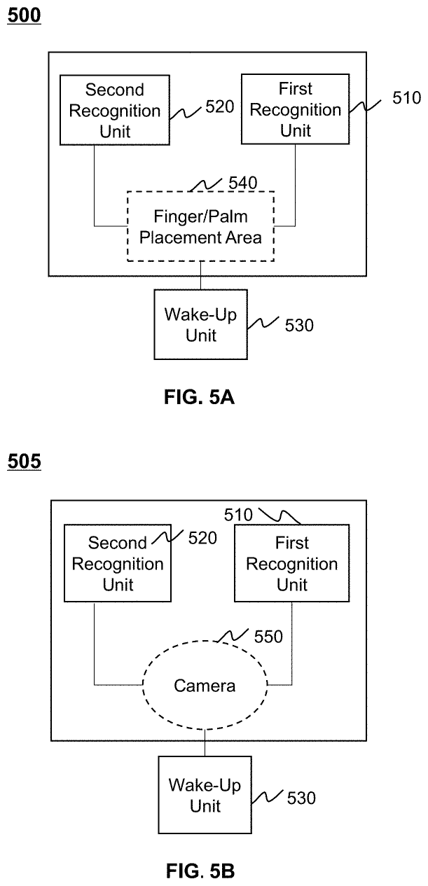

FIG. 5A and FIG. 5B are schematic diagrams of exemplary identity confirmation devices according to some embodiments of the present disclosure. As shown in FIG. 5A, in some embodiments, the identity confirmation device 500 may include a first recognition unit 510, a second recognition unit 520, a wake-up unit 530, and a finger/palm placement area 540. The detection module 210 may obtain first recognition information and/or second recognition information of a subject when a finger or a palm of the subject is placed on the finger/palm placement area 540. In some embodiments, the first recognition unit 510 and/or the second recognition unit 520 may be located at the finger/palm placement area 540. In some embodiments, part of sub-units (e.g., the first information obtainment sub-unit 411) of the first recognition unit 510, and part of sub-units (e.g., the second information obtainment sub-unit 421) of the second recognition unit 520 may be located at the finger/palm placement area 540. Part of the sub-units of the first recognition unit 510 (e.g., the first information processing sub-unit 412), and part of the sub-units (e.g., the second information processing sub-unit 422) of the second recognition unit 520 may be located outside the finger/palm placement area 540. In some embodiments, the first recognition information may include fingerprint information or palm print information. In some embodiments, the second recognition information may include blood oxygen level information, heart rate information, or palmar digital vein information. The first recognition unit 510 may confirm identity of the subject based on the first recognition information. The second recognition unit 520 may confirm whether the subject is a living body based on the second recognition information. In such embodiments, the identity confirmation device 500 may perform an identity recognition by the first recognition unit 510 and perform a liveness recognition by the second recognition unit 520, thus effectively preventing an unauthorized person from being successfully confirmed by the identity confirmation device 500 using fake biometric feature information (e.g., fingerprint information, palm print information).

It should be noted that the identity confirmation device 500 may use different obtainment modes based on characteristics of the first recognition information and/or the second recognition information and adjust units or components of the identity confirmation device 500 accordingly. For example, when the first recognition information and/or the second recognition information include the facial information, the iris information, and the retinal information, the present disclosure may provide an identity confirmation device 505. As shown in FIG. 5B, the identity confirmation device 505 may include the second recognition unit 520, the first recognition unit 510, the wake-up unit 530, and a camera 550. In some embodiments, the camera 550 may obtain the facial information (e.g., a facial image, a facial dynamic video), the iris information, or the retinal information. For example, the first recognition unit 510 may match the facial information of the subject obtained by the camera 550 with pre-obtained facial information of the subject and determine the identity of the subject. The second recognition unit 520 may determine whether the subject is the living body based on the facial information. As another example, the first recognition information may also include the voice information, and the identity confirmation device 505 may also include a microphone. In some embodiments, when the identity confirmation device 505 may simultaneously include the finger/palm placement area 540 and the camera 550, the first recognition information obtained by the first recognition unit 510 may include the fingerprint information or the palm print information, and the second recognition information obtained by the second recognition unit 520 may include the facial information. In some embodiments, the identity confirmation device 505 may only include the second recognition unit 520. Taking a door lock with a peephole as an example, an identity confirmation device only including the second recognition unit 420 may be disposed at the inside of a door. The liveness recognition of the subject may be performed when the subject needs to open the door from the inside, in order to prevent the door from being accidently unlocked by, for example, an unauthorized person or animal (e.g., a child, a pet (e.g., a dog)) from the inside, such that the security is improved. In this case, the first recognition unit 510 may be omitted, reducing the complexity of opening the door from the inside of the door. As another example, the identity confirmation device may simultaneously confirm the identity of the subject and determine whether the subject is the living body based on only one type of recognition information. Merely by way of example, the second recognition information obtained by the second recognition unit 520 may include the palmar digital vein information. The palmar digital vein information may include a venous blood vessel image generated by imaging the absorption of a near-infrared light by flowing hemoglobin in the blood. When the palmar digital vein information is converted into a digital feature to perform the liveness recognition, the identity of the subject may be directly identified based on the venous blood vessel image.

In some embodiments, the wake-up unit 530 may be independent from the identity confirmation device 500. For example, the wake-up unit 530 may include a push-button switch disposed outside the identity confirmation device 500. As another example, the wake-up unit 530 may include a speech recognition device, an infrared detection device, etc., disposed outside the identity confirmation device. In some embodiments, the wake-up unit 530 may be located in the first recognition unit 510 or the second recognition unit 520. For example, the wake-up unit 530 may include a capacitive sensor and a pressure sensor that are integrated with the first recognition unit 510 or the second recognition unit 520. As another example, the wake-up unit 530 may include a snap dome switch of the identity confirmation device 500. More descriptions of the wake-up unit 530 may be found elsewhere in the present disclosure.

It should be noted that the above descriptions of the identity confirmation device are merely provided for the purposes of illustration, and not intended to limit the scope of the present disclosure. For persons having ordinary skills in the art, multiple variations and modifications on the identity confirmation device may be made under the teachings of the present disclosure. However, those variations and modifications do not depart from the scope of the present disclosure. In some embodiments, the wake-up unit 530 may be omitted. For example, the first recognition unit 510 and the second recognition unit 520 may be always in the working mode and the wake-up unit 430 may be unnecessary. In some embodiments, the first recognition unit 510 and the second recognition unit 520 may be combined into one unit having the identity recognition function and the liveness recognition function. In some embodiments, the first recognition unit 510 or the second recognition unit 520 may be omitted. For example, when the identity of the subject and whether the subject is the living body may be determined based on the first recognition information or the second recognition information (e.g., the palmar digital vein information, the facial information), the first recognition unit 510 or the second recognition unit 520 may be omitted.

FIG. 6 is a flowchart illustrating an exemplary process for identity confirmation according to some embodiments of the present disclosure.

In 610, a wake-up signal from a subject may be received. Operation 610 may be performed by the wake-up unit 430. The wake-up unit 430 may activate components (e.g., the first recognition unit 410, the second recognition unit 420) of the identity confirmation device 130 or the detection module 210 from a sleep mode or a standby mode. In some embodiments, a wake-up mode of the wake-up unit 430 may include a contact wake-up and a non-contact wake-up. The contact wake-up may include a mechanical switch wake-up (e.g., a push-button switch wake-up, a shrapnel-type pressure wake-up), and a touch wake-up (e.g., a pressure sensor wake-up, a capacitive sensor wake-up). The non-touch wake-up may include a voice wake-up, an infrared proximity wake-up, or the like, or any combination thereof. In some embodiments, the wake-up signal may be configured to activate the first recognition unit 410 and/or the second recognition unit 420. For example, when the subject acts (e.g., touches, presses, slides) on an area corresponding to a capacitive sensor, a variable of a capacitance of the capacitive sensor may be used as the wake-up signal. As another example, when the wake-up unit 430 includes a pressure sensor and the subject presses an area corresponding to the pressure sensor, a pressure signal of the pressure sensor may be used as the wake-up signal. As another example, when the wake-up unit 430 includes a voice sensor and an external voice acts on the voice sensor (e.g., a microphone), a signal of a variable of a capacitance of the voice sensor may be used as the wake-up signal. As another example, when the wake-up unit 430 includes a speech recognition system, a predetermined voice sentence may be used as the wake-up signal. In some embodiments, a current signal of a control circuit being turned on by a switch may be used as a wake-up signal. For example, the subject may act on the switch such that the first recognition unit 410 or the second recognition unit 420 may be connected to the control circuit, thereby achieving the wake-up purpose.

In 620, first recognition information of the subject may be obtained. Operation 620 may be implemented by the first information obtainment sub-unit 411.

The first recognition information (also referred to as identity recognition information) may be used to indicate identity of the subject. In some embodiments, the first recognition information may include biometric feature information, password information, ID information of the subject, or the like, or any combination thereof. The biometric feature information may include physiological characteristics that may be measured, identified, or verified on a human individual, distinguishing from other human individuals. In some embodiments, the biometric feature information may include a fingerprint, a palm print, a palmar digital vein, the face, a heart rate, voice, an iris, or a retina, or the like, or any combination thereof. In some embodiments, the password information may include digit, character, text, or the like, or any combination thereof. In some embodiments, the password information may include an authentication gesture, an answer to an authentication question, an image selection result, etc. In some embodiments, the ID information of the subject may include a name, a nickname, a series number, an employee number, contact information (e.g., a phone number, a mobile phone number, a mailbox) of the subject, or the like, or any combination thereof. In some embodiments, the ID information of the subject may be stored in a magnetic key card. For example, the first recognition information may only be the biometric feature information (e.g., the fingerprint, the palmar digital vein, the facial information). As another example, the first recognition information may be a combination of one or more types of the biometric feature information and the password information or the ID information of the subject. As a further example, the first recognition information may only include the password information and/or the ID information of the subject. The first information obtainment sub-unit 411 may refer to a device for obtaining the first recognition information. In some embodiments, the first information obtainment sub-unit 411 may include a fingerprint collector, a palm print collector, a palmar digital vein collector, a voice collector (e.g., a microphone), an iris collector, a facial information collector (e.g., a camera), an electronic tagging reader, an information input device (e.g., a keyboard), or the like, or any combination thereof. The first information obtainment sub-unit 411 may correspond to the first recognition information. For example, when the first recognition information includes the password information, the first information obtainment sub-unit 411 may include the information input device (e.g., a keyboard, a touch screen). As another example, when the first recognition information includes the password information and fingerprint information, the first information obtainment sub-unit 411 may include the information input device and the fingerprint collector. As a further example, when the first recognition information includes the ID information, the fingerprint information, and the facial information of the subject, the first information obtainment sub-unit 411 may include the electronic tagging reader, the fingerprint collector, and the facial information collector.

In 630, a first recognition result may be determined based on the first recognition information. Operation 630 may be performed by the first information processing sub-unit 412. In some embodiments, the first recognition information may include identity information of the subject, for example, the ID information, the facial information, the fingerprint information, etc., of the subject obtained in 610. In some embodiments, other types of the identity information may be obtained based on the first recognition information obtained in 610, for example, a photo, a contact number, an ID number, an address, etc., of the subject. In some embodiments, the first recognition information may include a recognition manner of the subject. For example, when the first recognition information includes the fingerprint information, the recognition of the subject may be based on a fingerprint. As another example, when the first recognition information includes the password information, the recognition of the subject may be based on a password.

In some embodiments, the first recognition result may include that the identity of the subject is confirmed or not. In some embodiments, the first recognition result may correspond to a type of the first recognition information. For example, when the first recognition information only includes the fingerprint information, the first recognition result may include a recognition result of the fingerprint information. As another example, when the first recognition information includes the fingerprint information and the facial information, the first recognition result may include a recognition result of the fingerprint information and the facial information. In some embodiments, that the identity of the subject is confirmed may mean that all types of the first recognition information are confirmed. For example, when the first recognition information obtained by the first information obtainment sub-unit 411 includes the fingerprint and the palmar digital vein of the subject, that the identity of the subject is confirmed may mean that the fingerprint information and the palmar digital vein information are both confirmed. In some embodiments, that the identity of the user fails to be confirmed may mean that at least one type of the first recognition information fails to be confirmed. For example, in response to the fingerprint information of the first recognition information being confirmed and the facial information failing to be confirmed, the first recognition result may include that the identity of the subject fails to be confirmed.

In some embodiments, a retrieval result may be generated by retrieving the first recognition information in a pre-stored first recognition information set, and the first recognition result may be determined based on the retrieval result. In response to the first recognition information being retrieved from or matched with the pre-stored first recognition information set, the first recognition result may include that the identity of the subject is confirmed. For example, when the first recognition information includes the fingerprint information, the fingerprint information obtained by the first information obtainment sub-unit 411 may be retrieved from and matched with fingerprint information of the pre-stored first recognition information set. In response to the obtained fingerprint information being matched with corresponding fingerprint information of the pre-stored first recognition information set, the identity of the subject may be confirmed. As another example, in response to the password information entered by the user conforming to a password of the pre-stored first recognition information set, the identity of the user may be confirmed. As a further example, the ID information of the subject exists in a permission list of the pre-stored first recognition information set, the identity of the user may be confirmed. When recognition information corresponding to the first recognition information fails to be retrieved from or matched with the pre-stored first recognition information set, the first recognition result may include that the identity of the subject fails to be confirmed. The first recognition information obtained by the first information obtainment sub-unit 411 may be transmitted to the first information processing sub-unit 412 via the network 120. The pre-stored first recognition information set may be stored in a hard disk or a storage of the first information processing sub-unit 412.

In 640, second recognition information of the user may be obtained. Operation 640 may be performed by the second information obtainment sub-unit 421.

In some embodiments, the second recognition information may include a blood oxygen level, a heart rate, a palmar digital vein, facial information, or the like, or any combination thereof. For example, the second recognition information may include the blood oxygen level information. As another example, the second recognition information may include the blood oxygen level information and heart rate information. As a further example, the second recognition information may include the blood oxygen level information, the heart rate information, and the palmar digital vein information. As a further example, the second recognition information may include the palmar digital vein information and the facial information. As a further example, the second recognition information may be the palmar digital vein information. As a further example, the second recognition information may be the facial information. The second information obtainment sub-unit 421 may include a device for obtaining the second recognition information. In some embodiments, the first recognition information may include the palmar digital vein information, and the second recognition information may include the facial information. In some embodiments, the first recognition information may include the facial information, and the second recognition information may include the palmar digital vein information. The second information obtainment sub-unit 421 may include a device for obtaining the second recognition information. In some embodiments, the second information obtainment sub-unit 421 may include a collection device of the blood oxygen level information, a collection device of the heart rate information, a collection device of the palmar digital vein information, a collection device of the facial information, or the like, or any combination thereof. In some embodiments, the second information obtainment sub-unit 421 may match the second recognition information. For example, when the second recognition information includes the blood oxygen level, the second information obtainment sub-unit 421 may include the collection device of the blood oxygen level information. As another example, when the second recognition information includes the blood oxygen level information and the palmar digital vein information, the second information obtainment sub-unit 421 may include the connection device of the blood oxygen level information and the collection device of the palmar digital vein information.

In 650, a second recognition result may be determined based on the second recognition information. Operation 650 may be performed by the second information processing sub-unit 422 or the processing module 220. The second recognition information obtained by the second information obtainment sub-unit 421 may be transmitted to the second information processing sub-unit 422 via the network 120 or the communication module 240.

In some embodiments, the second recognition result may include that the liveness of the subject is recognized or not. In some embodiments, the second recognition result may correspond to a type of the second recognition information. For example, when the second recognition information includes the blood oxygen level information, the second recognition result may include a recognition result of the blood oxygen level information. As another example, when the second recognition information includes the blood oxygen level information and the palmar digital vein information, the second recognition result may include a recognition result of the blood oxygen level information and the palmar digital vein information. In some embodiments, that the liveness of the subject is recognized may mean that all types of the second recognition information of the subject are recognized. That the liveness recognition of the subject fails to be recognized may mean that at least one type of the second recognition information fails to be recognized. For example, if the blood oxygen level information of the second recognition information is recognized, and the palmar digital vein information fails to be recognized, the second recognition result may include that the liveness of the subject fails to be recognized.

In some embodiments, a comparison result may be generated by comparing the second recognition information (also referred to as liveness recognition information) with a liveness detection threshold, and the second recognition result may be determined based on the comparison result. In some embodiments, the liveness detection threshold may refer to a range or a variation of the second recognition information (e.g., a blood oxygen level, a heart rate) of the subject. In some embodiments, the second recognition information may be presented in the form of a numerical value or a curve.

In some embodiments, the liveness detection threshold may include a liveness detection intensity threshold. An average of the second recognition information may be compared with the liveness recognition intensity threshold. The liveness recognition intensity threshold may include an upper limit of the liveness recognition intensity threshold, a lower limit of the liveness recognition intensity threshold, and/or a range of the liveness recognition intensity threshold. For example, in response to the average of the second recognition information within the range of the liveness recognition intensity threshold, the second recognition result may include that the liveness recognition of the subject is recognized. In response to the average of the second recognition information out of the range of the liveness recognition intensity threshold (e.g., greater than the upper limit of the liveness recognition intensity threshold or lower than the lower limit of the liveness recognition intensity threshold), the second recognition result may include that the liveness recognition of the subject fails to be recognized.

In some embodiments, a difference between a maximum value and a minimum value of the second recognition information may be compared with the liveness recognition intensity threshold. For example, in response to the difference between the maximum value and minimum value of the second recognition information within the range of the liveness recognition intensity threshold, the second recognition result may include that the liveness of the subject is recognized. In response to the difference between the maximum value and the minimum value of the second recognition information out of the range of the liveness recognition intensity threshold (e.g., greater than the upper limit of the liveness recognition intensity threshold or lower than the lower limit of the liveness recognition intensity threshold), the second recognition result may include that the liveness of the subject fails to be recognized.

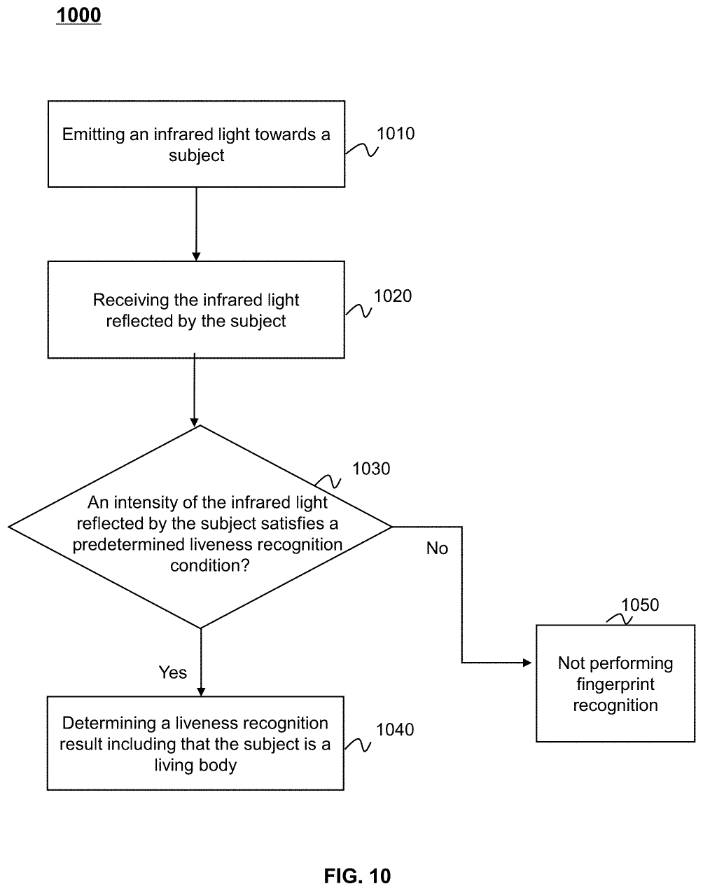

In some embodiments, the liveness detection threshold may also include a liveness detection curve slope threshold. A liveness recognition curve slope may reflect a change of the second recognition information of the subject, for example, a change of the blood oxygen level or heart rate within a specific time period. In some embodiments, the second recognition information may be compared with the liveness detection curve slope threshold. The liveness detection curve slope threshold may include an upper limit of the liveness detection curve slope threshold, a lower limit of the liveness detection curve slope threshold, and/or a range of the liveness detection curve slope threshold. For example, in response to a curve slope or a change value per time unit of the second recognition information within the liveness recognition curve slope range, the second recognition result may include that the liveness of the subject is recognized. In response to the slope or the change value per time unit of the second recognition information out of the liveness recognition curve slope range (e.g., greater than the upper limit of the liveness detection curve slope threshold or lower than the lower limit of the liveness detection curve slope threshold), the second recognition result may include that the liveness of the subject fails to be recognized. More descriptions and relevant principles of the living recognition may be found elsewhere in the present disclosure, for example, FIG. 10 or the descriptions thereof.

In 660, a detection result of the subject may be determined based on the first recognition result and the second recognition result. Operation 660 may be implemented by the processing module 220. In some embodiments, the first information processing sub-unit 412 may transmit the first recognition result to the processing module 220 via the network 120 or communication module 240. The second information processing sub-unit 422 may transmit the second recognition result to the processing module 220 via the network 120 or communication module 240.

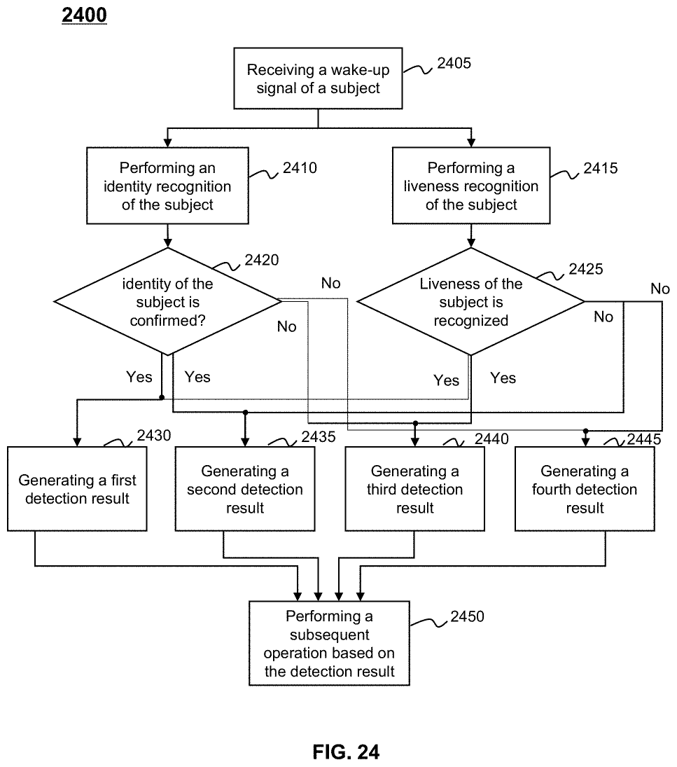

In some embodiments, the determination of the detection result of the subject based on the first recognition result and the second recognition result may include the following situations: (1) in response to the first recognition result including that the identity of the subject is confirmed, and the second recognition result including that the liveness of the subject is recognized, determining the detection result of the subject to be positive; (2) in response to the first recognition result including that the identity of the subject fails to be confirmed and the second recognition result including that the liveness of the subject fails to be recognized, determining the detection result of the subject to be negative; (3) in response to the first recognition result including that the identity of the subject is confirmed and the second recognition result including that the liveness of the subject fails to be recognized, determining the detection result of the subject to be negative; or (4) in response to the first recognition result including that the identity of the subject fails to be confirmed and the second recognition result including that the liveness of the subject is recognized, determining the detection result of the subject to be negative. In some embodiments, although the detection result is determined to be negative under the situations (2), (3), or (4), subsequent operations may vary accordingly. More descriptions of the subsequent operations for different situations may be found elsewhere in the present disclosure, for example, FIG. 24, or the descriptions thereof.

Additionally or alternatively, when there are multiple types of the first recognition information, that the identity of the subject is confirmed may indicate that a count of types of the first recognition information being confirmed is greater than a specific count threshold. For example, when the first recognition information includes the fingerprint information, the facial information, the palmar digital vein information, and the voice information, a count of types of the first recognition information being confirmed is greater than the count threshold (e.g., two or three), the identity of the subject may be confirmed. When types of the second recognition information are multiple, that the liveness of the subject is recognized may refer that a count of types of the second recognition information being recognized is greater than a count threshold. For example, when the second recognition information includes the heart rate information, the blood oxygen level information, the palmar digital vein information, the voice information, a count of types of the second recognition information being recognized is greater than the count threshold (e.g., two or three), the liveness of the subject may be recognized.

The processing module 220 may transmit corresponding instructions or operations based on different detection results. For example, in response to the detection result of the subject being positive, the processing module 220 may transmit an initiation instruction to the control module 230 based on the detection result. The control module 230 may initiate the drive module 270 to complete an unlocking operation or generate a result that the identity of the subject is positive. As another example, in response to the detection result of the subject being negative, the processing module 220 may not perform an unlocking operation (or even trigger an additional locking operation) or generate a result that the identity of the subject is negative. The processing module 220 may transmit a reminder instruction by the control module 230. The control module 230 may control the input/output module 260 to emit reminder information. Detailed descriptions of performing corresponding operations or instructions based on the detection results of the subject may be found in FIG. 24 or the descriptions thereof. It should be noted that the above descriptions regarding the process 600 are merely provided for the purposes of illustration, and not intended to limit the scope of the present disclosure. For persons having ordinary skills in the art, multiple variations and modifications on the process 600 may be made under the teachings of the present disclosure. However, those variations and modifications do not depart from the scope of the present disclosure. In some embodiments, operation 610 may be omitted, that is, the identity confirmation device 130 may always be in an active status, and subsequent operations 620, 630, 640, and 650 may be performed without performing the wake-up operation. In some embodiments, operation 620 and operation 640 may be unnecessary to be performed simultaneously as shown in FIG. 6, and adjusted based on practical demands. For example, operation 640 and operation 650 may be performed before operation 620. The identity confirmation system 100 may first determine the second recognition information of the subject, and then perform operations 620, 630, and 660 in response to the second recognition result including that the liveness of the subject is recognized. Operations 620, 630, and 660 may be unnecessary to be performed in response to the second recognition result including that the liveness of the subject fails to be recognized. As another example, operation 620 and operation 630 may be performed before operation 640. The identity confirmation system 100 may first confirm the first recognition information of the subject, and then perform operations 640, 650, and 660 in response to the first recognition result including that the identity of the subject is confirmed. It may be unnecessary to perform operations 640, 650, and 660 in response to the first recognition result including that the identity of the subject fails to be confirmed. Therefore, the operations of the identity confirmation may be simplified, and the work efficiency of the identity confirmation device may be improved.

In some embodiments, the subject may be located at a control area corresponding to a smart lock (for example, a control area of the smart lock on a door, a safe deposit box, or a package delivery box, or another control area operably connected with the smart lock) to enable the control module 230 to collect the first recognition information or the second recognition information. Additionally or alternatively, the subject may manually input the first recognition information through the control area corresponding to the smart lock. The control module 230 may transmit corresponding instruction or operation information based on the first recognition result corresponding to the first recognition information or the second recognition result corresponding to the second recognition information.

In some embodiments, the system may track a status of the identity confirmation device. For example, the system may determine whether an item in the identity confirmation device, such as a key of a lockbox, a gun in a gun safe, a package in a package delivery box, etc., is removed. As another example, the system may determine risk reminder information related to the identity confirmation device, such as the identity confirmation device having been turned on but not been turned off for a time period (for example, 1 minute, 2 minutes, 3 minutes, 5 minutes), a count of false password input exceeding a threshold (for example, 3 times, 5 times), a count of false double recognition exceeding a threshold (for example, 3 times, 5 times), a forced fingerprinting (for example, a device that receives the fingerprint detects that a pressure exceeds a threshold while the fingerprint is received), etc. In some embodiments, the system may also transmit the status of the identity confirmation device to other devices related to the identity confirmation device (e.g., a mobile phone, a computer, etc., of an owner of the identity confirmation device), allowing the owner of the identity confirmation device to learn the status of the identity confirmation device promptly, thereby improving security. Merely by way of example, the system may track the status of the identity confirmation device through a camera configured to monitor the identity confirmation device.

In some embodiments, in response to a specific trigger condition being satisfied (e.g., the identity confirmation device receiving a wake-up signal or being unlocked, an item in the device being removed), the identity recognition device may operate collaboratively with other devices (such as a camera) through the network. For example, in response to the device receiving the wake-up signal of the subject, the camera may synchronously obtain an image and/or a video of the subject and/or the identity confirmation device, and transmit the image and the video to the owner of the identity confirmation device, facilitating the owner to track and/or learn the status of the identity confirmation device.

FIG. 7 is a flowchart illustrating an exemplary process for identity confirmation according to some embodiments of the present disclosure. In order to further illustrate the technical solutions of the present disclosure, the fingerprint recognition unit may be used as a specific embodiment of the first recognition unit 410.

In 710, the second recognition unit 420 may be woken up in response to a subject being detected. The operation may be performed by the wake-up unit 430.

In some embodiments, a wake-up mode of the second recognition unit 420 may include a contact wake-up and a non-contact wake-up. In some embodiments, the contact wake-up may include a mechanical switch wake-up (e.g., a push-button switch wake-up, a shrapnel-type pressure wake-up), and a touch wake-up (e.g., a pressure sensor wake-up, a capacitive sensor wake-up). In some embodiments, the non-touch wake-up may include a voice wake-up, an infrared proximity wake-up, or the like, or any combination thereof. In order to further illustrate the wake-up unit 430, a capacitance sensor may be described as a specific embodiment of the wake-up unit 430. For example, a capacitance of the capacitive sensor may change under an action (e.g., touching, pressing, sliding) of the subject. The wake-up unit 430 may convert a signal of the change of the capacitance into an electrical signal and transmit the electrical signal to the control module 230. When the electrical signal is greater than a specific threshold, the control module 230 may activate the second recognition unit 420.

It should be noted that the second recognition unit 420 may usually be in a sleep mode. The second recognition unit 420 may be woken up only when the subject touches an area (e.g., the finger/palm placement area 540 in FIG. 5A) corresponding to the wake-up unit 430 or acts on the wake-up unit 430. For example, when the wake-up unit 430 includes a pressure sensor and the area corresponding to the wake-up unit 430 detects a pressure or a touch, the pressure sensor may detect a pressure signal. The pressure sensor may convert the pressure signal into an electrical signal and then transmit the electrical signal to the control module 230. In response to the electrical signal greater than the specific threshold, the control module 230 may activate the second recognition unit 420. As another example, when the wake-up unit 430 includes an infrared sensor, the infrared sensor may generate a wake-up signal when the subject is close to the infrared sensor, and the second recognition unit 420 may be activated accordingly. As a further example, when the wake-up unit 430 includes a push-button switch, the subject may press the push-button switch to generate a wake-up signal, thereby waking up the second recognition unit 420. In some embodiments, the wake-up unit 430 may be independent from the second recognition unit 420 (e.g., the second recognition unit 420 is inside a door lock and the wake-up unit 430 is on a mobile device or a wall), or located in the second recognition unit 420. In some embodiments, the first recognition unit 410 may also include another wake-up unit. After the another wake-up unit is activated, a fingerprint recognition operation may be performed.

In 720, whether the subject is a living body may be determined by performing a liveness recognition of the subject. The operation may be performed by the second information processing sub-unit 422.

In response to the liveness recognition result including that the subject is a living body, operation 730 may be performed; in response to the liveness recognition result including that the subject is a non-living body, operation 750 may be performed, and a fingerprint recognition may be not performed. In some embodiments, in response to the liveness recognition result including that the subject is the non-living body, operation 720 may be re-performed (that is, the liveness recognition is performed again) before the wake-up unit 430 enters the standby mode. Detailed descriptions of performing the liveness recognition by the second recognition unit 420, and determining whether the subject is the living body may be found elsewhere in the present disclosure, for example, FIG. 6, or the descriptions thereof.

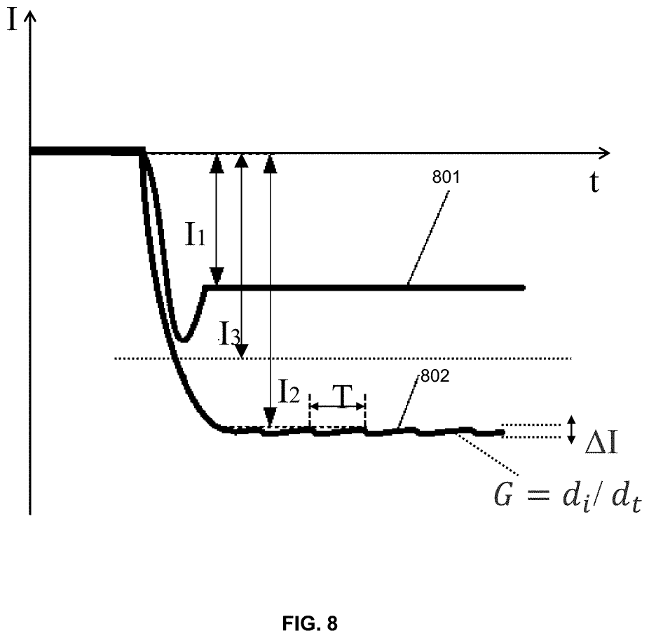

It should be noted that the subject may touch various items in his/her daily life, and it is easy to leave his/her fingerprints on the items. An unauthorized person may use the fingerprints left on the items to make a fingerprint film, a fingerprint sleeve, etc., and unlock a fingerprint lock by using the fake fingerprint. Herein, the liveness of the subject may be recognized, effectively preventing the usage of fingerprint film or the fingerprint sleeve to unlock the fingerprint lock. The technical effects of the fingerprint film or the fingerprint sleeve and the true finger on the liveness recognition may be found elsewhere in the present disclosure, for example, FIG. 8, or descriptions thereof.

In 730, a fingerprint image may be obtained. The operation may be performed by the first information obtainment sub-unit 411.

In some embodiments, the first information obtainment sub-unit 411 may include a device for obtaining the fingerprint information of the subject. In some embodiments, the first information obtainment sub-unit 411 may include a semiconductor-capacitive fingerprint collection device, an optical fingerprint collection device, a semiconductor pressure-sensitive fingerprint collection device, a temperature difference induction fingerprint collection device, an ultrasonic recognition fingerprint collection device, a micro-optical fingerprint collection device, or the like, or any combination thereof. In some embodiment of the present disclosure, the fingerprint image may refer to an image obtained by collecting uneven lines on the skin of the end of a finger using the first information obtainment sub-unit 411 (e.g., an image collection machine such as the semiconductor-capacitive fingerprint collection device, the optical fingerprint collection device, the semiconductor pressure-sensitive fingerprint collection device, the temperature difference induction fingerprint collection device, the ultrasonic recognition fingerprint collection device, the micro-optical fingerprint collection device). Lines of each fingerprint image may be arranged regularly and form different lines arrangements; a start point, an end point, a conjunction point, and a bifurcated point of each line may be different. Each subject may have different fingerprints. Different fingers of a same subject may also be different. Thus, different subjects may be distinguishable by obtaining fingerprint images.

In 740, the fingerprint image may be retrieved from a pre-stored fingerprint image set, and a recognition result may be determined. The operation may be performed by the first information processing sub-unit 412.

It should be noted that the fingerprint image set may include fingerprint images of subjects pre-stored in a storage of the identity confirmation device 130 (e.g., FIG. 1). During the usage, the obtained fingerprint image of the subject may be matched with the pre-stored fingerprint images of the fingerprint image set. If a fingerprint feature of the fingerprint image of the subject may be determined to match a specific fingerprint image of the fingerprint image set, the fingerprint match may be determined to be positive, and the fingerprint recognition may be confirmed. In response to the fingerprint feature of the fingerprint image of the subject failing to match the pre-stored fingerprint images of the fingerprint image set, the fingerprint match may be determined to be negative, and the fingerprint recognition may fail to be confirmed. That the fingerprint recognition is confirmed may indicate that a fingerprint image corresponding to the fingerprint is pre-stored in the identity confirmation device 130, and the subject having the fingerprint is a legal user; conversely, the subject having the fingerprint is an illegal user. In other parts of the present disclosure, the legal user may correspond to that the identity recognition is confirmed, and the illegal user may correspond to that the identity recognition fails to be confirmed.

In some embodiments, the first information obtainment sub-unit 411 may obtain the fingerprint image, and then obtain the fingerprint information based on the fingerprint image. The fingerprint information may be matched with fingerprint information corresponding to the pre-stored fingerprint images of the fingerprint information set based on a matching algorithm. In some embodiments, the fingerprint information may be obtained by performing a fingerprint image preprocessing and a fingerprint image feature extraction. In some embodiments, the fingerprint image preprocessing may include a grayscale normalization and equalization, a segmentation, a binaryzation, an enhancement, or a refinement of the fingerprint image. In some embodiments, the fingerprint image feature extraction may include a feature extraction based on a grayscale image, a feature extraction based on 8 neighborhood coding, a feature extraction based on a ridge frequency, a feature extraction based on a field characterization, a singularity-based feature extraction, a curve-based feature extraction, a feature extraction based on a gradient vector, etc.

It should be noted that the fingerprint recognition unit in the embodiments is merely an example of the first recognition unit 410. The first recognition unit 410 may also include a face recognition unit, a palmar digital vein recognition unit, a palm print recognition unit, a voice recognition unit, an iris recognition unit, or the like, or any combination thereof. In some embodiments, the fingerprint image set may be stored in the storage or a hard disk of the identity confirmation device 130, or in the server 110. The fingerprint recognition unit may transmit the fingerprint image information to the server 110 (or the processing module 220) via the network 120. In some embodiments, the identity confirmation device 130 or the server 110 may store a facial information set, a palmar digital vein information set, a palm print information set, a voice information set, an iris information set, or the like, or any combination thereof.

It should be noted that the above descriptions of the process 700 are merely provided for the purposes of illustration, and not intended to limit the scope of the present disclosure. For persons having ordinary skills in the art, multiple variations and modifications of the process 700 may be made under the teachings of the present disclosure. However, those variations and modifications do not depart from the scope of the present disclosure. For example, operation 710 may be omitted. As another example, operations 720 and 730 may be performed in any order or simultaneously.

FIG. 8 is a schematic diagram illustrating exemplary curves of signals received by a human finger and a fake finger according to some embodiments of the present disclosure. The curve 801 may be a curve of intensities of an infrared light received by an infrared receiving device (e.g., the second recognition unit 520, the photoelectric receiver 902) over time when a non-living fake finger (e.g., a prosthetic finger, a fingerprint film attached to a human finger, a fingerprint sleeve) is placed on a detection area (e.g., the finger/palm placement area 540) of the present disclosure. For example, the intensities may be represented by a current of a corresponding electrical signal converted by the infrared receiving device based on the intensities of the detected infrared light. The curve 802 may be a curve of intensities of the infrared light detected by the infrared receiving device over time when a living human finger is placed on the detection area of the present disclosure. The operation principle of the infrared receiving device in the embodiments of the present disclosure may be found elsewhere in the present disclosure.

As shown in FIG. 8, initial values of the curves 801 and 802 are 0, respectively, and the non-living fake finger and the living human finger are not placed on the detection area at this time. During the placement of a finger (e.g., the non-living fake finger, the living human finger), intensities of electrical signals of the curves 801 and 802 change. The curve 801 corresponding to the non-living fake finger is presented as a flat straight line after a time period (e.g., T₀), representing that the intensities of the electrical signals received by the second recognition unit 520 remain the same, denoting as I₁. In contrast, the curve 802 corresponding to the living human finger is a curve with periodic fluctuations after the time period. An average corresponding to the periodic fluctuations is I₂, a fluctuation value corresponding to the periodic fluctuations is Δi, and a fluctuation period corresponding to the periodic fluctuations is T. The reason why the curve 801 and the curve 802 have different averages is that the fake finger and the human finger have different reflectances for infrared rays, resulting in reflected lights with different intensities. The reason why the curve 802 fluctuates and the curve 801 does not fluctuate is that there is no blood vessel in the fake finger (even if the fake finger has a blood vessel, the fingerprint film or the fingerprint sleeve on the fake finger may block the blood vessel), while the curve 802 shows data corresponding to the presence of a blood vessel. Internal blood oxygen levels of the blood vessel may be changeable during each cardiac cycle due to the heart beat, causing the periodic fluctuations of the reflectances and different intensities of the reflected light. The following may specifically explain how to determine whether the subject includes the non-living fake finger or the living human finger based on the characteristics of the curve 801 and the curve 802. The electrical signal used in the following may refer to an electrical signal after the finger is completely placed on the detection area (i.e., after t₀).

In some embodiments, a liveness detection threshold may include a liveness recognition intensity threshold. By comparing the intensities of the electrical signals received by the second recognition unit 520 with the liveness recognition intensity threshold, that the subject is a living body or not may be determined. In some embodiments, an average of the intensities of the electrical signals received by the second recognition unit 520 may be compared with the liveness recognition intensity threshold I₃ (absolute values being compared herein). In response to the average of the intensities of the electrical signals greater than the liveness recognition intensity threshold I₃, the subject may be determined to be the living body. For example, an average I₂ corresponding to the curve 802 is greater than I₃, and the subject may be determined to be the living body. In contrast, an average I₁ corresponding to the curve 801 is smaller than I₃, the subject may be determined to be the non-living body. In some embodiments, I₃ may be set based on average intensities of electrical signals of common fake fingers and average intensities of electrical signals of common living human fingers (e.g., I₃ being inbetween), as long as the living body and the non-living body are distinguishable based on I₃. In some embodiments, a maximum value, a minimum value, or a difference ΔI between the maximum value and the minimum value may be compared with the liveness recognition intensity threshold. Specifically, in response to the difference ΔI between the maximum value and the minimum value of the intensities of the electrical signals greater than the liveness recognition intensity threshold, the subject may be determined to be the living body; in response to the difference ΔI between the maximum value and the minimum value of the intensities of the electrical signals smaller than the liveness recognition intensity threshold, the subject may be determined to be the non-living body.

In some embodiments, the liveness detection threshold may include a liveness detection curve slope threshold. By comparing a curve slope value of the electrical signals received by the second recognition unit 520 with the liveness detection curve slope threshold, whether the subject is the living body or not may be determined. Specifically, the curve slope value G of the electrical signals may be denoted as G=di/dt. In some embodiments, the maximum curve slope of the electrical signals received by the second recognition unit 520 may be compared with the liveness detection curve slope threshold. In response to the maximum curve slope of the electrical signals greater than the liveness detection curve slope threshold, the subject may be determined to be the living body. In response to the maximum curve slope of the electrical signals smaller than the liveness detection curve slope threshold, the subject may be determined to be the non-living body. In some embodiments, the minimum curve slope of the electrical signals received by the second recognition unit 520 may be compared with the liveness detection curve slope threshold. In response to the minimum curve slope value of the electrical signals smaller than the liveness detection curve slope threshold, the subject may be determined to be the living body. In response to the minimum curve slope value of the electrical signals greater than the liveness detection curve slope threshold, the subject may be determined to be the non-living body. By the above comparison, a recognition result that the of the subject is the living body or not may be obtained.

In some embodiments, a heart rate of the subject may be detected based on the curves of the electrical signals received by the second recognition unit 520. As shown in FIG. 8, the curve 802 corresponding to the living body changes periodically after the stabilization. The time period T of the curve 802 may be obtained (which may only measure a time span of one cycle, or measure a time span of multiple cycles to get an average). The heart rate of the subject may be determined based on T. Specifically, if a cardiac cycle is T (second), a heart rate per minute may be determined to be 60/T. By detecting the heart rate of the subject, a vital sign of the subject may be detected. For example, it may be applied to a heart rate detection of a driver of a vehicle. An early warning of sudden heart disease of the driver during driving may be generated. As another example, it may be applied to a heart rate detection of a user of a security device, synchronously implementing the identity confirmation purpose and the safety and health detection purposes. More descriptions of the heart rate detection may be found elsewhere in the present disclosure, and not repeated here.

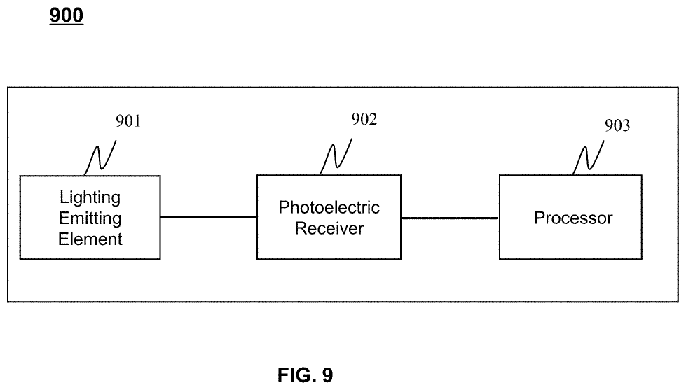

FIG. 9 is a block diagram illustrating an exemplary identity confirmation device according to some embodiments of the present disclosure. As shown in FIG. 9, in some embodiments, the identity confirmation device 900 may include a light emitting element 901, a photoelectric receiver 902, and a processor 903. The light emitting element 901 and the photoelectric receiver 902 may correspond to the second information obtainment sub-unit 421 in FIG. 4 of the present disclosure. The processor 903 may correspond to the second information processing sub-unit 422 in FIG. 4 of the present disclosure. The light emitting element 901 may be configured to emit a light towards a subject. In some embodiments, the light emitting element 901 may include a light emitting diode. The light emitting diode may include a visible light emitting diode and an invisible light emitting diode. In some embodiments, the visible light emitting diode may include a red light emitting diode, an orange light emitting diode, a yellow light emitting diode, a green light emitting diode, a cyan light emitting diode, a blue light emitting diode, a purple light emitting diode, a white light emitting diode, or the like, or any combination thereof. In some embodiments, the invisible light emitting diode may include an infrared light emitting diode, an ultraviolet light emitting diode, or a super infrared light emitting diode. In some embodiments, the light emitting element may include the infrared light emitting diode. In some embodiments, the infrared light emitting diode may include a diode capable of emitting an infrared ray of a wavelength of 830 nanometers to 950 nanometers. In some embodiments, the infrared light emitting diode may include a diode capable of emitting an infrared ray of a wavelength of 850 nanometers or 940 nanometers.

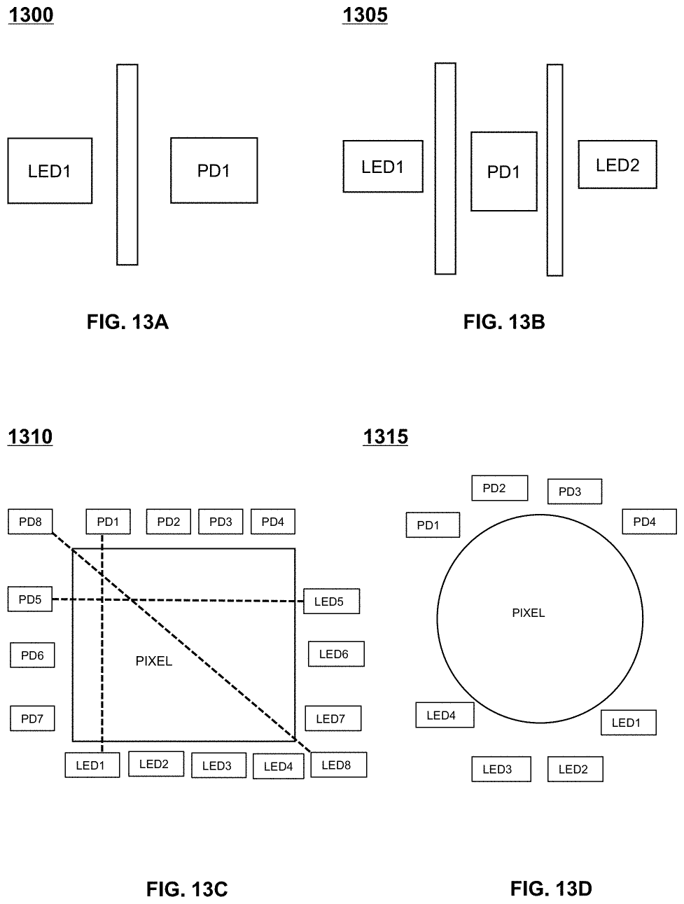

The photoelectric receiver 902 may be configured to receive the light reflected by the subject, and transmit an intensity signal of the light reflected by the subject to the processor 903. In some embodiments, the photoelectric receiver 902 may match the light emitting element 901. For example, when the light emitted by the light emitting element 901 includes the infrared light of a wavelength of 850 nanometers, the photoelectric receiver 902 may be configured to receive the infrared light of the wavelength of 850 nanometers. In some embodiments, a count of the light emitting element 901 and the photoelectric receiver 902 may be one or more, respectively. By setting positions of the light emitting element 901 and the photoelectric receiver 902, the light emitted by the light emitting element 901 may be not directly emitted to the photoelectric receiver 902, but received by the photoelectric receiver 902 after being reflected by the subject. More descriptions of a distribution of the light emitting element 901 and the photoelectric receiver 902 may be found elsewhere in the present disclosure, for example, FIG. 13a, FIG. 13b, FIG. 13c, FIG. 13d, or the descriptions thereof.

The processor 903 may be configured to determine whether the light intensity of the light reflected by the subject satisfies a predetermined liveness recognition condition, and determine a detection result of the subject. The light emitting element 901 and the photoelectric receiver 902 may be elements in the second information obtainment sub-unit 421. The processor 903 may be the second information processing sub-unit 422 or one component thereof. The intensity of the light received by the photoelectric receiver 902 may be transmitted to the processor 903 via the network 120 or the communication module 240. More descriptions that the processor 903 determines whether the intensity of the light reflected by the subject satisfies the predetermined liveness recognition condition, and determine the detection result of the subject may be found elsewhere in the present disclosure, for example, FIG. 10 or the descriptions thereof, and not repeated here.

It should be noted that the above descriptions of the identity confirmation device are merely provided for the purposes of illustration, and not intended to limit the scope of the present disclosure. For persons having ordinary skills in the art, multiple variations and modifications on the specific manners of the identity confirmation may be made under the teachings of the present disclosure. However, those variations and modifications do not depart from the scope of the present disclosure. For example, there may be multiple groups of the light emitting element 901 and the photoelectric receiver 902. As another example, a count of the light emitting element 901 may be one, and the count of the photoelectric receiver 902 may be multiple. As a further example, a count of the light emitting element 901 may be multiple, and a count of the photoelectric receiver 902 may be multiple. Such variations is within the scope of the present disclosure.

FIG. 10 is a flowchart illustrating an exemplary process for recognizing a living body according to some embodiments of the present disclosure. To further illustrate a specific process of the identity confirmation device 900, the embodiments described herein may take an infrared light as an example to illustrate the process of the identity confirmation device 900.

In 1010, an infrared light may be emitted towards a subject. The operation may be performed by the light emitting element 901. In some embodiments, a wavelength of the infrared light may be from 830 nanometers to 950 nanometers. In some embodiments, the wavelength of the infrared light may be 850 nanometers or 940 nanometers.

In some embodiments, the light emitting element 901 may include a light emitting diode of other wavelengths that emits other invisible lights (e.g., an ultraviolet light, a far-infrared light) of wavelengths smaller than 380 nanometers or greater than 760 nanometers towards the subject or other visible lights (e.g., a red light, an orange light, a yellow light, a green light, a cyan light, a blue light, a purple light, a white light) of wavelengths from 380 nanometers to 780 nanometers.

In 1020, the infrared light reflected by the subject may be received. The operation may be performed by the photoelectric receiver 902.

It should be noted that the identity confirmation device 900 may include at least one photoelectric receiver 902 configured to receive the infrared light reflected by a surface of the subject. The photoelectric receiver 902 may convert a received optical signal into an electrical signal. The electrical signal may change as an intensity of the optical signal changes. It should be noted that when the infrared light is emitted on a human finger, the blood oxygen in the human finger may absorb a portion of the infrared light. A concentration of the blood oxygen of the tissues in the human finger may change regularly, causing that the infrared light absorbed by the blood oxygen may change regularly. In response to the subject being a non-living body, the infrared light may be not absorbed by the non-living body. The infrared light absorbed by the non-living body may be constant, or the infrared light absorbed by the non-living body may change irregularly. Therefore, a curve formed by intensities (also referred to as infrared light intensity) of the infrared light reflected by the non-living body may be a flat straight line or an irregular curve, while a curve formed by intensities of the infrared light reflected by the living body may be a regular curve. A detection time period may be set according to a specific condition, which may be not limited here. More specifically, different subjects may correspond to different signal attenuations due to different reflectances of different materials. For example, a reflectance of a material of a low-end fingerprint film or a low-end fingerprint sleeve may be different from the reflectance of the human tissue, causing a great difference between intensities of infrared lights reflected by thereof. Whether the subject includes the human tissue or not may be determined by comparing the intensities (e.g., an average) of the reflected infrared light with a predetermined threshold. As another example, a reflectance of a material of a high-end fingerprint film or a high-end fingerprint sleeve may be similar to the reflectance of the human tissue. However, the concentration of the blood oxygen of the living body may change periodically due to the heart beat and/or the pulse of the living body. Due to the absorption of the infrared light by the blood oxygen of the human tissue and diffuse reflection characteristics of the infrared light, the absorption of the infrared light by the blood oxygen may also change with the change of the concentration of the blood oxygen. Therefore, the intensity of the reflected infrared light may fluctuate periodically, which is absent even for a high-end fingerprint film or a high-end fingerprint sleeve whose material is similar to the human tissue. Whether the subject is the living body or not may be determined by comparing a fluctuation value (a difference between the maximum value and the minimum value) or the maximum curve slope of the reflected infrared light with the predetermined threshold. Additionally or alternatively, the periodic fluctuation of the blood oxygen concentration may also reflect the change of the human heart rate. The vital sign information, e.g., the heart rate of the human body may be obtained by analyzing the reflected infrared light.

In 1030, whether the intensity of the infrared light reflected by the subject satisfies the predetermined liveness recognition condition may be determined. The operation may be implemented by the processor 903.

In some embodiments, whether the intensity of the infrared light reflected by the subject is within a predetermined intensity range may be determined. For example, the predetermined intensity range may include an upper limit and a lower limit. In response to the intensity of the infrared light reflected by the subject greater than or equal to the lower limit and smaller than or equal to the upper limit, the subject may be determined to be the living body. In response to the intensity of the infrared light reflected by the subject smaller than the lower limit or greater than the upper limit, the subject may be determined to be the non-living body. In some embodiments, the intensity of the infrared light reflected by the subject may include an average, the maximum value, the minimum value of the intensity, or the like, or any combination thereof. Further, one or more of the average, the maximum value, and the minimum value of the intensity of the infrared light reflected by the subject may be compared with the predetermined intensity range. In some embodiments, a difference between the maximum value and the minimum value of the intensity of the infrared light reflected by the subject may be compared with a predetermined intensity range. In response to the difference between the maximum and minimum value of the intensity of the infrared light emitted by the subject within the predetermined intensity range, the subject may be determined to be the living body. In response to the difference between the maximum value and the minimum value of the intensity of the infrared light reflected by the subject smaller than the predetermined intensity range, the subject may be determined to be the non-living body. In some embodiments, in response to the difference between the maximum value and the minimum value of the intensity of the infrared light reflected by the subject greater than the predetermined intensity range, the subject may be determined to be the non-living body or the operation of the subject during the detection may be not standardized.

In some embodiments, whether a curve of the intensity of the infrared light reflected by the subject over time during the detection time period conforms to a predetermined curve may be determined. More specifically, the conformity of the predetermined curve (e.g., a regular curve) may indicate that a trend of the change of the curve of the intensity of the reflected infrared light over time conforms to a trend of the change of the predetermined curve.

In some embodiments, whether the curve of the intensity of the infrared light reflected by the subject over time conforms to the predetermined curve may be determined by determining whether a curve similarity between thereof satisfies a similarity threshold. In some embodiments, in response to the curve similarity greater than or equal to the similarity threshold, the subject may be determined to be the living body. In response to the curve similarity smaller than the similarity threshold, the subject may be determined to be the non-living body. Merely by way of example, the similarity threshold may be 80%. In response to the curve similarity greater than or equal to 80%, the subject may be determined to be the living body. In response to the curve similarity smaller than 80%, the subject may be determined to be the non-living body.

In some embodiments, the curve similarity may be compared and/or determined by a trained machine learning model. In some embodiments, an algorithm for comparing and/or determining the curve similarity by the trained machine learning model may include a similarity algorithm based on a Euclidean distance, a similarity algorithm based on a Manhattan distance, a similarity algorithm based on a Chebyshev distance, a similarity algorithm based on a Minkowski distance, a similarity algorithm based on a standardized Euclidean distance, a similarity algorithm based on a Mahalanobis distance, a similarity algorithm based on an angle cosine, a similarity algorithm based on a Pearson correlation coefficient, a similarity algorithm based on a dynamic time warping (DTW) distance, a similarity algorithm based on a Kullback-Leibler (KL) divergence, or the like, or any combination thereof. In some embodiments, historical curves of intensities of infrared lights reflected by multiple subjects over time may be selected as training samples to train a preliminary machine learning model and determine the trained machine learning model configured to compare and/or determine the curve similarity.

In some embodiments, the identity of the subject may be determined by comparing the curve of the intensity of the infrared light reflected by the subject over time during the detection period with the predetermined curve. For example, a predetermined curve of an intensity of a reflected infrared light corresponding to the identity of the subject may be pre-stored. After the identity confirmation device 900 acquires the curve of the intensity of the infrared light reflected by the subject over time, the curve may be searched and matched with the predetermined curve to determine the identity of the subject. For example, within a short time period (hours, days), two different living bodies may have their own fixed but different blood oxygen levels, causing their curves of intensities of infrared lights being fixed but different from each other. Therefore, by searching and matching the curve of the intensity of the infrared light with a predetermined curve set (including multiple curves of intensities of infrared lights reflected by different subjects), identity recognition may be performed while the living body recognition is performed. In some embodiments, in response to the subject being recognized as the living body and the identity being confirmed, an electrical signal curve of the subject may be stored as part of the identity of the subject. If a same electrical signal curve is detected within a specific time period, the identity recognition may be omitted and the identity of the subject may be directly determined as the identity corresponding to the stored electrical signal curve.

In some embodiments, whether the subject has a cardiac disease (e.g., the heart rate being too high, the heart rate being too low, arrhythmia, sudden cardiac arrest (SCA)) may be diagnosed by comparing the intensity of the reflected infrared light during the detection time period and the predetermined curve.

In response to the intensity of the infrared light reflected by the subject satisfying the predetermined liveness recognition condition, operation 1040 is performed, and the detection result may include that the subject is the living body; Otherwise, the subject may be determined to be the non-living body, operation 1050 may be performed, and the fingerprint recognition may be not performed.

It should be noted that whether the subject is the living body or not may be determined based on one of the above mentioned conditions: the intensity of the infrared light, or the curve of the intensity of the infrared light over time during the detection time period. However, whether the subject is the living body or not may be determined based both on the intensity of the infrared light and the curve of the intensity of the infrared light over time during the detection time period. In some embodiments, the second recognition unit 420 may also perform the liveness recognition of the subject based on the heart rate, a palmar digital vein, the face, an iris, or other information of the subject.

It should be noted that the descriptions of the process 1000 are merely provided for the purposes of illustration, and not intended to limit the scope of the present disclosure. For persons having ordinary skills in the art, multiple variations and modifications of the process 1000 may be made under the teachings of the present disclosure. However, those variations and modifications do not depart from the scope of the present disclosure. For example, in some embodiments, the infrared light may be replaced with a visible light (e.g., white light, green light, blue light). In some embodiments, the liveness recognition condition (the predetermined infrared intensity range, the predetermined infrared curve) may be replaced with information relating to the heart rate, the palmar digital vein, the face, the iris, etc.

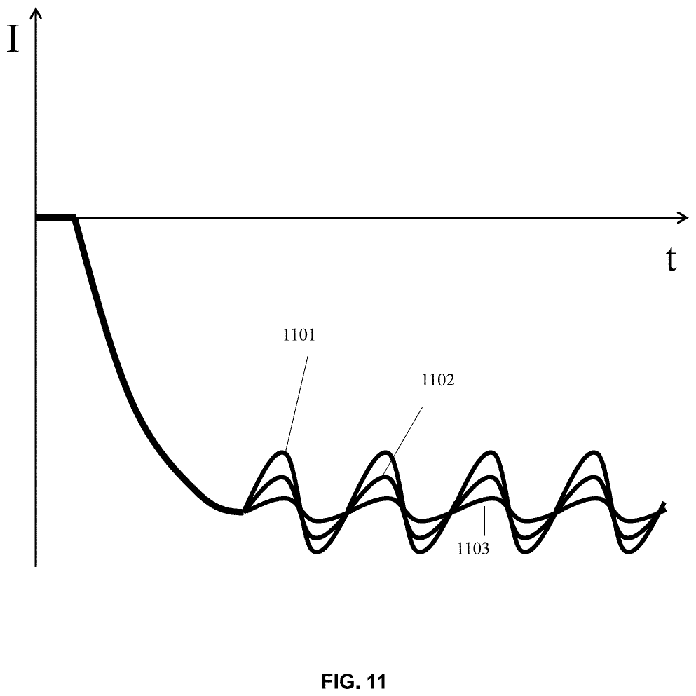

FIG. 11 is a schematic diagram illustrating exemplary signal curves of different blood oxygen levels of subjects according to some embodiments of the present disclosure. As shown in FIG. 11, curves 1101, 1102, and 1103 may respectively represent intensities of electrical signals received by the second recognition unit 520 over time when fingers and palms of three subjects of different blood oxygen levels are placed on the finger/palm placement area 540. Since different blood oxygen levels may affect reflectances of an infrared light, and further affect an intensity of a received infrared light and an intensity of the converted electrical signal, the curves 1101, 1102, and 1103 may be different.

Since the blood oxygen level of a same subject may change slightly within a short time period under a condition that a surrounding environment remains unchanged and the subject has no strenuous exercise, an absorption/reflection of the same subject for a same light may be almost the same, and a corresponding curve may be almost the same. Therefore, a specific subject of a particular blood oxygen level and a particular heart rate may be determined based on a fluctuation degree and a change cycle of the curve of the received electrical signal. Therefore, identity of the subject may be determined. In some embodiments, in response to a specific subject being recognized as a living body and an identity of the specific subject being confirmed, an electrical signal curve of the subject may be stored as part of the identity of the subject. In response to the same electrical signal curve being detected within a specific time period, the identity recognition may be omitted and the identity of the specific subject may be directly determined as identity corresponding to the stored electrical signal curve.

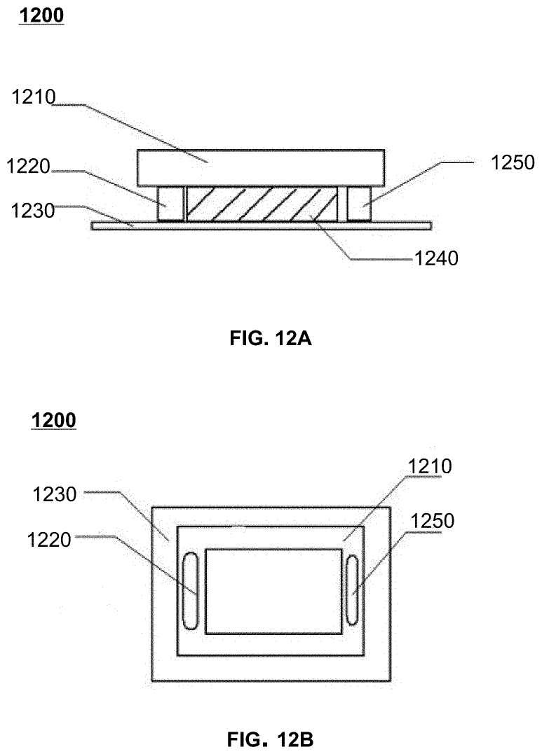

FIG. 12A is a section view of an exemplary identity confirmation device according to some embodiments of the present disclosure. FIG. 12B is a top view of an exemplary identity confirmation device according to some embodiments of the present disclosure. As shown in FIG. 12A and FIG. 12B, in some embodiments, the identity confirmation device 1200 may include an optical lens 1210 (also referred to as a light transmitting plate), a photoelectric receiver 1220, a chip (not shown), a fingerprint scanner 1240, and an infrared light emitting element 1250. The fingerprint scanner 1240 may correspond to the first information obtainment sub-unit 411 in FIG. 4. The infrared light emitting element 1250 and the photoelectric receiver 1220 may correspond to the second information obtainment sub-unit 421 in FIG. 4. The chip may correspond to the first information processing sub-unit 412 and the second information processing sub-unit 422 in FIG. 4.

The fingerprint scanner 1240 may be configured to scan a fingerprint image of a subject. The fingerprint image may be an image obtained by collecting uneven lines on the skin of the end of a finger using by an image collection device. Lines of each fingerprint image may be arranged regularly and form different line arrangements, and a start point, an end point, a conjunction point, and a bifurcated point of each line may be different. The fingerprint scanner 1240 may include the first information obtainment sub-unit 411 of the first recognition unit 410.

The infrared light emitting element 1250 may be configured to emit an infrared light of a specific wavelength. The photoelectric receiver 1220 may be configured to receive the infrared light reflected by the subject, and convert an intensity of the infrared light reflected by the subject into an electrical signal. In some embodiments, the infrared light emitting element 1250 may include but being not limited to an infrared light emitting diode. In some embodiments, the infrared light emitting element 1250 may include a light emitting element of other colors, such as a red light emitting element, a blue light emitting element, a white light emitting element, etc. Correspondingly, the infrared light emitting element 1250 may match the photoelectric receiver 1220.

It should be noted that there may be a group of the infrared light emitting element 1250 and the photoelectric receiver 1220 shown in FIG. 12A and FIG. 12B, which may be non-limiting. There may also be multiple groups (for example, two groups, three groups, four groups) of the infrared light emitting element 1250 and the photoelectric receiver 1220. In some embodiments, the multiple groups of the infrared light emitting element 1250 and the photoelectric receiver 1220 may emit, and receive infrared lights of different wavelengths, respectively. The emitting and receiving process of the multiple groups of the infrared light emitting element 1250 and the photoelectric receiver 1220 may be simultaneous or subsequent. The infrared light emitting element 1250 and the photoelectric receiver 1220 may be included in the second information obtainment sub-unit 421.

In some embodiments, the infrared light emitting element 1250 and the photoelectric receiver 1220 may be disposed oppositely. For example, the infrared light emitting element 1250 may be located at one side of the fingerprint scanner 1240, and the photoelectric receiver 1220 may be located at another side of the fingerprint scanner 1240. In some embodiments, the infrared light emitting element 1250 and the photoelectric receiver 1220 may also be located at two corners of the diagonal of the fingerprint scanner 1240. Detailed descriptions of the infrared light emitting element 1250 and the photoelectric receiver 1220 may be found elsewhere in the present disclosure (e.g., FIG. 13), which are not repeated here.

In some embodiments, an upper surface of the infrared light emitting element 1250 and an upper surface of the photoelectric receiver 1220 may be not higher than an upper surface of the fingerprint scanner 1240. It should be noted that the infrared light emitting element 1250 may include a device capable of emitting the infrared light. In some embodiments of the present disclosure, the infrared light emitting element 1250 may emit the infrared light towards the subject. The photoelectric receiver 1220 may receive the infrared light reflected by the subject. The photoelectric receiver 1220 may convert the received infrared light into an electrical signal. The chip may determine an intensity of the electrical signal to realize a liveness recognition function. If the infrared light is directly emitted to the photoelectric receiver 1220, the intensity of the infrared light reflected by the subject may be smaller, by several orders of magnitude, than an intensity of being directly emitted to the photoelectric receiver 1220, and be undetectable, and the accuracy of liveness recognition of the subject may be poor. Therefore, the infrared light emitted by the infrared light emitting element 1250 may be not directly emitted to the photoelectric receiver 1220 (the infrared light may be emitted towards the subject through the optical lens 1210, then be reflected from the subject through the optical lens 1210 and be emitted to the photoelectric receiver 1220).

As shown in FIG. 12A, the optical lens 1210 may be located above the fingerprint scanner 1240, the infrared light emitting element 1250, and the photoelectric receiver 1220. The infrared light emitted by the infrared light emitting element 1250 may travel through the optical lens 1210 and emit towards the subject. The photoelectric receiver 1220 may receive the infrared light reflected by the subject. The fingerprint scanner 1240 may scan the fingerprint image of the subject placed on the optical lens 1210.

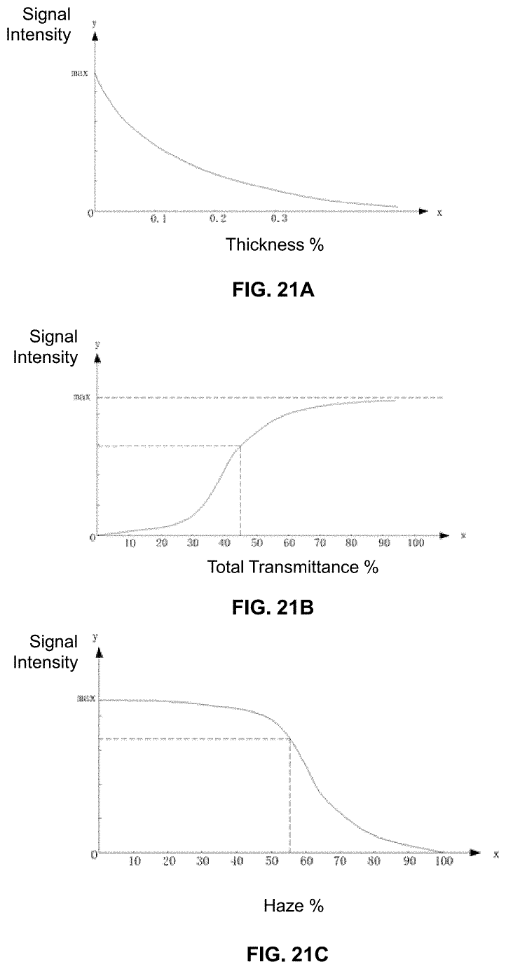

The optical lens 1210 may isolate the components inside the identity confirmation device 1200 from the outside, preventing an external foreign matter from entering the identity confirmation device 1200. The optical lens 1210 may also allow the infrared light of the infrared light emitting element 1250 to travel through, and allow the infrared light to irradiate on a surface of the subject placed thereon. The optical lens 1210 may also allow the infrared light reflected by the subject to travel through and to be received by the photoelectric receiver 1220. In some embodiments, the optical lens 1210 may also filter out lights of specific wavelengths, or have relatively large attenuations of the light of the specific wavelengths. In some embodiments, a transmittance (also referred to as a total transmittance) of the optical lens 1210 may be at least 45% or more. The transmittance may refer to a percentage of a ratio of a luminous flux of an incident light transmitting the optical lens to a luminous flux of the incident light. In some embodiments, a material of the optical lens 1210 may include glass, plexiglass (PMMA), polyvinyl chloride, polycarbonate (PC), polystyrene (PS), ABS plastic, etc. The optical lens 1210 may match the light emitting element. For example, when the light emitting element is the infrared light emitting element 1250, the optical lens 1210 may be travelled through by the infrared light. As another example, when the light emitting element is the white light emitting element, the optical lens 1210 may be traveled through by a white light. Detailed descriptions of the optical lens 1210 may be found elsewhere in the present disclosure, for example, FIG. 21A, FIG. 21B, and FIG. 21C or the description thereof, which are not repeated here.

Only taking the infrared light emitting element 1250 in the embodiments as an example, the infrared light emitted by the infrared light emitting element 1250 may pass through the optical lens 1210 towards the subject. Due to the diffuse reflection characteristics of the light, the infrared light may be reflected by the subject, and the reflected infrared light may be received by the photoelectric receiver 1220. The photoelectric receiver 1220 may convert the received infrared light into the electrical signal. The electrical signal may change with the intensity of the infrared light.

The chip may contain the processor 903 (see FIG. 9) or the processing module 220. The chip may be connected to the photoelectric receiver 1220, the infrared light emitting element 1250, and the fingerprint scanner 1240. In some embodiments, the chip may determine a liveness recognition result of the subject based on the infrared light received by the photoelectric receiver 1220. In some embodiments, the chip may also retrieve the fingerprint image of the subject from a pre-stored fingerprint image set to determine a fingerprint recognition result.

It should be noted that since the infrared light may be absorbed by the blood oxygen in the finger tissue, and a concentration of the blood oxygen in the finger tissue may change when the finger tissue is irradiated by the infrared light, an absorption of the infrared light absorbed by the blood oxygen may change. The photoelectric receiver 1220 may convert the detected infrared light into an electrical signal, transmit the electrical signal to the chip for analysis. The chip may determine whether the subject is a living body or not based on a result including whether the intensity of the electrical signal changes. Detailed descriptions of the liveness recognition result and the fingerprint recognition result of the subject may be found elsewhere in the present disclosure, which are not repeated here.

In some embodiments, one or more user fingerprint images may be pre-recorded and pre-stored in a storage device or a database to obtain the fingerprint image set. During the usage, the obtained fingerprint image of the subject and the pre-stored fingerprint images in the fingerprint image set may be matched and identified. If a fingerprint feature of the fingerprint image of the subject is determined to match a fingerprint feature of a pre-stored fingerprint image in the fingerprint image set, the fingerprint matching may be determined to be successful, and the fingerprint recognition may be determined to be confirmed. If the fingerprint feature of the fingerprint image of the subject fails to match any fingerprint feature of the pre-stored fingerprint images in the fingerprint image set, the fingerprint matching may be determined to be unsuccessful, and the fingerprint recognition may be determined to fail.

In some embodiments, only when the subject is the living body, the fingerprint recognition may be performed on the subject and the fingerprint recognition result may be determined. When the subject is the non-living body, the fingerprint recognition may be not performed. In some embodiments, when the fingerprint recognition of subject is confirmed, the liveness recognition may be performed on the subject. When the fingerprint recognition of subject fails to be confirmed, the liveness recognition may be not performed. Additionally or alternatively, the liveness recognition and the fingerprint recognition (or other identity recognition) may be performed at the same time, and a detection result may be determined based on results of the liveness recognition and the fingerprint recognition.

In some embodiments, the identity confirmation device 1200 may also include a support plate 1230. The support plate 1230 may be disposed below the fingerprint scanner 1240 and in contact with the fingerprint scanner 1240, the infrared light emitting element 1250, and the photoelectric receiver 1220. The support plate 1230 may be configured to support the fingerprint scanner 1240, the infrared light emitting element 1250, and the photoelectric receiver 1220. In some embodiments, the support plate 1230 may include a printed circuit board, a flexible circuit board, etc., which may be non-limiting.

Based on the above-mentioned identity confirmation device 1200, the implementation principle thereof may be exemplified as follows.

When a human finger is in contact with the optical lens 1210, a wake-up device (e.g., the wake-up unit 430) may activate the infrared light emitting element 1250. The infrared light emitting element 1250 may emit the infrared light. The infrared light may pass through the optical lens 1210 and be irradiated on the human finger. The human finger may reflect the infrared light and then the infrared light may pass through the optical lens 1210 and be received by the photoelectric receiver 1220. The photoelectric receiver 1220 may convert the received infrared light to the electrical signal, which is transmitted to the chip for processing. If the finger of the subject belongs to the living body, a concentration of the blood oxygen in the finger tissue may change when the infrared light normally irradiates on the finger tissue. An absorption of the infrared light absorbed by the blood oxygen may also change with the change of the concentration of the blood oxygen. The intensity of the infrared light received by the receiver 1220 may change periodically. The photoelectric receiver 1220 may convert the changed intensity into an electrical signal. The chip may determine that the subject is the living body based on the changed electrical signal at a current time point. If the subject is the non-living body, when the infrared light is irradiated on the subject, the infrared light may be reflected by the subject. Since the subject is the non-living body, there may be no change in the concentration of the blood oxygen, thus there may be no change of the intensity of the infrared light. Therefore, the intensity of the infrared light received by the photoelectric receiver 1220 may be constant, and the electrical signal converted by the photoelectric receiver 1220 based on the constant infrared light may also be constant. Therefore, the chip may determine the subject is the non-living body based on the constant electrical signal. When the subject is detected to be the living body, the fingerprint image scanned during the liveness fingerprint detection may be used to perform the fingerprint recognition (which is a type of the identity recognition). The fingerprint recognition may include searching for the fingerprint image of the subject in the pre-recorded fingerprint image set. If a fingerprint feature of the fingerprint image of the subject is determined to match a specific fingerprint image of the fingerprint image set, the fingerprint recognition may be confirmed. In response to the fingerprint feature of the fingerprint image of the subject failing to match the pre-stored fingerprint images of the fingerprint image set, the fingerprint recognition may fail to be confirmed. The identity confirmation device 1200 provided in the embodiment may determine the liveness recognition result by performing the liveness recognition on the subject, and then determine the fingerprint recognition result by recognizing the fingerprint of the subject. By using double recognition, the security of a fingerprint lock using the fingerprint recognition technology may be improved.

It should be noted that the above identity confirmation device 1200 may have the liveness recognition function and the identity recognition function. In other embodiments, the identity confirmation device 1200 may only have the liveness recognition function or the identity recognition function. For example, the fingerprint scanner 1240 may be omitted from the identity confirmation device 1200, and the identity confirmation device 1200 may only have the liveness recognition function. At this time, the identity confirmation device 1200 may be applied to the inside of a door including an anti-peephole door lock. In this way, the liveness recognition may need to be performed when the inside of the door is unlocked, preventing the door from being accidently unlocked by, for example, an unauthorized person or animal (e.g., a child, a pet (e.g., a dog)) from the inside, such that the security is improved. As another example, the 1 and the photoelectric receiver 1220 may be omitted from the identity confirmation device 1200, thereby only having the identity recognition (e.g., the fingerprint recognition) function.

In order to be relatively accurate to obtain the intensity of the reflected infrared light of the subject, the light emitting element may be separated from the photoelectric receiver to allow the light emitted by the light emitting element not directly irradiate on the photoelectric receiver. In some embodiments, a light shielding element may be situated between the light emitting element and the photoelectric receiver. The light shielding element may be made of an optically non-transmissive material.

FIG. 13A is a schematic diagram illustrating an exemplary distribution of a light emitting element and a photoelectric receiver according to some embodiments of the present disclosure. As shown in FIG. 13A, the identity confirmation device 1300 may include a group of a light emitting element and a photoelectric receiver (LED1 may indicate the light emitting element, and PD1 may indicate the photoelectric receiver), and a light shielding element (a rectangular region may indicate the light shielding element) located between LED1 and PD1. LED1 and PD1 may be separated by the light shielding element such that a light emitted by the LED1 may not directly emit to the PD1. In some embodiments, the identity confirmation device 1300 may also include multiple light emitting elements or multiple photoelectric receivers. The multiple light emitting elements may be located at one side of the light shielding element. The multiple photoelectric receivers may be located at another side of the light shielding element.

FIG. 13B is a schematic diagram illustrating an exemplary light emitting element and an exemplary photoelectric receiver according to some embodiments of the present disclosure. In the embodiments, the identity confirmation device 1305 may include two light emitting elements (LED 1 and LED 2) and a photoelectric receiver (PD1). LED 1 and LED 2 may be located at two sides of the PD1. Light shielding elements may be disposed between PD1 and LED1, and PD1 and LED2, respectively.

In some embodiments, the light shielding elements may be disposed along a circumferential direction of the photoelectric receiver and/or the light emitting elements. The light shielding elements may separate the photoelectric receiver from the light emitting elements surrounding thereof, such that lights emitted by the light emitting elements may be not directly irradiate to the photoelectric receiver. In some embodiments, one of the light shielding elements may include two through holes. The photoelectric receiver and/or the light emitting elements may be located in the through holes of the light shielding elements, such that the lights emitted by the light emitting element may not directly irradiate on the photoelectric receiver.

FIG. 13C is a schematic diagram illustrating exemplary light emitting elements and exemplary photoelectric receivers according to some embodiments of the present disclosure. As shown in FIG. 13C, the identity confirmation device 1310 may include light emitting elements, photoelectric receivers, and a pixel region. The pixel region may be located in the fingerprint scanner 1240 (see FIG. 12). The pixel region may be configured to obtain a fingerprint image of a subject. In the embodiment, the pixel region may include a rectangle or a square and an optically non-transmissive region such that lights emitted by the light emitting elements may not be directly irradiated on the photoelectric receiver.

In some embodiments, the light emitting elements and the photoelectric receivers may be located at two sides of the pixel region. The identity confirmation device 1310 may include multiple light emitting elements and multiple photoelectric receivers located at two sides of the pixel region, respectively. In some embodiments, as shown in FIG. 13C, the multiple light emitting elements may be horizontally located at a bottom side of the pixel region, and the multiple photoelectric receivers may be horizontally located at a top side opposite to the pixel region. In some embodiments, each group of the light emitting elements and photoelectric receivers may be set oppositely. For example, as shown in FIG. 13C, LED 1 may be opposed to PD1, and LED2 may be opposed to PD2. In other embodiments, the positions of each group of the light emitting elements and the photoelectric receivers may be not set oppositely. For example, LED1, LED 2, LED3, and LED4 may be sequentially and horizontally set from left to right on the bottom side of the pixel region. PD4, PD3, PD2, and PD1 may be sequentially and horizontally set from left to right in the top side of the pixel region.

In some embodiments, the multiple light emitting elements may be vertically located at a right side of the pixel region, and the multiple photoelectric receivers may be vertically located at a left side of the pixel region. In some embodiments, each group of the light emitting elements and the photoelectric receivers may be set oppositely. For example, as shown in FIG. 13C, LED 5 may be opposed to PD5, and LED 5 may be opposed to PD5. In other embodiments, the positions of each group of the light emitting elements and the photoelectric receivers may be not set oppositely. For example, LED5, LED 6, the LED 7 may be sequentially and vertically set from top to bottom at the right side of the pixel region, PD7, PD6, and PD5 may be sequentially and vertically set from top to bottom in the left side of the pixel region.

In some embodiments, the light emitting elements and the photoelectric receivers may be located at opposite corners of the pixel region. For example, PD8 and LED8 may be located at two opposite corners of the pixel region, respectively. In some embodiments, the pixel region may be not limited to the arrangement in FIG. 13C, and the circumferential direction of the pixel region may be set to have any tilting angle with respect to any standard direction (for example, a north direction). Accordingly, the light emitting elements and the photoelectric receivers may be arranged along the circumferential direction of the pixel region and having certain tilting angles with respect to the standard direction.

FIG. 13D is a schematic diagram illustrating an exemplary distribution of light emitting elements and photoelectric receivers according to some embodiments of the present disclosure. In some embodiments, a pixel region may also be a circle. Multiple light emitting elements and multiple photoelectric receivers may be located at two sides of a centerline of the circular pixel region, respectively. For example, PD1, PD2, PD3, and PD4 may be located at an upper side of the circular pixel regions, and LED1, LED2, LED3, and LED4 may be located at a lower side of the circular pixel region. The multiple light emitting elements and the multiple photoelectric receivers may be distributed along a circumferential direction of the circular pixel region. In some embodiments, each group of the light emitting elements and the photoelectric receivers may be located in an extension line of a same diameter of the circular pixel region.

In some embodiments, wavelengths of lights processed by each group of the light emitting elements and the photoelectric receivers may be the same. For example, wavelengths of lights processed by LED1 and PD1, LED2 and PD2, LED3 and PD3, LED 4 and PD4 of the identity confirmation device 1315 may all be 850 nanometers. In some embodiments, the wavelengths of the lights processed by each group of the light emitting elements and the photoelectric receivers may be different. For example, the wavelength of an infrared light emitted by the LED1 may be 850 nanometers, and the wavelength of an infrared light received by the PD1 may be 850 nanometers. The wavelength of an infrared light emitted by the LED2 may be 940 nm, and the wavelength of the infrared light received by the PD2 may be 940 nanometers.

The count of the light emitting elements and the count of the photoelectric receivers in such embodiments may also be different. For example, the identity confirmation device may include multiple light emitting elements and a photoelectric receiver. Lights emitted by the multiple light emitting elements and reflected by the subject may be received by the photoelectric receiver. As another example, the identity confirmation device may include a light emitting element and multiple photoelectric receivers. A light emitted by the light emitting element and reflected by the subject may be received by the multiple photoelectric receivers.

In some embodiments, the light emitting element and the photoelectric receiver may also be located inside the pixel region. A top side of the light emitting element and a top side of the photoelectric receiver may be below or flush with the top side of the pixel region. Since an optically non-transmissive material (for example, silicon grease) may exist inside the pixel region, the light emitted by the light emitting element may be not directly irradiated on the photoelectric receiver.

In some embodiments, the length of the pixel region may be from 4 millimeters to 11 millimeters. In some embodiments, the length of the pixel region may be from 5 millimeters to 8 millimeters. In some embodiments, the length of the pixel region may be from 5.4 millimeters to 6 millimeters. In some embodiments, the width of the pixel region may be from 4 millimeters to 11 millimeters. In some embodiments, the width of the pixel region may be from 5 millimeters to 8 millimeters. In some embodiments, the width of the pixel region may be from 4.5 millimeters to 6 millimeters.

In some embodiments, a gap between the light emitting element and the photoelectric receiver may be at least 0.5 millimeters. The gap between the light emitting element and the photoelectric receiver may be selected according to the size of the light shielding element, the size of the identity confirmation device, and the size of the pixel region, which may be not further limited in the embodiments.

It should be noted that the descriptions of the identity confirmation device are merely provided for the purposes of illustration, and not intended to limit the scope of the present disclosure. For persons having ordinary skills in the art, multiple variations and modifications of the identity confirmation device may be made under the teachings of the present disclosure. However, those variations and modifications do not depart from the scope of the present disclosure. For example, the pixel region may also have an elliptical shape, other regular or irregular polygons (e.g., a triangle, a pentagon). Further, for example, the light emitting diode and the photoelectric receiver may also be distributed in a same side of the pixel region and be isolated by a plate of an optically non-transmissive material. Such variations and modifications do not depart from the scope of the present disclosure

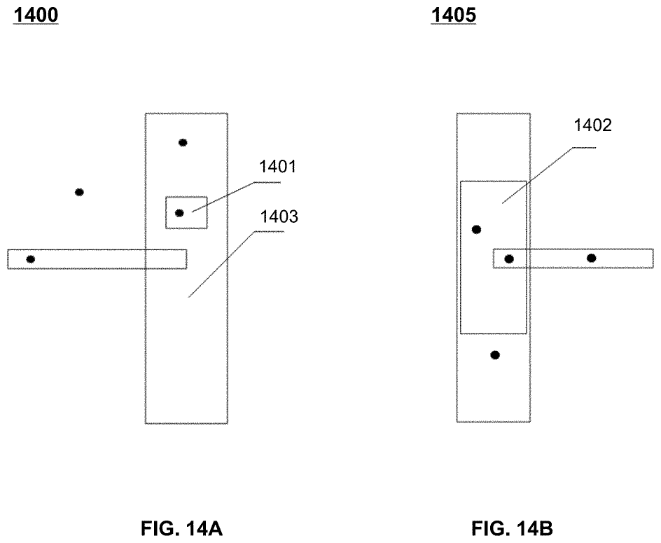

FIG. 14A and FIG. 14B are schematic diagrams illustrating exemplary structures of door lock devices according to some embodiments of the present disclosure. An identity confirmation device may be applied to a security device (e.g., a lock, a turnstile, a safe deposit box), an electronic device (e.g., a mobile phone, a computer), and an online transaction of identity authentication. In the embodiments, the door lock device 1400 may be used as an example for further describing the above identity confirmation device. As shown in FIGS. 14A and 14B, the door lock device 1400 provided in the present disclosure may include a detection module 1401 (or referred to as a liveness fingerprint detection device), a control module 1402 (or referred to as a controller), a drive module (not shown, or referred to as a motor drive module) and a mechanical structure 1403 (or referred to as a mechanical lock body).

Merely by way of example, the detection module 1401 in the embodiments may be configured to perform a liveness recognition and a fingerprint recognition of a subject. In some embodiments, the detection module 1401 may be located in the mechanical structure 1403. In some other embodiments, the detection module 1401 may also be set independently that opposes to the mechanical structure 1403. For example, the detection module 1401 may be located at a door body or a wall near the mechanical structure 1403. In some embodiments, the detection module 1401 may be located at a user terminal (for example, a mobile phone, a tablet computer). The user terminal may process user information collected by the detection module 1401, transmit the processing result to the control module 1402 through a wired or wireless manner. In the embodiments, the mechanical structure 1403 may be a lock body structure of the door lock.

The control module 1402 and the drive module may be located in the mechanical structure 1403. The detection module 1401 may be connected to the control module 1402 by a wired manner or a wireless manner. The drive module may be connected to the control module 1402 by the wired manner or the wireless manner. The detection module 1401 may transmit a liveness recognition result and a fingerprint recognition result to the control module 1402. When the fingerprint recognition result includes that identity of the subject is confirmed, the control module 1402 may transmit an unlocking instruction to the drive module. The drive module may be configured to perform the unlocking instruction emitted by the control module 1402.

The control module 1402 may be an integrated chip including a storage medium and a processor. The storage medium may be configured to store program codes of the control module 1402. The processor may be configured to invoke a program of the control module 1402 in the storage medium, and perform a control of the drive module.

The drive module may include a motor. When the drive module receives the unlocking instruction transmitted by the control module, the motor may be initiated and drive a lock tongue in the mechanical structure to move into the lock body to unlock by a rotation of the rotor.

It should be noted that the control module 1402 may transmit the unlocking instruction to the drive module only in response to the fingerprint of the subject being confirmed. In response to the fingerprint of the subject failing to be confirmed, the control module may not transmit the unlocking instruction to the drive module. In some embodiments, the control module may further transmit a further locking instruction to the drive module.

In some embodiments, the door lock device 1400 may also include a wake-up module (e.g., black points in FIG. 14A and FIG. 14B). The wake-up module may activate the detection module 1401 from a standby mode, a hibernation mode, or a sleep mode. In some embodiments, the wake-up module may be located in the detection module 1401, at a shell of the mechanical structure 1403, at a door handle, at a door body, or at a wall near the door. In some embodiments, the wake-up module may also be located at a position of the door handle opposing a door panel (for example, a left, right, upper, or lower end of the door handle, a middle region) or a position of the door handle toward the door panel.

In some embodiments, the wake-up manner may include a contact wake-up and a non-contact wake-up. The contact wake-up may include a mechanical switch wake-up (e.g., a push-button switch wake-up, a shrapnel-type pressure wake-up), and a touch wake-up (e.g., a pressure sensor wake-up, a capacitive sensor wake-up). In some embodiments, the non-touch wake-up may include a voice wake-up, an infrared proximity wake-up, or the like, or any combination thereof. For example, a shrapnel-type pressure switch (for example, a snap dome) may be disposed below the detection module 1401. When the subject presses the detection module 1401 and a shrapnel-type pressure switch, the shrapnel-type pressure switch may be under a certain pressure, the detection module 1401 may be closed with and connected to an internal circuit of the door lock, and the detection module 1401 may be activated. When the pressure is removed, the detection module 1401 may be disconnected from the internal circuit of the door lock, and the detection module 1401 may switch to the hibernation mode after the detection. As another example, a capacitive sensor may be disposed on the door handle. When the subject touches the door handle, the detection module 1401 may be activated. As a further example, an infrared sensor may be disposed around the detection module. The detection module 1401 may be activated when the infrared sensor senses a person within a distance range approaching the detection module 1401.

It should be noted that the descriptions of the door lock device are merely provided for the purposes of illustration, and not intended to limit the scope of the present disclosure. For persons having ordinary skills in the art, multiple variations and modifications of the door lock device may be made under the teachings of the present disclosure. However, those variations and modifications do not depart from the scope of the present disclosure. For example, the door handle may be omitted from the door lock device 1400 or the door lock device 1405. As another example, the capacitive sensor may also be located in the detection module 1401. Such variations and modifications do not depart from the scope of the present disclosure.

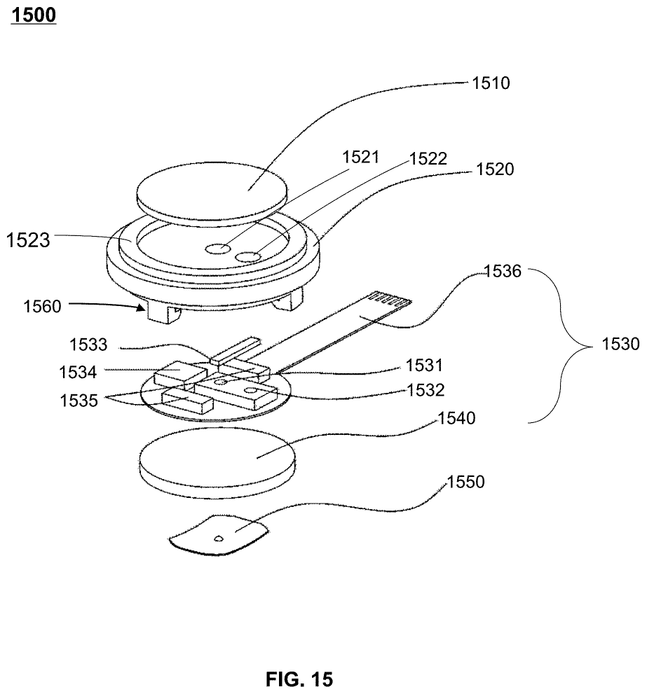

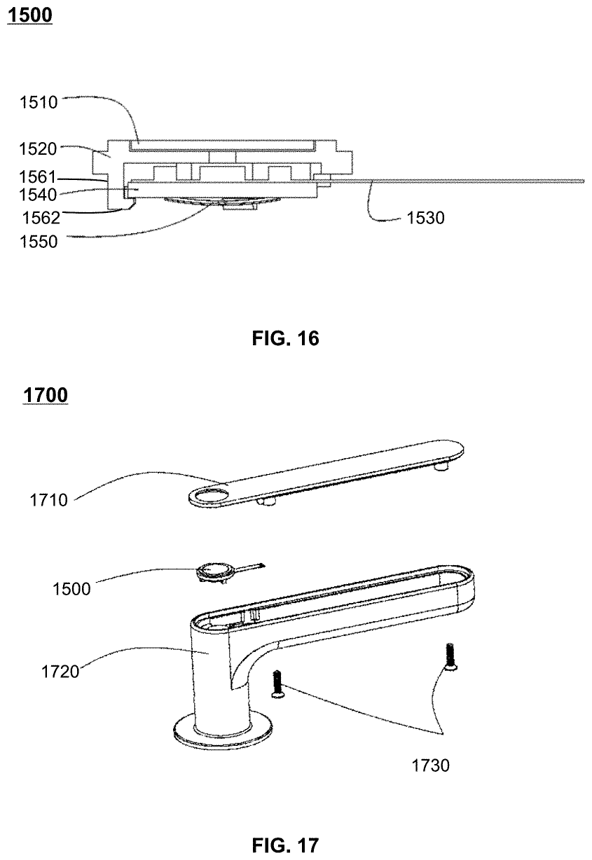

FIG. 15 is an exploded view of an exemplary identity confirmation device according to some embodiments of the present disclosure. FIG. 16 is a section view of an exemplary identity confirmation device according to some embodiments of the present disclosure. In some embodiments, the identity confirmation device 1500 may not include a fingerprint recognition module (first recognition unit), i.e., not have a fingerprint recognition function and only have a liveness recognition function. As shown in FIG. 15 and FIG. 16, in some embodiments, the identity confirmation device 1500 may include a support bracket 1520, a liveness recognition assembly 1530, and a printed circuit board (PCB) 1540. The liveness recognition assembly 1530 may correspond to the second recognition unit 420 in FIG. 4. In some embodiments, the liveness recognition assembly 1530 may include a light emitting element 1531, a photoelectric receiver 1532, a chip 1534, and a flexible circuit board (FPC) 1536.

The support bracket 1520 may include a support bracket body having a plate-like structure. The light emitting element 1531 and the photoelectric receiver 1532 may be located below the support bracket body.

In some embodiments, a material of the support bracket body may include an optically non-transmissive material. The support bracket body may include a first through hole 1521 and a second through hole 1522 corresponding to the light emitting element 1531 and the photoelectric receiver 1532, respectively. The light emitting element 1531 may emit a light towards the subject. The light emitted by the light emitting element 1531 may travel through the first through hole 1521 towards the subject. The light reflected by the subject may be received by the photoelectric receiver 1532 through the second through hole 1522. The photoelectric receiver 1532 may convert the received reflected light into an electrical signal. The liveness recognition function may be realized based on the electrical signal.

In some embodiments, the material of the support bracket body may include a transparent material. The transparent material may include glass, plexiglass (PMMA), polyvinyl chloride, polycarbonate (PC), polystyrene (PS), or ABS plastics, etc. The light emitted by the light emitting element 1531 may pass through the support bracket body, and the light reflected by the subject may travel through the support bracket body and be received by the photoelectric receiver 1532. By setting the light shielding element 1533, the light emitted by the light emitting element 1531 may be not directly received by the photoelectric receiver 1532. More descriptions of the light shielding element 1533 may refer to the descriptions of the light shielding element 1533 below. In some embodiments, a count of light emitting elements 1531 and/or a count of the corresponding first through hole 1521 may be not limited to one in FIG. 15, may also be 2, 3, 4 or more, respectively. In other embodiments, a count of photoelectric receivers 1532 and/or a count of the corresponding second through hole 1522 may be multiple. The specific distribution of the light emitting element 1531 and the photoelectric receiver 1532 may be found elsewhere in the present disclosure, for example, FIG. 13A, FIG. 13B, FIG. 13C, or FIG. 13D, or the descriptions thereof.

In some embodiments, the light shielding element 1533 may be disposed in a circumferential direction of the light emitting element 1531 and/or the photoelectric receiver 1532. The light shielding element 1533 may isolate the light emitting element 1531 from the photoelectric receiver 1532, preventing the light emitted by the light emitting element 1531 from being directly emitted to the photoelectric receiver 1532 and ensuring the accuracy of the liveness recognition result. In some embodiments, the light shielding element 1533 may also be located between the light emitting element 1531 and the photoelectric receiver 1532. In some embodiments, the light shielding element 1533 may include a light shielding cotton. In some embodiments, the light shielding element 1533 may include a polyurethane (PU) foam.

In some embodiments, the light emitting element 1531 may include a light emitting diode. The light emitting diode may include a visible optical diode and an invisible optical diode. For example, the visible optical diode may include a red light emitting diode, an orange light emitting diode, a yellow light emitting diode, a green light emitting diode, a cyan light emitting diode, a blue light emitting diode, a purple light emitting diode, a white light emitting diode, or the like, or any combination thereof. The invisible optical diode may include an infrared light emitting diode, an ultraviolet light emitting diode, or a far-infrared light emitting diode. In some embodiments, the light emitting element may include the infrared light emitting diode. In some embodiments, a wavelength of the infrared light emitted by the infrared light emitting diode may be from 830 nanometers to 950 nanometers. In some embodiments, the wavelength of the infrared light emitted by the infrared light emitting diode may be 850 nanometers or 940 nanometers.

The light emitting element 1531 and the photoelectric receiver 1532 may be located at the FPC 1536 and connected to an external power supply or input/output device via the FPC 1536. The PCB 1540 may be located below the FPC 1536. The PCB 1540 may support the FPC 1536 and the light emitting element 1531, the photoelectric receiver 1532, the capacitive sensor 1535, etc., located thereabove, etc.

The support bracket 1520 may also include multiple fixture mechanisms 1560. In some embodiments, one of the fixture mechanisms 1560 may include a first fixture arm 1561 and a second fixture arm 1562. The first fixture arm 1561 may be vertically arranged opposite to the support bracket body. The second fixture arm 1562 may be horizontally arranged opposite to the support bracket body. End portions of two ends of the first fixed arm 1561 may be connected to the bottom portion of the support bracket body and an end portion of an end of the second fixed arm 1562, respectively. The second fixture arm 1562 may be located right below the support bracket body. The first fixture arms 1561, the second fixture arms 1562 of the multiple fixture mechanisms 1560, and the support bracket 1520 may form a limited space and be configured to fix the PCB 1540 and the liveness recognition assembly 1530. In other embodiments, the PCB 1540 and the liveness recognition assembly 1530 may be fixed by other fixture manners. For example, the fixture manners may include a threaded connection, a clamping connection, a welding connection, etc.

In some embodiments, the identity confirmation device 1500 may also include a capacitive sensor 1535. The capacitive sensor 1535 may be a specific embodiment of a wake-up module. The capacitive sensor 1535 may be configured to activate the identity confirmation device 1500 from a sleep mode or a standby mode. The capacitive sensor 1535 may be located between the support bracket body and the FPC 1536. A count of the capacitive sensor 1535 may be one or more. When the count of the capacitive sensor 1535 is one, the capacitive sensor 1535 may be located at a specific area of the support bracket body. The subject may need to touch, press, or slide on the specific area to activate the identity confirmation device 1500. For example, when the capacitive sensor 1535 is located in a middle region of the support bracket body, the subject may need to touch or press the middle area of the support bracket body to activate the detection device, thereby performing a subsequent liveness recognition.

When the count of the capacitive sensor 1535 is more than one, the multiple capacitive sensors may be distributed in the bottom portion of the support bracket body by a certain shape (for example, a circle, a square, a triangle). The shape formed by the multiple capacitive sensors may be the same as the shape of the support bracket body. Each capacitive sensor may correspond to a small area of the support bracket body. The subject may need to simultaneously trigger the multiple capacitive sensors to activate the identity confirmation device 1500. The support bracket body may have a circular shape, for example, the multiple capacitive sensors may be arranged along a circle at a lower portion of the support bracket body. For example, when the count of the capacitive sensor is two, the two capacitive sensors may be located at two sides of a centerline of the support bracket body, and symmetrical with respect to the centerline of the support bracket.

In some embodiments, an activation area of the identity confirmation device 1500 may be changed by adjusting a switch status of each capacitive sensor 1535. Merely by way of example, in some embodiments, the identity confirmation device 1500 may include a first capacitive sensor, a second capacitive sensor, a third capacitive sensor, and a fourth capacitive sensor, each of which may be located at the bottom portion of the support bracket body, and spaced by 90° along a circle whose origin coincides with the center of the support bracket body. That is, if the position of the first capacitive sensor is at 0°, the position of the second capacitive sensor may be located at 90°, the position of the third capacitive sensor may be located at 180°, and the position of the fourth capacitive sensor may be located at 270°. The subject may input control information of the switch status of each capacitive sensor in the identity confirmation device 1500 by the input/output device. The chip 1534 may receive the control information for processing and transmit a control instruction for the above capacitive sensors to the control module 1402. For example, the control information may include an on status of the first capacitive sensor and an off status of other capacitive sensors. At this time, if the liveness recognition needs to be performed on the subject, an upper area of the support bracket body corresponding to the first capacitive sensor may need to be triggered by the subject for activating the identity confirmation device 1500. As another example, the control information may include an on status of the first capacitive and the third captive sensor and an off status of the second capacitive sensor and the fourth captive sensor. Upper areas of the support bracket body corresponding to the first capacitive sensor and the third capacitive sensor may need to be triggered by the subject for activating the identity confirmation device. In the embodiments, the activation area may be changed by controlling the switch statuses of the capacitive sensors, thereby increasing the safety level of the liveness recognition.

In some embodiments, the identity confirmation device 1500 may also include a snap dome 1550. The snap dome 1550 may be another specific embodiment of the wake-up module. The snap dome 1550 may be an arc dome whose center point bulge upwards. The center point of the snap dome 1550 may be located below a conductive portion at the bottom portion of the PCB 1540. The conductive portion of the PCB 1540 may include two separate conductive points. Without pressing, the center point of the snap dome 1550 may not contact the conductive portion at the bottom of the PCB 1540. A circuit of the identity confirmation device 1500 may be not connected. When pressed, the snap dome 1550 may deform, and the center point of the snap dome 1550 may bulge upwards and contact the conductive portion of the PCB 1540, thus forming a closed circuit, and enabling the identity confirmation device 1500 to be powered and start to work normally. In some embodiments, the snap dome 1550 may include a circular snap dome, a cross-shaped snap dome, a triangular snap dome, an elliptical snap dome, etc. In a specific embodiment, the subject may apply a certain pressure (for example, 50 g-80 g) on the identity confirmation device 1500. The identity confirmation device 1500 may traverse a certain mechanical distance under the pressure. The center point of the snap dome 1550 may bulge upwards and contact the conductive portion at the PCB 1540, such that the identity confirmation device 1500 may work normally. In the embodiments, the operation complexity of the liveness recognition process may increase by adding the operation for pressing the identity confirmation device 1500, increasing the complexity of the unauthorized person to operate, and achieving better security effects.

In some embodiments, the identity confirmation device 1500 may also include an optical lens 1510 located above and fixed to the support bracket body. The optical lens 1510 may house the components (for example, the capacitive sensor 1535, the, the photoelectric receiver 1532) of identity confirmation device 1500 to prevent substances such as dust from entering the identity confirmation device 1500. The optical lens 1510 may also allow the light emitted by the light emitting element 1531 to travel through and emit towards the subject, and allow the light reflected by the subject to be received by the photoelectric receiver 1532. In some embodiments, the upper surface of the support bracket body may include a flange structure 1523 matched with the optical lens 1510. The optical lens 1510 may be fixed in the flange structure 1523. In other alternative embodiments, the fixture manner of the optical lens 1510 may also include bonding, threaded connecting, clamping, etc., which may be not limited here. Furthermore, more descriptions of the optical lens 1510 may be found elsewhere in the present disclosure.

It should be noted that the descriptions of the liveness recognition device are merely provided for the purposes of illustration, and not intended to limit the scope of the present disclosure. For persons having ordinary skills in the art, multiple variations and modifications of the liveness recognition device may be made under the teachings of the present disclosure. However, those variations and modifications do not depart from the scope of the present disclosure. For example, the liveness recognition device may be not limited to be mounted according to FIG. 15 and FIG. 16 or installed by rotating 90° or other angles. For example, the optical lens 1510 may be located outside of the support bracket 1520, and bonded to the support bracket 1520 by a certain bonding connection. Such variations and modifications do not depart from the scope of the present disclosure.

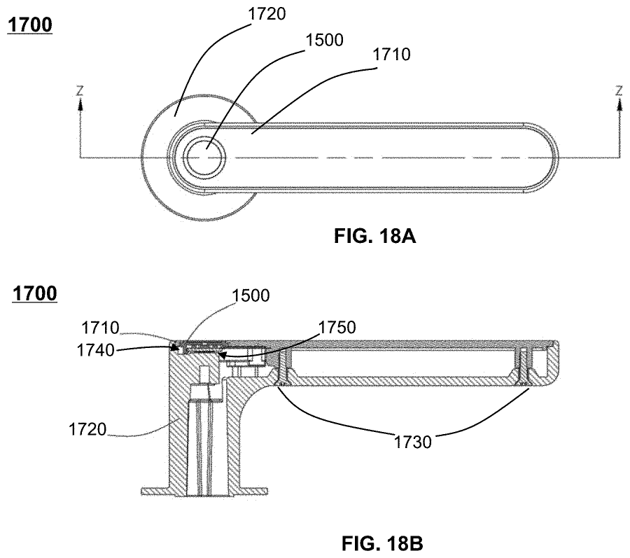

FIG. 17 is an exploded view illustrating an exemplary door handle containing an identity confirmation device according to some embodiments of the present disclosure. FIG. 18A is a top view illustrating an exemplary door handle containing an identity confirmation device according to some embodiments of the present disclosure. FIG. 18B is a section view illustrating an exemplary door handle containing an identity confirmation device according to some embodiments of the present disclosure. In combination with FIG. 17, FIGS. 18A and 18B, the door handle 1700 may include a handle 1720, a handle cover 1710, and the identity confirmation device 1500. The handle 1720 and the handle cover 1710 may house and fix the identity confirmation device 1500. In some embodiments, the handle 1720 and the handle cover 1710 may be detachably connected by a screw 1730. In other embodiments, the handle 1720 and the handle cover 1710 may also be detachably connected by other manners (e.g., a clamping connection).

In some embodiments, the inside of the handle 1720 may include a groove for placing the identity confirmation device 1500. The groove may include a first groove 1740 and a second groove 1750. The first groove 1740 may be communicated with the second groove 1750. A depth of the second groove 1750 may be smaller than the first groove 1740. The second fixture arm 1562 of the fixture mechanism 1560 may be located in the first groove 1740. The PCB 1540 may be located right above the second groove 1750. The snap dome 1550 may be located in the second groove 1750. When there is no external pressure on the identity confirmation device 1500, there may be a gap between a bottom portion of the second fixture arm 1562 and a bottom portion of the first groove 1740. When an external pressure acts on the identity confirmation device 1500, the entire identity confirmation device 1500 may be shifted downwards. When an edge point of the snap dome 1550 is connected to a conductive portion of the PCB 1540, the bottom portion of the second fixture arm 1562 may be in contact with the bottom portion of the first groove 1740. At this time, not only the identity confirmation device 1500 may be activated, but also the snap dome 1550 may be prevented from being over-deformed due to the excessive external pressure, thereby increasing the service life of the snap dome 1550.

It should be noted that the count of first grooves 1740 may be consistent with the count of second fixture arm 1562 of the fixture mechanism 1560. Each of the second fixed arm 1562 may be located right above the first groove 1740.

In some embodiments, the handle cover 1710 may include an opening, located right above the optical lens 1510. The size of the flange structure 1523 on the upper surface of the support bracket body may be smaller than the size of the support bracket body, such that the outside of the flange structure 1523 and the support bracket body may form a first limit structure. The inner wall of the handle cover 1710 may include a second limit structure (i.e., a groove) matched with the first limit structure (such as groove), avoiding a displacement of the identity confirmation device 1500 in the handle 1720. In some embodiments, the top portion of the flange structure 1523 may be flush with, higher than, or lower than the top portion of the handle cover 1710. In other embodiments, the position of the identity confirmation device 1500 may be not limited to the position shown in FIG. 17, FIG. 18A and FIG. 18B. For example, the identity confirmation device 1500 may also be located in the middle area or another side of the handle 1720.

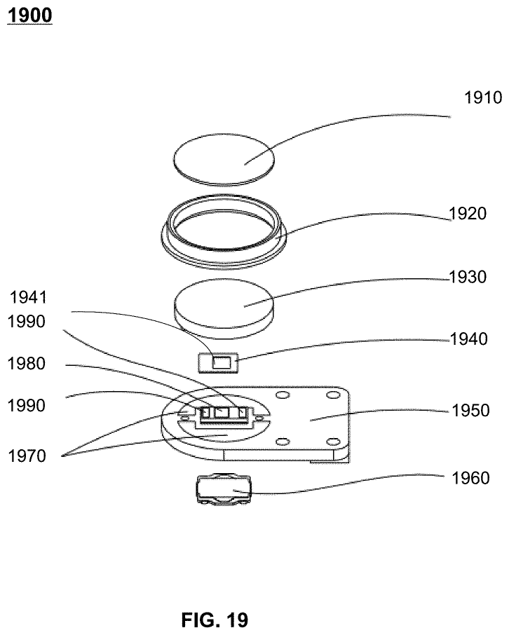

FIG. 19 is an exploded view illustrating an exemplary identity confirmation device according to some embodiments of the present disclosure. As shown in FIG. 19, the present disclosure may also provide an identity confirmation device 1900. The identity confirmation device 1900 in the embodiments may include a support bracket 1930, a light emitting element 1990, a photoelectric receiver 1980, a capacitive sensor 1970, and a printed circuit board (PCB) 1950. A snap dome 1960 may be located at a bottom portion of the PCB 1950. The light emitting element 1990 and the photoelectric receiver 1980 may correspond to the second recognition unit 420 in FIG. 4. The capacitive sensor 1970 and the snap dome 1960 may correspond to the wake-up unit 430 in FIG. 4.

In the embodiments, the light emitting element 1990 and the photoelectric receiver 1980 may be located at the PCB 1950. The support bracket 1930 may be located above the PCB 1950 and located right above the light emitting element 1990, the photoelectric receiver 1980, and the capacitive sensor 1970. A count of the light emitting element 1990 in the embodiments may be two, and the two light emitting elements 1990 may be located at two sides of the photoelectric receiver 1980. A light shielding element 1940 may also be provided between the support bracket 1930 and the photoelectric receiver 1980. The light shielding element 1940 may not cover the light emitting element 1990 such that a light emitted by the light emitting element 1990 may travel through the support bracket 1930 and be irradiated on the subject. A position of the light shielding element 1940 opposite to the photoelectric receiver 1980 may be opened with a receiving hole 1941 such that the light of the light emitting element 1990 reflected by the subject may be received by the photoelectric receiver 1980 via by the receiving hole 1941. In the embodiments, the support bracket 1930 may be made of a transparent material. In other alternative embodiments, the support bracket 1930 may also be made of an optically non-transmissive material. A through hole may be configured on a portion of the support bracket 1930 that opposes the light emitting element 1990 and the photoelectric receiver 1980 such that the light may travel through the support bracket 1930.

In some embodiments, a count of the capacitive sensor 1970 may be two, and the two capacitive sensors 1970 may be located at the PCB 1950. The capacitive sensor 1970 may be a form of a wake-up module. The two capacitive sensors 1970 may be located at two sides of the light emitting element 1990 and the photoelectric receiver 1980, respectively. The subject may need to simultaneously press conductive portions of the two capacitive sensor 1970 to contact the snap dome 1960 to activate the identity confirmation device 1900. In some embodiments, the capacitive sensors 1970 may of a semi-circular ring shape. Two capacitive sensors 1970 of the semi-circular ring shape may be symmetrical with respect to the center of the light emitting element 1990 and the photoelectric receiver 1980. In other embodiments, the count of the capacitive sensor 1970 may also be one or more.

In some embodiments, the identity confirmation device 1900 may also include a limit structure 1920. The limit structure 1920 may be configured to fix and limit a position of the support bracket 1930. The limit structure 1920 may be matched with the shape of the support bracket 1930. In the embodiments, the limit structure 1920 may be substantially an annular cylinder detachably connected to the support bracket 1930. The support bracket 1930 may be located in the annular cylinder. In some embodiments, the identity confirmation device 1900 may also include an optical lens 1910 fixedly connected to the limit structure 1920. The optical lens 1910 may be located inside or at a top portion of the limit structure 1920. The above connection manners may include, but being not limited to, a threaded connection, a bonding connection, a welding connection, a clamping connection, etc.

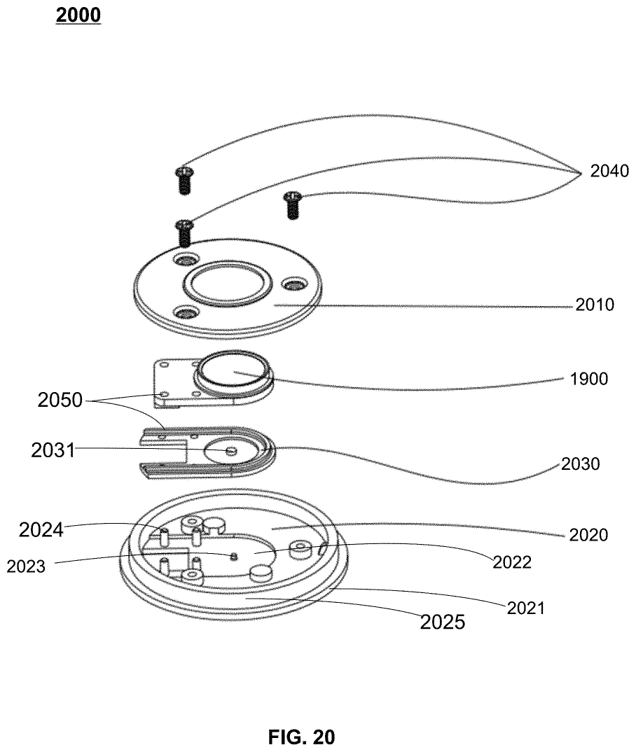

FIG. 20 is an exploded view of an exemplary shell structure according to some embodiments of the present disclosure. As shown in FIG. 20, in some embodiments, the identity confirmation device 1900 may also include a shell structure 2000. The shell structure 2000 may be configured to house the components of the identity confirmation device 1900 (e.g., the PCB 1950, the light emitting element 1990, the photoelectric receiver 1980, the capacitive sensor 1970, the limiting structure 1920, the optical lens 1910). The shell structure 2000 may include a first shell structure 2020 and a second shell structure 2010. The first shell structure 2020 and the second shell structure 2010 may be matched to form a space for placing the identity confirmation device 1900. In some embodiments, the first shell structure 2020 may include a base 2021 configured to place the PCB 1950. An inner surface of the base 2021 may include a placement groove 2022 matched with the PCB 1950. The PCB 1950 may be placed in the placement groove 2022. The placement groove 2022 may limit and fix a position of the PCB 1950, preventing a position deviation of the PCB 1950 in the first shell structure 2020, and increasing the service life of the PCB 1950.

In some embodiments, a buffer 2030 may be located between the PCB 1950 and the placement groove 2022. The buffer 2030 may be matched the PCB 1950 and the placement groove 2022. The buffer 2030 may effectively reduce the collision and the wearing between the PCB 1950 and the placement groove 2022 of the identity confirmation device 1900 during the working. In some embodiments, a material of the buffer 2030 may include silica gel, rubber, plastic, or the like, or any combination thereof. In some embodiments, the placement groove 2022 may also include a first protrusion structure 2023 that may cooperate with a center point of the snap dome 1960. When the components of the identity confirmation device 1900 (e.g., the optical lens 1910, the support bracket 1930) are pressed by the subject, the snap dome 1960 at a bottom portion of the PCB 1950 may be deformed under an action of the first protrusion structure 2023. The central point of the snap dome 1960 may bulge upwards, thereby switching on the circuit and activating the identity confirmation device 1900. When the detection of the subject is completed, the snap dome 1960 may restore its shape when the pressure is removed. The circuit may be disconnected to switch the identity confirmation device 1900 into a standby mode. Accordingly, an upper surface of the buffer 2030 may include a second protrusion structure 2031 matched with the first protrusion structure 2023. The interior of the second protrusion structure 2031 may be hollow. The first protrusion structure 2023 may extend into the second protrusion structure 2031 through a bottom portion of the buffer 2030 and be sleeved with the second protrusion structure 2031. The second protrusion structure 2031 may cooperate with the first protrusion structure 2023 to act on the snap dome 1960. At the same time, by sleeving the second protrusion structure 2031 and the first protrusion structure 2023, the buffer 2030 may be fixed. In some embodiments, the placement groove 2022 may include at least one limit pillar 2024. Accordingly, the buffer 2030 and the PCB 1950 may include limit hole(s) 2050 matched with the limit pillar(s) 2024, respectively. The limit pillar(s) 2024 may sequentially pass through the limit hole(s) 2050 on the PCB 1950 to prevent a deviation between the buffer 2030 and the PCB 1950.

In some embodiments, the first shell structure 2020 may also include a flange 2025. The flange 2025 may be located at the upper surface of the first shell structure 2020 and disposed along the circumferential direction of the first shell structure 2020. The flange 2025 may be fixedly or detachably connected to the first shell structure 2020, or the flange 2025 and the first shell structure 2020 may form an integrated piece. The second shell structure 2010 may be located right above the flange. After the second shell structure 2010 connects to the first shell structure 2020, an internal cavity for placing the identity confirmation device 1900 may be formed through the flange 2025. In some embodiments, the second shell structure 2010 may be a plate-like structure and include an opening located right above the optical lens 1910. In some embodiments, the optical lens 1910 may be located above, below, or flushed with the opening. In some embodiments, the first shell structure 2020 and the second shell structure 2010 may be detachably connected by a screw 2040. In a specific embodiment, multiple first threaded holes may be opened on the second shell structure 2010. The upper surface of the first shell structure 2020 may include second threaded holes opposite to the first threaded holes. Screws may fix the first shell structure 2020 and the second shell structure 2010 through the first threaded holes and the second threaded hole. In other alternative embodiments, the first shell structure 2020 and the second shell structure 2010 may also be fixed by a bonding connection, a welding connection, a clamping connection, a threaded connection, etc.

It should be noted that the shell structure 2000 in the embodiment may also be applied to the identity confirmation device 1500 in FIG. 15, FIG. 16, or the embodiments thereof. When the shell structure 2000 is applied to other embodiments, adaptive adjustment may be made according to the specific structure of the identity confirmation device.

It should be noted that the identity confirmation device 1900 may be applied to the inside of a door, preventing the door from being accidently unlocked by, for example, an unauthorized person or animal (e.g., a child, a pet (e.g., a dog)) from the inside, and improving the security effect of a lock of the door. In other embodiments, the identity confirmation device 1900 may also be applied to the outside of the door, other identity confirmation units (e.g., a fingerprint and/or palm print recognition unit, a palmar digital vein recognition unit, a face recognition unit, an iris recognition unit) may be added or combined to form a detection device having a liveness recognition function and an identity recognition function. In some embodiments, the identity confirmation device 1900 may be used in a security device (e.g., a door lock, an access control, a turnstile), a TNA device (e.g., attendance machine), a transportation device (e.g., a transport vehicle, an intermodal container), or the like.

It should be noted that the descriptions of the identity confirmation device are merely provided for the purposes of illustration, and not intended to limit the scope of the present disclosure. For persons having ordinary skills in the art, multiple variations and modifications of the identity confirmation device may be made under the teachings of the present disclosure. However, those variations and modifications do not depart from the scope of the present disclosure. For example, the support bracket 1520 may be not limited to the circular shape, and may also include an elliptical shape, a regular or irregular polygon, etc., as long as the optical lens 1510 may be matched with a body of the support bracket 1520. For example, the shell structure 2000 may be not limited to the cylinder in FIG. 21, and may also be a polygon prism structure (e.g., a triangular prism, a square, or the like) or an irregular structure. Such variations and modifications do not depart from the scope of the present disclosure.

FIG. 21A is a schematic diagram illustrating an exemplary curve of a thickness of an optical lens and an optical signal intensity according to some embodiments of the present disclosure. FIG. 21B is a schematic diagram illustrating an exemplary curve of a total transmittance of an optical lens and an optical signal intensity according to some embodiments of the present disclosure. FIG. 21C is a schematic diagram illustrating an exemplary curve of a haze of an optical lens and an optical signal intensity according to some embodiments of the present disclosure.

According to the descriptions elsewhere in the present disclosure, an identity confirmation device (e.g., the identity confirmation device 900, the identity confirmation device 1500) described in the present disclosure may include an infrared light emitting diode (e.g., the light emitting element 901) and an infrared light photoelectric receiver (e.g., the photoelectric receiver 902). The infrared light emitting diode may emit an infrared light. After passing through an optical lens (e.g., the optical lens 1210, the optical lens 1510), the infrared light may be reflected by a subject. The reflected infrared light by the subject may pass through the optical lens and be received by the infrared light photoelectric receiver.

As shown in FIG. 21A, a signal intensity of the light received by the infrared light photoelectric receiver may relate to a thickness of the optical lens. If materials of optical lenses are the same and the intensity of the infrared light emitted by the infrared light emitting diode is constant, the signal intensity of the infrared light reflected by the subject and further received by the infrared light photoelectric receiver may decrease with the increment of the thickness of the optical lens. The increment of the thickness of the optical lens may affect the intensity of the transmitted light. For example, the greater the thickness of the optical lens, the lower the intensity of the infrared light transmitted from the optical lens, the lower a luminous flux of the infrared light transmitted from the optical lens, and the lower the signal intensity of the infrared light received by the infrared light photoelectric receiver. In some embodiments, when a wavelength of the infrared light is 840 nanometers, the thickness of the optical lens may be from 0.05 millimeters to 0.3 millimeters. In some embodiments, the thickness of the optical lens may be from 0.1 millimeters to −0.2 millimeters. It should be noted that, if the thickness of the optical lens is 0, there may be no optical lens. In this case, the signal intensity of the infrared light may be the maximum value, Imax. By disposing the optical lens, components of the identity confirmation device may be isolated from an external environment, preventing external dust, water, or other foreign matters from entering the device.

As shown in FIG. 21B, the signal intensity of the light received by the infrared light photoelectric receiver may relate to the total transmittance of the optical lens. In some embodiments of the present disclosure, when an incident light passes through the optical lens, a portion of the incident light may be absorbed by the optical lens, a portion of the incident light may transmit the optical lens, and a portion of the light may be diffusely reflected. The total transmittance may refer to a result of dividing a sum of a luminous flux of the incident light transmitting the optical lens and a luminous flux of the incident light diffusely reflected by a luminous flux of the incident light. As shown in FIG. 21B, if materials of optical lenses are the same and the intensity of the infrared light emitted by the infrared light emitting diode is constant, the signal intensity of the infrared light reflected by the subject and further received by the infrared light photoelectric receiver may increase with the increment of the total transmittance of the optical lens. In some embodiments, the total transmittance of the optical lens may be greater than 45%, that is, the total transmittance of the optical lens may be from 45% to 100%. In some embodiments, the total transmittance of the optical lens may be from 60% to 95%. In some embodiments, the total transmittance of the optical lens may from 70% to 92%.

As shown in FIG. 21C, the signal intensity of the light received by the infrared light photoelectric receiver may relate to the haze of the optical lens. The haze may refer to a percentage of a ratio of the luminous flux of the diffuse reflection to the luminous flux of the light transmitting the optical lens. As shown in FIG. 21C, the signal intensity of the light received by the infrared light photoelectric receiver may gradually decrease with the increment of the haze of the optical lens. In some embodiments, the haze of the optical lens may be not greater than 65%. In some embodiments, the haze of the optical lens may be not greater than 55%. In some embodiments, the haze of the optical lens may be not greater than 45%. In some embodiments, the haze of the optical lens may be not greater than 30%.

FIG. 22 is a schematic diagram illustrating an exemplary communication module according to some embodiments of the present disclosure. As shown in FIG. 22, the communication module 240 may include a Bluetooth™ unit 2210, a WIFI unit 2220, a local area network (LAN) unit 2230, a near field communication (NFC) unit 2240, a wide area network (WAN) unit 2250, a metropolitan area network (MAN) unit 2260, a ZigBee unit 2270, a radio frequency identification (RFID) unit 2280, a cellular data unit 2290, or the like, or any combination thereof. The Bluetooth™ unit 2210 may be configured to establish data communication between the identity confirmation device 130 and an electronic device of a subject or a user. For example, the identity confirmation device 130 may communicate with the electronic device (e.g., a mobile phone, a tablet computer, or a smart watch) of the subject via the Bluetooth™ unit 2210. The electronic device may be configured to collect first recognition information (e.g., fingerprint information, facial information, voice information) and/or second recognition information (e.g., blood oxygen information, heart rate information, facial information) and transmit the collected first recognition information and/or second recognition information to the Bluetooth™ unit 2210. More specifically, the electronic device of the subject may include a fingerprint detection area of a liveness recognition function. The fingerprint detection area may be configured to collect fingerprint recognition information and liveness recognition information of the subject. The electronic device of the subject may transmit ID information of the electronic device together with the fingerprint recognition information and the liveness recognition information of the subject to the Bluetooth™ unit 2210 via Bluetooth™. The Bluetooth™ unit 2210 may transmit the above-mentioned information to the identity confirmation device 130 for further recognition or detection, and performing subsequent operations. The WIFI unit 2220 may be configured to establish data transmission between components of the identity confirmation system 100 or the identity confirmation device 130. For example, the identity confirmation information obtained by the identity confirmation device 130 may be transmitted to the server 110 via the WIFI unit 2220 for processing. As another example, the identity confirmation device 130 may perform a remote alarm via the WIFI unit 2220. More specifically, when the identity confirmation device 130 determines a detection result of the subject and whether the detection result is positive or negative, the identity confirmation device 130 may transmit the detection result to a personal device of an owner of the identity confirmation device 130 via the WIFI unit 2220. In some embodiments, only when the detection result of the subject is negative, the identity confirmation device 130 may transmit the negative detection result to the personal device of the owner of the identity confirmation device 130 via the WIFI unit 2220. In this case, the operation of the identity confirmation device 130 may be considered as the remote alarm. The LAN unit 2230, the WAN unit 2250, and the MAN unit 2260 may be configured to establish communication and/or connection between various components (e.g., the detection module 210, the processing module 220, the control module 230, the power supply module 250, the input/output module 260, and/or the drive module 270) of the identity confirmation system 100 or the identity confirmation device 130. The communication and/or connection may include a wired connection (e.g., a cable connection, an optical cable connection) or a wireless connection (e.g., a network card connection). The NFC unit 2240 and the RFID unit 2280 may be configured to obtain the first recognition information of the subject. For example, the NFC unit 2240 may obtain the ID information of the electronic device (e.g., a mobile phone, a tablet computer) of the subject. As another example, the RFID unit 2280 may obtain the ID information of a magnetic key card of the subject. The ZigBee unit 2270 may be configured to establish data and/or information exchange between various modules (e.g., the detection module 210, the processing module 220, the control module 230, the power supply module 250, the input/output module 260, and/or the drive module 270) of the identity confirmation device 130. For example, the identity confirmation information (e.g., the first recognition information and the second recognition information) obtained by the detection module 210 may be transmitted to the processing module 220 or the server 110 via the ZigBee unit 2270. The function of the cellular data unit 2290 may be similar to the WIFI unit 2220. The cellular data unit 2290 may be served as a backup module when the WIFI unit 2220 fails to receive a high-intensity WIFI signal. The cellular data unit 2290 may work separately from the WIFI unit 2220 for different data and/or information exchange tasks. For example, the user terminal 140 may be configured to obtain reminder information or alarm information of the identity confirmation device 130 via the cellular data unit 2290. As another example, the WIFI unit 2220 may be configured to transmit reminder information or alarm information and automatically download the latest software version of the identity confirmation device 130 from the server 110, while the cellular data unit 2290 may only be configured to transmit the reminder information or the alarm information.

FIG. 23 is a schematic diagram illustrating an exemplary input/output module according to some embodiments of the present disclosure. It should be noted that the functions of the module/unit/sub-unit mentioned in the present disclosure may be implemented by hardware, software, or a combination thereof, which is not limited here. For example, the input/output module 260 may refer to an input/output interface (e.g., a serial port, an audio port of 3.5 millimeters, a user interface), a code, or a device containing the interface and the code. As shown in FIG. 23, the input/output module 260 may include a touch screen display 2310, a speaker 2320, a microphone 2350, a keyboard 2330, an LED light 2360, a camera 2340, and an alarm device 2370. In some embodiments, the input/output module 260 may exchange information and/or data with the detection module 210. For example, when the input/output module 260 includes the touch screen display 2310 or the keyboard 2330, the subject may input password information through the touch screen display 2310 or the keyboard 2330. The password information may be transmitted to the detection module 210 via the network 120 or the communication module 240 and be served as first recognition information of a subject. In some embodiments, the password information may include digit, character, a text, or the like, or any combination thereof. In some embodiments, the password information may include an authentication gesture, an answer to an authentication question, an image selection result, etc. For example, when the input/output module 260 includes the microphone 2350, the microphone 2350 may obtain voice information of the subject as the first recognition information. The voice information may be transmitted to the detection module 210. For example, when the input/output module 260 includes the camera 2340, the camera 2340 may obtain facial information of the subject as the first recognition information. The facial information may be transmitted to the detection module 210. In some embodiments, an external device of the input/output module 260 may perform a corresponding operation based on a control instruction or a control signal of the identity confirmation system 100. For example, if the processing module 220 determines that the detection result of the subject is positive based on the identity confirmation information of the subject, the control module 230 may transmit an instruction for controlling the touch screen display 2310 to the input/output module 260 based on the result. The instruction may control the touch screen display 2310 to emit a message that the identity recognition is positive. Additionally or alternatively, the control module 230 may transmit an instruction for controlling the speaker 2320 to the input/output module 260 based on the result. The instruction may control the speaker 2320 to emit a message that the identity recognition is positive. As another example, if the processing module 220 determines that the detection result of the subject is negative based on the identity confirmation information of the subject, the control module 230 may transmit an instruction for controlling the touch screen display 2310 and/or the speaker 2320 to the input/output module 260 based on the result. The instruction may control the touch screen display 2310 and/or the speaker 2320 to emit a message that the identity recognition is negative. Additionally or alternatively, the control module 230 may transmit an instruction for controlling the alarm device 2370 to the input/output module 260 based on the result. The instruction may control the alarm device 2370 to emit an alarm. Additionally or alternatively, the control module 230 may transmit an instruction for controlling the LED light 2360 to the input/output module 260 based on the result. The instruction may control the LED light 2360 to flash. For example, the color of the LED light 2360 in a normal active status may be yellow. If the identity recognition of the subject is confirmed, the color of the LED light 2360 may be changed to green and the LED light 2360 may flash at a specific frequency (e.g., 1 Hz, 2 Hz, 3 Hz, or 4 Hz). If the identity recognition of the subject fails to be confirmed, the color of the LED light 2360 may turn to red and flash at a specific frequency. In some embodiments, if the processing module 220 determines that the detection result of the subject is negative based on the identity confirmation information of the subject, the control module 230 may transmit an instruction for controlling the camera 2340 to the camera 2340 based on the result. The instruction may control the camera 2340 to obtain the facial information of the subject. The facial information together with the detection result may be transmitted to the electronic device of the owner of the identity confirmation device 130 for reminding or alarming. In some embodiments, the facial information together with the detection result may also be transmitted to the server 110. If the identity confirmation device 130 is used in an important security scenario (e.g., a bank vault, a national security bureau), the facial information together with the detection result may also be transmitted to a police station.

In some embodiments, if the detection result is negative or the subject is inconvenient to be detected, the subject may be able to make a video call or an audio call to the user terminal through the touch screen display 2310 or the keyboard 2330. When it is necessary to make the video call or the audio call, the control module 230 may transmit a control signal to the communication module 240. The control signal may control the communication module 240 to make a call to the user terminal. Simultaneously, the control module 230 may transmit an instruction to the microphone 2350 or the camera 2340, and the microphone 2350 or the camera 2340 may enter a active status based on the instruction. In some embodiments, the subject may also be able to make the video call or the audio call to the relevant user terminal 140 based on a voice recognition system of the identity confirmation device 130. The owner or manager of the identity confirmation device 130 may then transmit a control instruction to the identity confirmation device 130 for a subsequent operation (e.g., unlocking) based on the video call or the audio call.

It should be noted that the above descriptions of the input/output module 260 are merely provided for the purposes of illustration, and not intended to limit the scope of the present disclosure. For persons having ordinary skills in the art, multiple variations and modifications on the input/output module 260 may be made under the teachings of the present disclosure. However, those variations and modifications do not depart from the scope of the present disclosure.

FIG. 24 is a flowchart illustrating an exemplary process for confirming identity of a subject according to some embodiments of the present disclosure. The process 2400 may be executed by a processing logic, which may include hardware (e.g., a circuit, a dedicated logic, a programmable logic, a microcode), software (instructions running on a processing device to execute hardware simulation), or the like, or any combination thereof. One or more operations of the process 2400 for confirming the identity in FIG. 24 may be implemented by the identity confirmation system 100 in FIG. 1. For example, the process 2400 may be stored in the server 110 in a form of instructions, which are retrieved and executed by the components of the identity confirmation device 130 (e.g., the processing module 220 of the identity confirmation device in FIG. 2, the processor 320 of the computing device 300 in FIG. 3). The process 2400 may include the following operations.

In 2405, a wake-up signal of a subject may be received. The operation may be performed by the wake-up unit 430. More descriptions of the specific principles and relevant details of the operation may be found elsewhere in the present disclosure, for example, operation 610 of FIG. 6 or the descriptions thereof.

In 2410, an identity recognition of the subject may be performed. The identity recognition of the subject in the operation may include obtaining first recognition information of the subject. More descriptions of obtaining the first recognition information of the subject may be found elsewhere in the present disclosure, for example, operation 620 of FIG. 6 or the descriptions thereof.

In 2415, a liveness recognition of the subject may be performed. The liveness recognition of the subject in the operation may include obtaining second recognition information of the subject. More descriptions of obtaining the second recognition information of the subject may be found elsewhere in the present disclosure, for example, operation 640 of FIG. 6 or the descriptions thereof.

In 2420, whether identity of the subject is confirmed or not may be determined. The determining whether the identity of the subject is confirmed or not may include determining a first recognition result based on the first recognition information. The first recognition result may include that the identity of the subject is confirmed or not. More descriptions of determining the first recognition result based on the first recognition information may be found elsewhere in the present disclosure, for example, operation 630 of FIG. 6 or the descriptions thereof.

In 2425, whether liveness of the subject is recognized or not may be determined. The determining whether the liveness of the subject is recognized or not may include determining a second recognition result based on the second recognition information. The second recognition result may include that the liveness of the subject is recognized or not. More descriptions of determining the second recognition result based on the second recognition information may be found elsewhere in the present disclosure, for example, operation 650 of FIG. 6 or the descriptions thereof.

In response to determining that the identity of the subject is confirmed in 2420, and the liveness of the subject is recognized in 2425, operation 2430 may be performed. In 2430, a first detection result may be generated. In some embodiments, the first detection result may include that the detection result of the subject is positive.

In response to determining that the identity of the subject is confirmed in 2420 and the liveness of the subject fails to be recognized in 2425, operation 2435 may be performed. In 2435, a second detection result may be generated. In some embodiments, the second detection result may include that the detection result of the subject is negative.

In response to determining that the identity of the subject fails to be confirmed in 2420 and the liveness of the subject is recognized in 2425, operation 2440 may be performed. In 2440, a third detection result may be generated. In some embodiments, the third detection result may include that the detection result of the subject is negative.

In response to determining that the identity of the subject fails to be confirmed in 2420 and the liveness of the subject fails to be recognized in 2425, operation 2445 may be performed. In 2445, a fourth detection result may be generated. In some embodiments, the fourth detection result may include that the detection result of the subject is negative.

In 2450, a subsequent operation may be performed based on the detection result described above. In some embodiments, the detection result may be the first detection result, and the identity confirmation system 100 may control the identity confirmation device 130 to perform the subsequent operation based on the first detection result. For example, when the identity confirmation device 130 is applied to a door lock device, the identity confirmation system 100 may unlock the lock based on the first detection result. As another example, when the identity confirmation device 130 is applied to a TNA device, the identity confirmation system 100 may update a database corresponding to the TNA device based on the first detection result by recording information of the subject and a current time point as the TNA information of the subject. As a further example, when the identity confirmation device 130 is applied to a turnstile device, the identity confirmation system 100 may control a turnstile to be released to the subject based on the first detection result. As a further example, when the identity confirmation device 130 is applied to a transportation device (e.g., a bicycle, an electrical vehicle, a car), the identity confirmation system 100 may unlock or initiate the transportation device based on the first detection result. As a further example, when the identity confirmation device 130 is applied to a communication device, the identity confirmation system 100 may permit the subject to switch on and off, log in a system, download software, etc., of the electronic device and set a permission level of an application program thereon based on the first detection result. As a further example, when the identity confirmation system 100 is applied to an online service platform for an Internet service (e.g., an online payment platform (e.g., an online shopping platform), an online banking, an online ride-hailing platform, an online meal ordering platform, etc., that requires identity authentication). The identity confirmation system 100 may search and associate a relevant account in the platform and approve a service request of the subject based on the first detection result.

In some embodiments, the detection result may include the second detection result (the detection result of the subject being negative), that is, the identity of the subject is confirmed and the liveness of the subject fails to be recognized. The second detection result may indicate that the subject is a non-living body that copies or forges the first recognition information of a legal subject. For example, when the first recognition information includes fingerprint information, the subject may have a fingerprint film, a fingerprint sticker, or a fingerprint glove including the fingerprint information of the subject. As another example, when the first recognition information includes facial information, the subject may have a photo, a sculpture, an electronic display device, or a mask including the facial information of the subject. According to the second detection result, the identity confirmation system 100 may remind or alarm an owner or a manager of the identity confirmation device 130 and/or an alarm center through the identity confirmation device 130 (e.g., the communication module 240 or the input/output module 260), or emit a warning to a person using the subject.

In some embodiments, the detection result may include the third detection result (the detection result of the subject being negative), that is, the identity of the subject fails to be confirmed and the liveness of the subject is recognized. The third detection result may indicate that the user does not have the authority of utilizing the identity confirmation device 130. The identity confirmation system 100 may emit a reminder to the subject through the identity confirmation device 130 (e.g., the communication module 240 or the input/output module 260) based on the third detection result.

In some embodiments, the detection result may include the fourth detection result (the detection result of the subject being negative), that is, the identity of the subject fails to be confirmed and the liveness of the subject fails to be recognized. The fourth detection result may indicate that the identity confirmation device 130 may be accidentally touched by an external non-living body. The identity confirmation system 100 may not respond or generate a reminder based on the fourth detection result.

It should be noted that the above descriptions of the process 2400 are merely provided for the purposes of illustration, and not intended to limit the scope of the present disclosure. For persons having ordinary skills in the art, multiple variations and modifications on the process 2400 may be made under the teachings of the present disclosure. However, those variations and modifications do not depart from the scope of the present disclosure. In some embodiments, an order of one or more operations of the process 2400 may be adjusted. For example, operation 2415 and operation 2425 may be performed after operation 2420, and the liveness recognition of the subject may be performed after the identity of the subject is confirmed. As another example, operation 2410 and operation 2420 may be performed after operation 2425, and identity confirmation of the subject may be performed after the liveness of the subject is recognized. In some embodiments, one or more operations may be omitted from the process 2400. For example, operation 2405 may be omitted, and the first recognition unit and the second recognition unit may be always in an active status. As another example, the identity confirmation or the liveness recognition may be performed based only on the first recognition information and/or the second recognition information (e.g., palmar digital vein information, dynamic facial information).

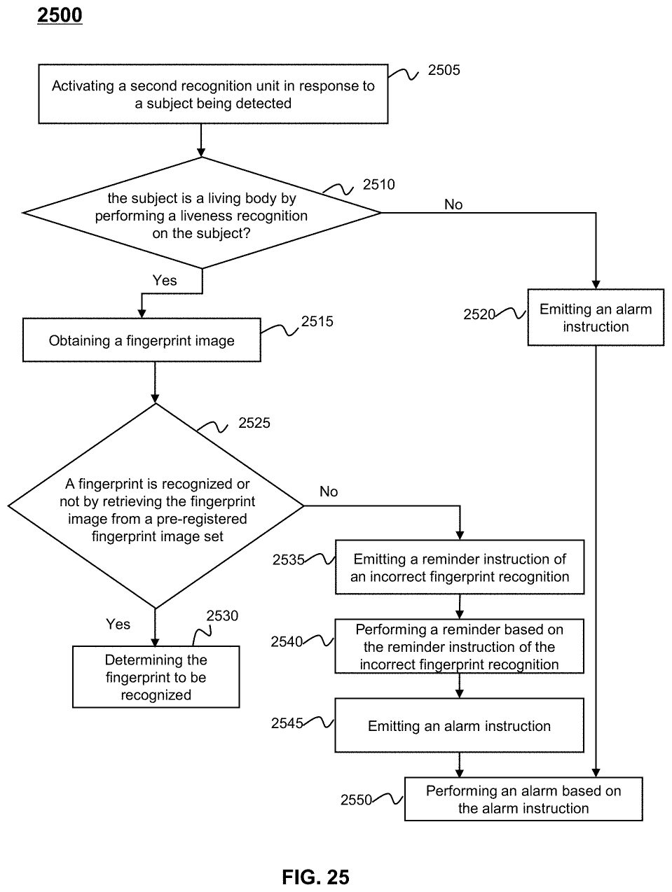

FIG. 25 is a flowchart illustrating an exemplary process for confirming identity of a subject according to some embodiments of the present disclosure. In some embodiments, the process 2500 may be executed by a processing logic, which may include hardware (e.g., a circuit, a dedicated logic, a programmable logic, a microcode), software (an instruction running on a processing device to execute hardware simulation), or the like, or any combination thereof. One or more operations of the process 2500 for confirming the identity of a subject in FIG. 25 may be implemented by the identity confirmation system 100 in FIG. 1. For example, the process 2500 may be stored in the server 110 in a form of instructions, which are retrieved and executed by components of the identity confirmation device 130 (e.g., the processing module 220 of the identity confirmation device in FIG. 2, the processor 320 of the computing device 300 in FIG. 3). The process 2500 may include the following operations.

In 2505, a second recognition unit may be waked up in response to a subject being detected. The operation may be performed by the wake-up unit 430. More descriptions of the specific principles and relevant details of the operation may be found elsewhere in the present disclosure, e.g., operation 610 of FIG. 6, or the descriptions thereof.

In 2510, whether the subject is a living body may be determined by performing a liveness recognition on the subject. The operation may be performed by the second recognition unit 420. In response to determining that the subject is the living body, operation 2520 may be performed. In response to determining that the subject is a non-living body, operation 2515 may be performed. The specific principles and relevant details of the operation 2505 and the operation 2510 may be the same as the operation 710 and the operation 720 FIG. 7, respectively, which may be referred to the above corresponding descriptions and not be repeated here.

It should be noted that the second recognition unit 420 in the embodiments may determine whether the subject is the living body based on one or more types of the second recognition information (e.g., blood oxygen information, heart rate information, palmar digital vein information, facial information) of the subject. For example, the second recognition unit 420 may determine whether the subject is the living body based only on the blood oxygen information of the subject. As another example, the second recognition unit 420 may determine whether the subject is living body based on the blood oxygen information and the heart rate information of the subject. In response to determining that both the blood oxygen information and the heart rate information are recognized, the subject may be determined to be the living body. In response to determining that the blood oxygen information or the heart rate information fails to be recognized, the subject may be determined to be the non-living body.

In 2520, an alarm instruction may be emitted. The operation may be performed by the second recognition unit 420.

It should be noted that when the subject is determined to be the non-living body, it may mean that the subject is the non-living body or the subject acts improperly during the detection process. A condition where the subject is the non-living body may include an external substance touching the second recognition unit 420 by mistake, a foreign object (e.g., a glove, a mask) located between a detection portion of the subject and the second recognition unit 420, or the detection portion of the subject having a fake item including the second recognition information (e.g., a fingerprint film, a photo, a mask) of the subject. The improper action of the subject during the detection process may include a random movement of the subject during the detection process, a relatively short detection time period, an insufficient contact between the detection portion and the second recognition unit 420, etc.

It should be noted that during the liveness recognition process of the subject, due to the improper actions (e.g., the random movement during the detection process, the relatively short detection time period), the liveness recognition result may be false. In order to avoid a false alarm during the recognition process of the subject, only when a count of consecutive failures of the liveness recognition within a certain time period reaches a predetermined threshold (e.g., 1, 3, 4, 5), the second recognition unit 420 may emit a reminder instruction that the liveness recognition fails to be recognized. More descriptions of the reminder instruction that the liveness recognition fails to be recognized may refer to relevant descriptions of the reminder instruction that the fingerprint recognition fails to be recognized.

In 2515, a fingerprint image may be obtained. The operation may be performed by a fingerprint recognition unit. More descriptions of the specific principles and relevant details of the operation may be found elsewhere in the present disclosure, for example, operation 730 of FIG. 7, or the descriptions thereof.

In 2525, whether a fingerprint is recognized or not may be determined by retrieving the fingerprint image from a pre-recorded fingerprint image set. The operation may be performed by the fingerprint recognition unit. The specific principles and relevant details of the operation 2525 may be similar to the operation 740 in FIG. 7, which may be referred to the above corresponding descriptions and not be repeated here.

In response to determining that the recognition result including that the fingerprint is recognized, operation 2530 may be performed, and the fingerprint may be determined to be recognized. The identity confirmation system 100 may control the identity confirmation device 130 to perform the subsequent operation when the detection result includes the first detection result in FIG. 24.

In response to determining that the recognition result including that the fingerprint fails to be recognized, operation 2535 may be performed and a reminder instruction of the false fingerprint recognition (i.e., failing to be recognized) may be emitted. The operation 2535 may be performed by the first recognition unit 410.

It should be noted that during the fingerprint recognition process, the fingerprint recognition result may be false due to fingerprint wear. In order to avoid a false alarm during the recognition process, only when a count of consecutive failures of the fingerprint recognition within a certain time period reaches a predetermined threshold (e.g., 1, 3, 4, 5), a reminder instruction of the false fingerprint recognition may be emitted.

In 2540, a reminder may be performed based on the reminder instruction of the false fingerprint recognition. The operation may be performed by the identity confirmation device 130 or user terminal 140. In the operation, the fingerprint recognition unit may generate reminder information. The reminder information may refer to information that notifies the subject that the fingerprint fails to be recognized and/or relevant information of the fingerprint recognition. The relevant information of the fingerprint recognition may include, but being not limited to the remaining times of fingerprint recognition attempts, reminder information that an alarm is triggered for the false fingerprint recognition, reminder information of an operation specification of the fingerprint recognition, etc. For example, if the subject places his/her finger in a wrong way during the fingerprint recognition, the fingerprint may fail to be recognized. The reminder information may need to be broadcasted directly to remind the user that the fingerprint fails to be recognized and the fingerprint recognition needs to be performed again. In some embodiments, the reminder information may be transmitted to the subject through the identity confirmation device 130 (e.g., the input/output module 260) and/or the user terminal 140. The reminder through the identity confirmation device 130 may be performed by the input/output module 260 (e.g., a display screen, a speaker) of the identity confirmation device 130 by performing a text display, an image display, a video display, a voice broadcast, a beep, a flashing indicator, or the like, or any combination thereof. For example, the identity confirmation device 130 may convey the reminder information via audio broadcast together with a beeping to remind the subject. As another example, the identity confirmation device 130 may display the reminder information by the text display together with the video display of the fingerprint operation specification to remind the subject. The reminder through the user terminal 140 may refer that the identity confirmation device 130 transmits the reminder information to the user terminal 140 via the network 120 or the communication module 240 to remind the subject. For example, when the user terminal 140 is in communication and connection with the identity confirmation device 130, the user terminal 140 may perform the liveness recognition and the fingerprint recognition, transmit the fingerprint recognition result to the identity confirmation device 130 for processing, and receive the processing result of the identity confirmation device 130. The reminder information may be transmitted to the user terminal 140 through WeChat, QQ, Yixin, Fetion, MSN, Line, WhatsApp, iMessage, a short message (e.g., a voice message or a text message), a control application of the identity confirmation system, or the like, or any combination thereof. In some embodiments, the owner or the manager of the identity confirmation device 130 and the subject trying to confirm the identity may be reminded simultaneously, sequentially, individually, or separately. The reminder information may be the same or different.

In response to a count of times that the fingerprint fails to be recognized within a certain time period greater than a predetermined threshold, operation 2545 may be performed to emit an alarm instruction. For example, in response to the fingerprint recognition result of the subject including that the count of times that the fingerprint fails to be recognized is greater than 3, the fingerprint recognition unit may transmit the alarm instruction.

In 2550, an alarm may be performed based on the alarm instruction. The alarm instruction may include an alarm instruction emitted by the second recognition unit 420 and an alarm instruction emitted by the fingerprint recognition unit. The operation may be performed by the identity confirmation device 130 (e.g., the communication module 240, the input/output module 260) or the server 110. For illustration purposes, brief introduction of performing the alarm based on the alarm instruction may be provided below. The input/output module 260 may include an alarm device. The alarm device may include, but being not limited to, a voice alarm device (or referred to as audio alarm device, an audio device), an optical alarm device (or referred to as optical alarm device, a light device), a remote alarm device (or referred to as a remote alarm device, a remote device), or the like, or any combination thereof. If the alarm device includes the sound alarm device, the sound alarm device may perform a sound alarm based on the alarm instruction. The sound alarm may include that an alarm is emitted based on a predetermined sound manner. When the alarm instruction is received, alarm information (e.g., a beeping alarm, a sound alert) may be broadcasted directly. If the alarm device includes the optical alarm device, the optical alarm device may perform an optical alarm based on the alarm instruction. The optical alarm device may emit a strong optical alarm signal to attract the attention of nearby persons. If the alarm device includes the remote alarm device, the remote alarm device may perform a remote alarm based on the alarm instruction. The remote alarm device may refer to a device capable of transmitting an alarm by transmitting a remote signal notification. The remote alarm device may notify the owner or manager of the identity confirmation device 130 and/or the alarm center (e.g., a police station) through the Internet, a telephone, a satellite phone, a walkie-talkie, etc. For example, the remote alarm device may control a telephone terminal device associated with the identity confirmation device 130 to alarm by making a phone call based on the alarm instruction. The phone number of the telephone terminal device may be preset in the device. When the alarm instruction is received, the device may call the predetermined phone number to perform the alarm. As another example, the remote alarm device may perform the alarm by pushing the alarm information to the user terminal 140 (e.g., a mobile phone, a tablet computer) associated with the identity confirmation device 130 based on the alarm instruction. The alarm information may include, but being not limited to, a reason for the alarm (e.g., the liveness of the subject failing to be recognized, the fingerprint failing to be confirmed, the identity confirmation device being attacked by a fingerprint film), an occurrence time, a location or a geographic coordinate of the identity confirmation device. In some embodiments, the alarm information may be presented in a form of a short message. For example, when the identity confirmation system 100 detects that the subject includes the fingerprint film, the alarm information may include words such as “fingerprint film attack”, “non-living fingerprint attack,” etc. In some embodiments, after an application of the user terminal receives the alarm information, a color of an interface or a corresponding icon of the application may change. For example, when the identity confirmation device 130 is in the standby mode or a normal active status, the color of the interface or the corresponding icon of the application may be green. When the identity confirmation device 130 is attacked by the non-living object, the color of the interface or the corresponding icon of the application may become orange, yellow, red, etc. As another example, after an application of the user terminal receives the alarm information, the color of the interface or the corresponding icon of the application may also flash.

In some embodiments, the alarm device may also include a camera. The camera may obtain image information or video information of the subject. When the subject is the non-living body or the fingerprint recognition result of the subject fails to be confirmed, the camera may transmit the image information or the video information of the subject to the subject and/or the alarm center. For example, the identity confirmation device 130 may be used in an important security scenario (e.g., a bank vault, a national security bureau). The image information or the video information of the subject together with the detection result may be transmitted to the police station.

It should be noted that, in some embodiments of the present disclosure, when the liveness fails to be recognized or the fingerprint fails to be confirmed, either the reminder or the alarm may be performed, or both the reminder and the alarm may be performed simultaneously.

It should be noted that the above descriptions of the process 2500 are merely provided for the purposes of illustration, and not intended to limit the scope of the present disclosure. For persons having ordinary skills in the art, multiple variations and modifications on the process 2500 may be made under the teachings of the present disclosure. However, those variations and modifications do not depart from the scope of the present disclosure. For example, when the liveness recognition unit is always in the active status, operation 2505 may be omitted. As another example, an order of the operation 2510 and the operations 2515-2530 may be adjusted, for example, the fingerprint recognition may be performed before determining whether the subject is the living body.

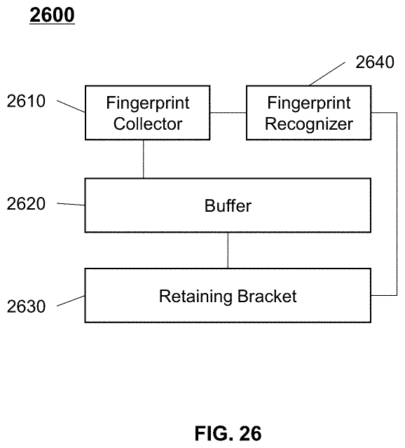

In some embodiments, the identity confirmation device may only have the identity recognition function. The present disclosure may provide an identity confirmation device with the fingerprint recognition function as an example for specific descriptions. FIG. 26 is a block diagram illustrating an exemplary identity confirmation device according to some embodiments of the present disclosure. As shown in FIG. 26, the identity confirmation device 2600 may include a fingerprint collector 2610 (also referred to as first recognition information collector), a mounting module (not shown in FIG. 26, or referred to as a fingerprint module), a fingerprint recognizer 2640 (also referred to as a first recognition information recognizer, a fingerprint recognition device), and a main control board. The fingerprint collector 2610 and the fingerprint recognizer 2640 may be referred to as a first recognition device configured to obtain first recognition information (e.g., a fingerprint image) of the subject. The main control board may be configured to determine a first recognition result (i.e., a fingerprint recognition result of the subject) based on the first recognition information. In some embodiments, the mounting module may fix the fingerprint collector 2610, the fingerprint recognizer 2640, and the main control board inside the identity confirmation device 2600. In some embodiments, the mounting module may include a retaining bracket 2630. In some embodiments, the fingerprint collector 2610 and the fingerprint recognizer 2640 may be located at the retaining bracket 2630 and fixedly or detachably connected to the retaining bracket 2630. The fingerprint collector 2610 and the fingerprint recognizer 2640 may be wired or wirelessly connected. In some embodiments, the fingerprint collector 2610 may be located at an upper side of the retaining bracket 2630. The fingerprint recognizer 2640 may be located at the upper side or a lower side of the retaining bracket 2630.

In some embodiments, the fingerprint collector 2610 may be configured to collect a fingerprint image of the subject. In some embodiments, the fingerprint collector 2610 may include an optical fingerprint sensor, a semiconductor capacitive sensor, a semiconductor thermal sensor, a semiconductor pressure sensor, an ultrasonic sensor, a radio frequency (RF) sensor, or the like, or any combination thereof. In some embodiments, the fingerprint recognizer 2640 may extract and store corresponding fingerprint information based on the fingerprint image of the subject (or user). In some embodiments, the fingerprint recognizer 2640 may also include a database located in the fingerprint recognizer 2640. The database may be configured to store the fingerprint information of the subject. In some embodiments, the database may include a mass storage, a removable storage device, a volatile read-and-write memory (e.g., a random access memory (RAM)), a read-only memory (ROM), or the like, or any combination thereof. In some embodiments, the database may be implemented on a cloud platform. For example, the cloud platform may include a private cloud, a public cloud, a hybrid cloud, a community cloud, a distributed cloud, an inter-cloud, or the like, or any combination thereof. In some embodiments, the fingerprint recognizer 2640 may also be configured to match and recognize the fingerprint information of the subject. For example, the fingerprint recognizer 2640 may match the fingerprint information of the subject with the fingerprint information of the subject that is pre-stored in the database.

In some embodiments, the mounting module may also include a buffer 2620 located at junctions of the various components. For example, when the fingerprint collector 2610 and the fingerprint recognizer 2640 are both located at the upper side of the retaining bracket 2630, the buffer 2620 may be located between the fingerprint collector 2610 and the fingerprint recognizer 2640 and/or between the fingerprint recognizer 2640 and the retaining bracket 2630. As another example, when the fingerprint collector 2610 is located at the upper side of the retaining bracket 2630 and the fingerprint recognizer 2640 is located at the lower side of the retaining bracket 2630, the buffer 2620 may be located between the fingerprint collector 2610 and the retaining bracket 2630 and/or between the fingerprint recognizer 2640 and the retaining bracket 2630.

It should be noted that the above identity confirmation device 2600 may also include a second recognition device configured to obtain second recognition information (e.g., liveness recognition information) of the subject. Further, the main control board may further determine a second recognition result based on the second recognition information. The main control board may also determine a detection result of the subject based on the first recognition result and the second recognition result. The main control board may also control the identity confirmation device based on the detection result of the subject. In some embodiments, the second recognition device may include a light emitting element, a receiving element, and a light shielding element. The light emitting element and the receiving element may be located at two sides of the light shielding element, respectively. The light emitting element may be configured to emit a recognition light (e.g., an infrared light) towards the subject. The receiving element may be configured to receive the recognition light reflected by the subject. More descriptions of the second recognition device may be found elsewhere in the present disclosure, e.g., FIG. 12A, FIG. 12B or the descriptions thereof. In some embodiments, the mounting module may be not limited to the fixing of the fingerprint collector 2610 and the fingerprint recognizer 2640, and also be applied to an identity confirmation device with the liveness recognition function (also referred to as the second recognition device). The specific structure of the mounting module may be adaptively adjusted based on the components of the identity confirmation device.

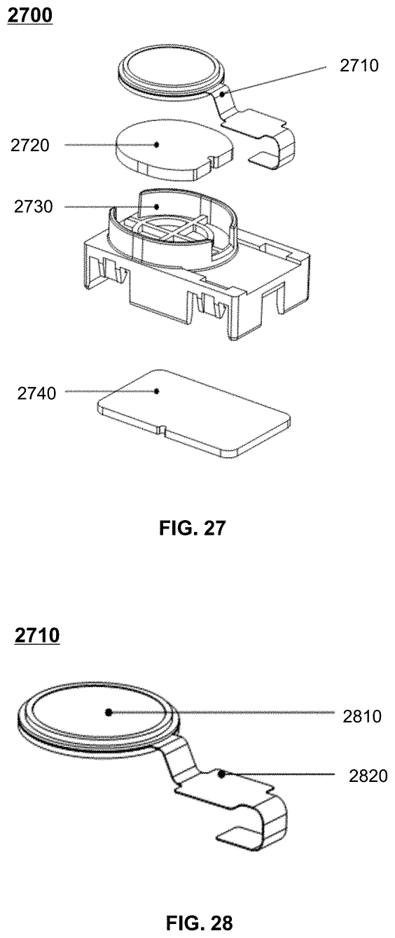

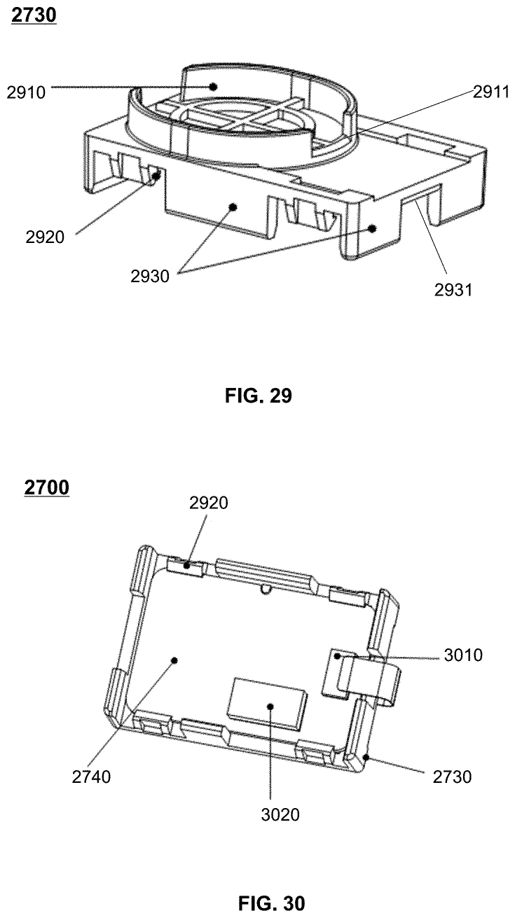

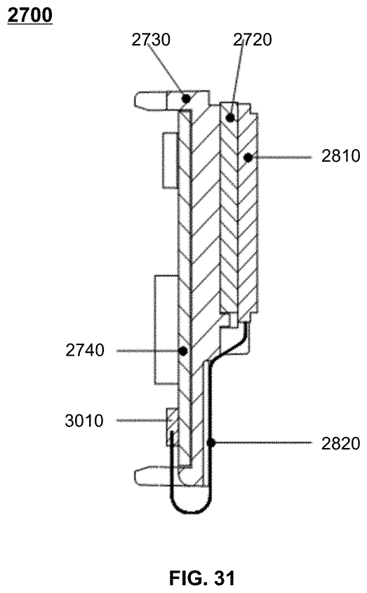

In order to further illustrate the specific structure of each component and the connection relationship between the components of the identity confirmation device 2600, an identity confirmation device 2700 may be provided as an example for further descriptions of the identity confirmation device 2600 in the present disclosure. FIG. 27 is a schematic diagram illustrating an exploded structure of an exemplary identity confirmation device according to some embodiments of the present disclosure. FIG. 28 a schematic diagram illustrating an exemplary fingerprint collector according to some embodiments of the present disclosure. FIG. 29 is a schematic diagram illustrating an exemplary retaining bracket according to some embodiments of the present disclosure. FIG. 30 a schematic diagram illustrating an exemplary identity confirmation device according to some embodiments of the present disclosure. FIG. 31 is a section view illustrating an exemplary identity confirmation device according to some embodiments of the present disclosure.

As shown in FIGS. 27-31, the identity confirmation device 2700 may include a retaining bracket 2730 and a fingerprint collector 2710, and a fingerprint recognizer 2740 that are located at the retaining bracket 2730. In some embodiments, the identity confirmation device 2700 may correspond to the identity confirmation device 2600 in FIG. 26. The fingerprint collector 2710 may correspond to the fingerprint collector 2610 in FIG. 26. The fingerprint recognizer 2740 may correspond to the fingerprint recognizer 2640 in FIG. 26. The fingerprint collector 2710 and the fingerprint recognizer 2740 may communicate via a wired or wireless network. It should be noted that, the retaining bracket 2730, the fingerprint collector 2710, and the fingerprint recognizer 2740 may be integrated into one module.

In the identity confirmation device 2700 provided by the embodiments of the present disclosure, the fingerprint collector 2710 and the fingerprint recognizer 2740 may both be located at the retaining bracket 2730. The fingerprint collector 2710 and the fingerprint recognizer 2740 may be integrated using the retaining bracket 2730. In a specific mounting process, the fingerprint collector 2710 and the fingerprint recognizer 2740 may be installed only by fixing the retaining bracket 2730 at a required position. Compared to the separate fixing of the fingerprint collector 2710 and the fingerprint recognizer 2740, the fixture structure may be reduced, the overall structure of the identity confirmation device 2700 may be simplified, and the production and assembly of the components of the identity confirmation device 2700 may be facilitated. In addition, the reliability of the identity confirmation device 2700 may be improved and the wear and tear thereof may be reduced.

In some embodiments, the fingerprint collector 2710 and the fingerprint recognizer 2740 may both be fixedly connected to the retaining bracket 2730. In some embodiments, the fingerprint recognizer 2740 may be fixed to the retaining bracket 2730, and the fingerprint collector 2710 may be fixedly connected to the fingerprint recognizer 2740. Additionally or alternatively, the fingerprint collector 2710 may be fixed to the retaining bracket 2730, and the fingerprint collector 2710 may be fixedly connected to the fingerprint recognizer 2740. A fixed connection described herein may include, but being not limited to, a bonding connection, a welding connection, a clamping connection, a threaded connection, etc.

In some embodiments, the fingerprint recognizer 2740 may be fixed to the retaining bracket 2730. The fingerprint collector 2710 may be fixedly connected to the fingerprint recognizer 2740. Specifically, the fingerprint collector 2710 and the fingerprint recognizer 2740 may be located at an upper side and a lower side of the retaining bracket 2730, respectively. For example, the fingerprint collector 2710 may be located at a top portion of the retaining bracket 2730, and the fingerprint recognizer 2740 may be located at a bottom portion of the retaining bracket 2730. The distribution mode in the embodiment may facilitate the arrangement of the fingerprint collector 2710 and the fingerprint recognizer 2740, and also facilitate the overall wiring. In addition, in the embodiment, the retaining bracket 2730 may protect the fingerprint recognizer 2740, reducing the probability of damage to the fingerprint recognizer 2740. In some embodiments, the fingerprint collector 2710 and the fingerprint recognizer 2740 may be located at a same side of the retaining bracket 2730.

In some embodiments, the fingerprint collector 2710 and the fingerprint recognizer 2740 may communicate via a wired or wireless network. In a specific embodiment, a communication line 2820 of the fingerprint collector 2710 may be connected to a terminal block 3010 (see FIG. 30) of the fingerprint recognizer 2740. In some embodiments, the terminal block 3010 may include a plug-in terminal block, a barrier terminal block, a spring-type terminal, a rail-type terminal, an H-type through-wall terminal, or the like, or any combination thereof. The fixed connection between the communication line 2820 and the terminal block 3010 may realize the fixed connection between the fingerprint collector 2710 and the fingerprint recognizer 2740, simplifying the structure of the identity confirmation device 2700. In the embodiment, the communication line 2820 may be connected to the terminal block 3010, not only realizing the communication and/or connection between the fingerprint collector 2710 and the fingerprint recognizer 2740, but also realizing the fixed connection between the fingerprint collector 2710 and the fingerprint recognizer 2740.

In some embodiments, the communication line 2820 may include a flexible printed circuit (FPC). The FPC may be a cable capable of bending to a certain extent, ensuring the fixed connection between the fingerprint collector 2710 and the fingerprint recognizer 2740 and simultaneously reducing the space occupied by the communication line 2820 in the identity confirmation device. In some embodiments, the communication line 2820 may be plugged into the terminal block 3010. In other embodiments, the communication line 2820 may also be connected to the terminal block 3010 via other connections, for example, a welding connection or a clamping connection, which may be not further limited here.

In some embodiments, the fingerprint recognizer 2740 may be detachably connected to the retaining bracket 2730, and the fingerprint collector 2710 may be detachably connected to the fingerprint recognizer 2740, facilitating maintenance and replacement. There may be many manners to realize the detachable connection, e.g., a clamping connection, a plugging connection, a connection using a threaded connector, etc. In order to facilitate the mounting and the disassembly, the fingerprint recognizer 2740 may be detachably located on the retaining bracket 2730 through the clamping connection. The fingerprint collector 2710 may be detachably fixedly connected to the fingerprint recognizer 2740 through the plugging connection.

With reference to FIG. 29 and FIG. 30, the bottom portion of the retaining bracket 2730 may include a buckle 2920 clamped with the fingerprint recognizer 2740. The buckle 2920 may fix the fingerprint recognizer 2740 on the bottom of the retaining bracket 2730. A count of the buckle 2920 may include one, two, or more than two. To ensure the reliability, the count of the buckle 2920 may include more than two. The count of the buckle 2920 may also be selected based on a shape of the fingerprint recognizer 2740. In some embodiments, the fingerprint recognizer 2740 may be of a quadrilateral shape, a circular shape, an oval shape, etc. Specifically, as shown in FIG. 27, the fingerprint recognizer 2740 may be of a rectangular shape, and the count of the buckle 2920 may include four. Two of the buckles 2920 may be located at a side of the fingerprint recognizer 2740, and the other two of the buckles 2920 may be located at another side of the fingerprint recognizer 2740. In some other embodiments, the four buckles 2920 may be located at four sides of the fingerprint recognizer 2740, respectively. The specific structure of the buckle 2920 may be designed according to practical demands, which may be not limited in the embodiments of the present disclosure.

The fingerprint collector 2710 may be classified as an electronic precision device, which can withstand a limited amount of external pressure and assembly stress. In order to reduce the probabilities of damaging the fingerprint collector 2710 and increase the service life thereof, the identity confirmation device 2700 may also include the buffer 2720 located between the fingerprint collector 2710 and the retaining bracket 2730. In some embodiments, a material of the buffer 2720 may include silica gel, rubber, plastic, or the like, or any combination thereof. The buffer 2720 may be configured to absorb the assembly stress and the excessive external force during the fingerprint recognition and also fill an assembly gap, effectively reducing the probability of damaging the fingerprint collector 2710 and improving the service life of the fingerprint collector 2710.

With reference to FIG. 27 and FIG. 28, in some embodiments, the fingerprint collector 2710 may include a fingerprint collector body 2810 and the communication line 2820. The buffer 2720 may be located between the fingerprint collector body 2810 and the retaining bracket 2730. A size and a shape of the buffer 2720 may be designed according to a size and a shape of the fingerprint collector body 2810. For example, when the fingerprint collector body 2810 is of the circular shape, the buffer 2720 may be of an arc shape. As another example, when the fingerprint collector body 2810 is of a quadrilateral shape, the buffer 2720 may be of a quadrilateral shape or approximately a quadrilateral shape, which is not intended to be limiting. In order to facilitate the mounting, the size of the buffer 2720 may be slightly smaller than the fingerprint collector body 2810. A thickness of the buffer 2720 may be selected according to practical demands. Preferably, the thickness of the buffer 2720 may be from 2 millimeters to 3 millimeters, ensuring a good buffer performance. In some other embodiments, the thickness of the buffer 2720 may be other values, which may be not limited here.

With reference to FIGS. 27, 28, and 29, in some embodiments, the retaining bracket 2730 may include a mounting groove 2910. The buffer 2720 may be pressed into the mounting groove 2910 by the fingerprint collector 2710. Specifically, the fingerprint collector body 2810 and the buffer 2720 may both be located in the mounting groove 2910. In the embodiment, a position of the buffer 2720 and a position of the fingerprint collector 2710 may be limited by the mounting groove 2910, improving the mounting reliability. The mounting groove 2910 may match the fingerprint collector body 2810. For example, when the fingerprint collector body 2810 is of the circular shape, the mounting groove 2910 may be of the circular shape. As another example, when the fingerprint collector body 2810 is of a rectangle shape, the mounting groove may also be of the rectangle shape. A size of the mounting groove 2910 may be slightly larger than that the buffer 2720 and the fingerprint collector body 2810, facilitating the buffer 2720 and the fingerprint collector body 2810 being located in the mounting groove 2910 and fitting a side wall of the mounting groove 2910 better.

In some embodiments, the side wall of the mounting groove 2910 may also include a first notch 2911. The side wall of the retaining bracket 2730 may include a second notch 2931. The communication line 2820 may pass through the first notch 2911 and the second notch 2931 and be connected to the fingerprint recognizer 2740 at the bottom of the retaining bracket 2730. By arranging the first notch 2911 and the second notch 2931, the communication line 2820 may directly pass through the side wall of the mounting groove 2910 and the side wall of the retaining bracket 2730, avoiding the wearing of the communication line 2820 at a top portion of the side wall of the mounting groove 2910 and a bottom portion of the side wall of the retaining bracket 2730 and increasing the service life of the communication line 2820.

It should be noted that the identity confirmation device 2700 described in the embodiments may implement the identity recognition function described in the present disclosure. The identity confirmation device 2700 may also be cooperated with an identity confirmation device (e.g., the identity confirmation device 1500, the identity confirmation device 1900) to implement the identity confirmation function described elsewhere in the present disclosure.

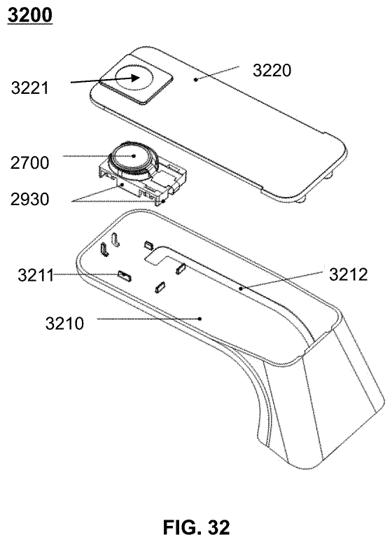

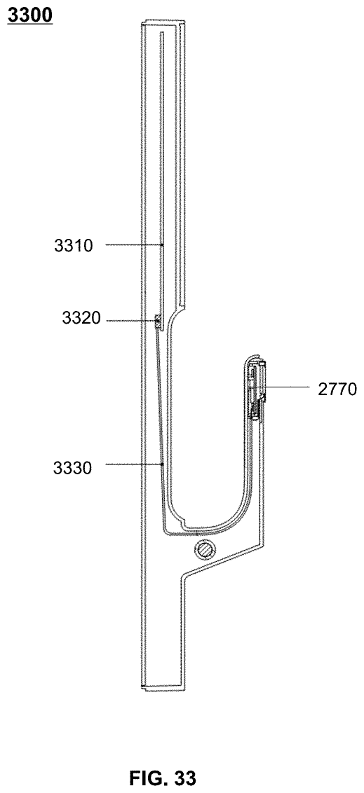

The identity confirmation device 2700 provided in the present disclosure may be applied to a security device (e.g., a door lock, an access control, a turnstile), a TNA device (e.g., a TNA machine), a transportation device (e.g., a transport vehicle, an intermodal container), an online transaction application, or other applications that require identity confirmation. Merely for illustrative purposes, in the embodiment, a door lock device (or referred to as a smart lock) is provided as an example of the application of security device. FIG. 32 a schematic diagram illustrating an exemplary handle of an identity confirmation device according to some embodiments of the present disclosure. FIG. 33 is a section view illustrating an exemplary handle according to some embodiments of the present disclosure. As shown in FIG. 32 and FIG. 33, in some embodiments, the identity confirmation device 2700 may be applied to a handle of the door lock device. The handle 3200 may include a handle body 3210 (also referred to as a first panel) and a handle housing 3220 (also referred to as a second panel) fixedly connected to the handle body 3210. In some embodiments, the handle body 3210 may include an inner cavity equipped with the identity confirmation device 2700. The handle housing 3220 may seal the inner cavity. The handle housing 3220 may include a through hole 3221 from which the fingerprint collector 2710 may be exposed. The first recognition device may obtain the first recognition information through the portion exposed from the through hole 3221, that is, the fingerprint collector 2710 may obtain the fingerprint image through the portion exposed from the through hole 3221. The entire identity confirmation device 2700 may be pressed into the inner cavity by the handle housing 3220, improving the mounting reliability. It should be noted that when the identity confirmation device 2700 includes a second recognition device, a part of the second recognition device may also be exposed from the through hole 3221. The second recognition device may obtain the second recognition information through the portion exposed from the through hole 3221.

In some embodiments, the identity confirmation device 2700 may be detachably located at the handle 3200. With reference to FIGS. 27, 32, and 33, the identity confirmation device 2700 may be detachably mounted on the handle 3200 via the retaining bracket 2730. For example, the identity confirmation device 2700 may be detachably located at the handle 3200 through a threaded connection, a clamping connection, a plugging connection, etc. In the present disclosure, the identity confirmation device 2700 being detachably located at the handle 3200 is described in detail by taking the clamping connection as an example. In some embodiments, the retaining bracket 2730 may be fixed in the inner cavity of the handle 3200 through the clamping connection. The inner cavity of the handle 3200 may include clamping ribs 3211. A count of the clamping rib 3211 may be at least two. The clamping ribs 3211 may form a rib groove clamped with the retaining bracket 2730. Correspondingly, a side wall of the retaining bracket 2730 may include a clamping plate 2930 abutting the clamping rib 3211. In some embodiments, the clamping rib 3211 may be a wedge-shaped structure. The bottom portion of the retaining bracket 2730 may include a guiding fillet such that the entire retaining bracket 2730 may be placed in the rib groove. In other alternative embodiments, the inner cavity of the handle 3200 may include other clamping structures. For example, the inner cavity of the handle 3200 may include multiple clamping hooks. The side wall of the retaining bracket 2730 may include multiple clamping grooves or clamping holes that cooperate with the multiple clamping hooks. As another example, the side wall of the retaining bracket 2730 may include the multiple clamping hooks, and multiple clamping grooves or clamping holes that cooperate with the multiple clamping hooks may be located in the inner cavity of the handle 3200, which may be not limited here.

In some embodiments, the fingerprint recognizer 2740 may be communicated with the main control board 3310 (or referred to as the control module 230) of the door lock device via a wired or wireless manner. The main control board 3310 may be located at an internal panel of the door lock device. In some embodiments, the fingerprint recognizer 2740 may be communicated and connected with the main control board 3310 through a data line 3330. Specifically, the main control board 3310 may include the terminal block 3320. The fingerprint recognizer 2740 may include a data line interface 3020 (see FIG. 30). The data line interface 3020 of the fingerprint recognizer 2740 may be connected to the data line 3330 and plugged into the terminal block 3320 of the main control board 3310 through the data line 3330, establishing a communication and a connection. In some embodiments, the data line 3330 may include an FPC or other types of wiring, which may be not limited here. After the terminal block 3320 and the data line interface 3020 are connected through the data line 3330, the fingerprint recognizer 2740 may transmit the fingerprint recognition result to the main control board 3310 through the data line 3330. The main control board 3310 may control an on/off state of the door lock device based on the fingerprint recognition result. In some embodiments, in order to facilitate the wiring, the inner cavity of the handle may include a wiring groove 3212. The data line 3330 may be arranged along the wiring groove 3212.

In some embodiments, the identity confirmation device may also include a speaker (e.g., the speaker 2320 in FIG. 23). The speaker may emit a voice reminder or a beeping alarm based on a control of the main control board, more descriptions of which may be found elsewhere in the present disclosure, for example, FIG. 23 or the descriptions thereof.

In some embodiments, the identity confirmation device may also include an optical indicator (e.g., the LED light 2360 in FIG. 23). The optical indicator may emit a light reminder based on the control of the main control board, more descriptions of which may be found elsewhere in the present disclosure, e.g., FIG. 23 and descriptions thereof.

In some embodiments, the identity confirmation device may also include a mechanical structure (e.g., a lock body, a motor). A status of the mechanical structure may be updated based on the control of the main control board. The mechanical structure of the updated status may cause the identity confirmation device to be locked or unlocked.

It should be noted that the door lock device described above may include a rotary door lock, that is, the door may be opened or closed by rotating the handle. The door lock device described above may also include a push-pull lock, that is, the door may be opened or closed by pushing or pulling the handle. The unlocking manner may be consistent with an opening direction. The unlocking manner of the push-pull lock is consistent with the opening direction, such that the use of the push-pull lock may be convenient. The identity confirmation device 2700 described in the embodiments may also include a wake-up unit, more descriptions of which may be found elsewhere in the present disclosure. In addition, the identity confirmation device 2700 in the embodiment may also have a liveness recognition function by adding corresponding components, which may be not limited here.

It should be noted that the above descriptions of the identity confirmation device are merely provided for the purposes of illustration, and not intended to limit the scope of the present disclosure. For persons having ordinary skills in the art, multiple variations and modifications on the specific manners of the identity confirmation device may be made under the teachings of the present disclosure. However, those variations and modifications do not depart from the scope of the present disclosure. For example, the identity confirmation device may also be located at a panel of the door lock device or on the door where the door lock device is located. As another example, the identity confirmation may be located in the upper area of the handle in FIG. 33, which may be non-limiting. The identity confirmation device may also be located in a middle area, a bottom area, or another side of the handle. Such variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in smaller than all features of a single foregoing disclosed embodiment.

1. A method for confirming identity of a subject, comprising:
obtaining first recognition information of the subject;
determining a first recognition result based on the first recognition information;
obtaining second recognition information of the subject;
determining a second recognition result based on the second recognition information; and
determining a detection result of the subject based on the first recognition result and the second recognition result.

2. The method of claim 1, wherein
the first recognition information includes identity recognition information; or
the second recognition information includes liveness recognition information.

3. The method of claim 1, wherein
the first recognition information includes information relating to at least one of a fingerprint, a palm print, a palmar digital vein, voice, an iris, or the face of the subject; or
the second recognition information includes at least one of a blood oxygen level, a heart rate, a palmar digital vein, or facial information of the subject.

4. The method of claim 2, wherein
the first recognition result includes that the identity of the subject is confirmed or not; or
the second recognition result includes that liveness of the subject is recognized or not.

5. The method of claim 4, wherein the determining a detection result of the subject based on the first recognition result and the second recognition result includes:
in response to the first recognition result including that the identity of the subject is confirmed, and the second recognition result including that the liveness of the subject is recognized, determining the detection result of the subject to be positive.

6. The method of claim 1, wherein the determining a second recognition result based on the second recognition information includes:
generating a comparison result by comparing the second recognition information with a liveness detection threshold; and
determining the second recognition result based on the comparison result.

7. The method of claim 6, wherein the liveness detection threshold includes a liveness detection intensity threshold, and the comparing the second recognition information with a liveness detection threshold includes:
comparing an average of the second recognition information with the liveness detection intensity threshold; or
comparing a maximum value of the second recognition information, a minimum value of the second recognition information, or a difference between the maximum value and the minimum value of the second recognition information with the liveness detection intensity threshold.

8. The method of claim 6, wherein the liveness detection threshold includes a liveness detection curve slope threshold, and the comparing the second recognition information with a liveness detection threshold includes:
comparing a maximum curve slope or a minimum curve slope of the second recognition information with the liveness detection curve slope threshold.

9. The method of claim 1, wherein the first recognition information includes identity recognition information, and the determining a first recognition result based on the first recognition information includes:
obtaining a retrieval result by retrieving the identity recognition information from a pre-stored identity recognition information set; and
determining the first recognition result based on the retrieval result.

10. The method of claim 1, further comprising:
generating an instruction for updating a current status of an identity confirmation device based on the detection result of the subject.

11. The method of claim 10, wherein the generating an instruction for updating a current status of an identity confirmation device based on the detection result of the subject includes:
in response to the detection result being positive, generating the instruction for updating the current status of the identity confirmation device such that the identity confirmation device is unlocked.

12. The method of claim 1, further comprising:
transmitting, to an external device, notification information relating to the detection result of the subject.

13. The method of claim 12, further comprising:
establishing a video call or an audio call between the subject and the external device.

14. The method of claim 1, further comprising:
transmitting, to the subject, reminder information relating to the detection result of the subject.

15. The method of claim 14, wherein the reminder information includes at least one of:
a voice reminder, a reminder by a flashing indicator, or a reminder by a beeping alarm.

16. The method of claim 1, further comprising:
determining whether a wake-up signal of the subject is detected; and
in response to determining that the wake-up signal of the subject is detected, obtaining the first recognition information of the subject and the second recognition information of the subject.

17. A system for confirming identity of a subject, comprising:
a storage device including a set of instructions; and
one or more processors in communication with the storage device, wherein when executing the set of instructions, the one or more processors are configured to direct the system to:
obtain first recognition information of the subject;
determine a first recognition result based on the first recognition information;
obtain second recognition information of the subject;
determine a second recognition result based on the second recognition information; and
determine a detection result of the subject based on the first recognition result and the second recognition result.

18-36. (canceled)

37. A device for confirming identity of a subject, comprising:
a first recognition device configured to obtain first recognition information of the subject;
a second recognition device configured to obtain second recognition information of the subject;
a main control board configured to:
determine a first recognition result based on the first recognition information;
determine a second recognition result based on the second recognition information; and
determine a detection result of the subject based on the first recognition result and the second recognition result; and
a mounting module configured to fix the first recognition device, the second recognition device, and the main control board in the device.

38-49. (canceled)

50. The method of claim 4, wherein the determining a detection result of the subject based on the first recognition result and the second recognition result includes:
in response to the first recognition result including that the identity of the subject fails to be confirmed or the second recognition result including that the liveness of the subject fails to be recognized, determining the detection result of the subject to be negative.

51. The method of claim 10, wherein the generating an instruction for updating a current status of an identity confirmation device based on the detection result of the subject includes:
in response to the detection result being negative, generating the instruction for updating the current status of the identity confirmation device such that the identity confirmation device is locked.
